(19) United States
(12) Patent Application Publication
(10) Pub. No.: US 2024/0114876 A1
(43) Pub. Date: Apr. 11, 2024

(54) COMPOSITIONS AND METHODS TO REDUCE MASTITIS IN DAIRY ANIMALS

(71) Applicant: Church & Dwight Co., Inc., Princeton, NJ (US)

(72) Inventors: Thomas Rehberger, Sister Bay, WI (US); Alexandra Smith, Greendale, WI (US); Jesse Thompson, Germantown, WI (US)

(21) Appl. No.: 18/478,450

(22) Filed: Sep. 29, 2023

Related U.S. Application Data
(60) Provisional application No. 63/377,848, filed on Sep. 30, 2022.

(51) Int. Cl. A01K 1/015; A01N 25/12; A01N 63/22

(52) U.S. Cl. CPC A01K 1/015; A01N 25/12; A01N 63/22

(57) ABSTRACT

Bacillus strain compositions and methods for reducing growth of one or more mastitis-causing organisms and/or reducing a symptom, sign, or occurrence of mastitis in animals are provided. The Bacillus strain composition can comprise a bacterial cell, a spore, a forespore, and/or a combination of cells, spores, and/or forespores of Bacillus subtilis 839, Bacillus subtilis 4976, and/or an active variant thereof. Compositions and methods provided herein can be applied to beddings of animals, such as dairy cows, and can reduce symptoms, signs, and/or occurrences of mastitis (e.g., environmental mastitis) in the animals and/or reduce somatic cell count in the milk produced by the animals. Beddings for animals comprising the Bacillus strain compositions provided herein in an effective amount to reduce growth of one or more mastitis-causing organisms are also provided.

### RELATED APPLICATIONS

This application claims priority to U.S. Provisional Application No. 63/377,848 filed on Sep. 30, 2022, the content of which is incorporated herein by reference in its entirety.

### FIELD OF THE INVENTION

The invention relates to microbial compositions, methods, and beddings for reducing symptoms and events of mastitis in dairy animals.

### BACKGROUND OF THE INVENTION

Mastitis is a frequently observed challenge throughout the dairy industry. There are two ways that mastitis can impact a dairy cow. The first way is clinical mastitis characterized by rapidly occurring inflammation of the udder often accompanied by pain and altered milk secretion from the affected quarter. The cost of clinical mastitis can be significant for dairy farms both from direct costs: diagnostics, therapeutics, non-saleable milk, vet service, labor, death loss, treatment costs, lost milk and decreased milk production as well as indirect costs: future milk production loss, premature culling loss and future reproduction loss. It is estimated for each clinical case of mastitis there is net economic loss of $458. The second way mastitis can impact a dairy cow is through subclinical mastitis which has no obvious signs either in the udder or in the milk, however milk production decreases and somatic cell count (SCC) increases. Dairy cows can contract mastitis two ways: contagious mastitis, which is contracted through interaction with other cows; or environmental mastitis, which is contracted through interaction with the environment. Due to improvements in management practices often dairies are able to control the transmission of contagious mastitis which has reduced the prevalence of these types of infections, making environmental mastitis more prevalent in US dairy herds.

Stall bedding is considered to be a key source of environmental mastitis as cows lay down 12 to 14 hours a day, and their teats are in direct contact with the bedding material. During this time teats become contaminated with environmental bacteria through contact with bedding. Different bedding types and environments can offer favorable or unfavorable bacterial environments. Often pathogenic bacteria are present in bedding prior to the bedding material being distributed to the stalls. Other common sources of pathogens being introduced to the bedding include fecal, milk or dirt contamination that could be introduced during transport or distribution to the stalls or through cow movement in and out of stalls. Once the bedding is inoculated with pathogens, factors that influence pathogen growth include: temperature, moisture/humidity, management (bedding frequency), and availability of nutrient sources. Bedding types can vary in both biochemical and nutritional properties. Bedding such as recycled manure solids has been shown to support more bacterial growth compared to sand and shavings for certain mastitis-causing pathogens. Low dry matter bedding can be associated with higher bacterial counts and lower milk quality.

Controlling the levels of mastitis-causing organisms in the bedding material is important to control the detrimental impacts of environmental mastitis. Many of the species associated with environmental mastitis are considered opportunistic pathogens causing a host immune response after colonizing the teat canal which negatively impacts animal performance as well as milk quality. Reducing the exposure to these organisms has been attempted but challenging due to limitations with equipment, storage, labor, cost, or other factors. Accordingly, compositions and methods for more efficiently and effectively reducing environmental mastitis events and symptoms could offer important commercial and animal health advantages.

### BRIEF SUMMARY OF THE INVENTION

Bacillus strain compositions and methods for reducing growth of one or more mastitis-causing organisms are provided. The Bacillus strain composition can comprise a bacterial cell, a spore, a forespore, and/or a combination of cells, spores, and/or forespores of Bacillus subtilis 839 and Bacillus subtilis 4976, or an active variant thereof. Compositions and methods provided herein can be applied to beddings of dairy animals, such as dairy cows, and can reduce symptoms and/or occurrences of mastitis (e.g., environmental mastitis) in the animals and/or reduce somatic cell count in the milk produced by the animals. Beddings for dairy animals, such as dairy cows comprising the Bacillus strain compositions provided herein at an effective amount to reduce growth of one or more mastitis-causing organisms are also provided.

In one aspect, the present disclosure provides a Bacillus strain composition for reducing growth of one or more mastitis-causing organisms, comprising a bacterial cell, a spore, a forespore, and/or a combination of cells, spores, and/or forespores of Bacillus subtilis 839 or an active variant thereof, and a bacterial cell, a spore, a forespore, and/or a combination of cells, spores, and/or forespores of Bacillus subtilis 4976 or an active variant thereof. In some embodiments, said one or more mastitis-causing organisms are selected from the group consisting of Staphylococcus, Streptococcus, Enterococcus, Enterobacter, Escherichia, Shigella, Salmonella, Klebsiella, Serratia, Pseudomonas, and Proteus. In some embodiments, the Bacillus strain composition comprises said Bacillus subtilis 839 or active variant thereof and said Bacillus subtilis 4976 or active variant thereof in equal proportions. In some embodiments, at least one of said Bacillus strains in the Bacillus strain composition is a powdered, lyophilized strain. In some embodiments, the Bacillus strain composition further comprises a cryoprotectant. In some embodiments, the Bacillus strain composition further comprises a preservative. In some embodiments, the Bacillus strain composition comprises bacterial cell, a spore, a forespore, and/or a combination of cells, spores, and/or forespores of Bacillus subtilis 839 or an active variant thereof and Bacillus subtilis 4976 or an active variant thereof is present at about 7.5×10⁵ CFU/gram to about 1×10⁶ CFU/gram or at about 7.5×10⁵ CFU/ml to about 1×10⁶ CFU/ml.

In some embodiments, the Bacillus strain composition provided herein is for reducing growth of said one or more mastitis-causing organisms in a bedding of a dairy animal having been applied an effective amount of said Bacillus strain composition. In some embodiments, said effective amount comprises the Bacillus strains of about 7.5×10⁵ CFU/gram of bedding to about 1×10⁶ CFU/gram of bedding.

In some embodiments, said Bacillus strain composition is formulated as a capsule, gel, paste, tablet, powder, or liquid. In some embodiments, said Bacillus subtilis 839 is deposited under NRRL accession number B-67951 and/or said Bacillus subtilis 4976 is deposited under NRRL accession number B-67953.

In one aspect, the present disclosure provides a bedding for a dairy animal comprising an effective amount of a Bacillus strain composition, said Bacillus strain composition comprising a bacterial cell, a spore, a forespore, and/or a combination of cells, spores, and/or forespores of Bacillus subtilis 839 or an active variant thereof, and a bacterial cell, a spore, a forespore, and/or a combination of cells, spores, and/or forespores of Bacillus subtilis 4976 or an active variant thereof, wherein said effective amount of Bacillus strain composition reduces growth of one or more mastitis-causing organisms. In some embodiments, said effective amount comprises the Bacillus strains of about 7.5×10⁵ CFU/gram of bedding to about 1×10⁶ CFU/gram of bedding. In some embodiments, the bedding comprises said Bacillus subtilis 839 or active variant thereof and said Bacillus subtilis 4976 or active variant thereof in equal proportions. In some embodiments, a least one of said Bacillus strains is a powdered, lyophilized strain. In some embodiments, said one or more mastitis-causing organisms are selected from the group consisting of Staphylococcus, Streptococcus, Enterococcus, Enterobacter, Escherichia, Shigella, Salmonella, Klebsiella, Serratia, Pseudomonas, and Proteus. In some embodiments, the bedding is selected from the group consisting of recycled manure solids (RMS) bedding, composted RMS bedding, digested RMS bedding, sand bedding, recycled sand bedding, corn fodder bedding, corn stalk bedding, riverbed rock bedding, saw dust bedding, straw bedding, and wood shavings bedding. In some embodiments, said Bacillus subtilis 839 is deposited under NRRL accession number B-67951 and/or said Bacillus subtilis 4976 is deposited under NRRL accession number B-67953.

In one aspect, provided herein is a method of reducing one or more symptoms, signs, and/or occurrences of mastitis (e.g., environmental mastitis) in a dairy animal, said method comprising contacting a bedding of a dairy animal with an effective amount of a Bacillus strain composition comprising a bacterial cell, a spore, a forespore, and/or a combination of cells, spores, and/or forespores of Bacillus subtilis 839 or an active variant thereof, and a bacterial cell, a spore, a forespore, and/or a combination of cells, spores, and/or forespores of Bacillus subtilis 4976 or an active variant thereof. In some embodiments, said effective amount comprises the Bacillus strains of about 7.5×10⁵ CFU/gram of bedding to about 1×10⁶ CFU/gram of bedding. In some embodiments, said Bacillus strain composition comprises said Bacillus subtilis 839 or active variant thereof and said Bacillus subtilis 4976 or active variant thereof in equal proportions. In some embodiments, at least one of said Bacillus strains is a powdered, lyophilized strain. In some embodiments, said Bacillus strain composition is formulated as a capsule, gel, paste, tablet, powder, or liquid. In some embodiments, contacting comprises spraying said Bacillus strain composition in liquid formulation onto said bedding. In some embodiments, contacting comprises applying said Bacillus strain composition in dry formulation onto said bedding. In some embodiments, the 20 bedding is selected from the group consisting of recycled manure solids (RMS) bedding, composted RMS bedding, digested RMS bedding, sand bedding, recycled sand bedding, corn fodder bedding, corn stalk bedding, riverbed rock bedding, saw dust bedding, straw bedding, and wood shavings bedding.

In some embodiments, the mastitis (e.g., environmental mastitis) comprises clinical mastitis and/or subclinical mastitis. In some embodiments, the method reduces a number of monthly mastitis events in the dairy animal by at least 10%. In some embodiments, the method reduces growth of one or more mastitis-causing organisms in said bedding. In some embodiments, said one or more mastitis-causing organisms are selected from the group consisting of Staphylococcus, Streptococcus, Enterococcus, Enterobacter, Escherichia, Shigella, Salmonella, Klebsiella, Serratia, Pseudomonas, and Proteus. In some embodiments, said method reduces level of Escherichia coli, Klebsiella, and/or total coliforms in the bedding. In some embodiments, said method reduces a somatic cell count in milk produced by the dairy animal. In some embodiments, said method reduces a somatic cell count in milk produced by the dairy animal by at least 10%. In some embodiments, said method reduces amount of bacteria in milk produced by the dairy animal and/or improves quality of milk produced by the dairy animal. In some embodiments, said Bacillus subtilis 839 is deposited under NRRL accession number B-67951 and/or said Bacillus subtilis 4976 is deposited under NRRL accession number B-67953.

### BRIEF DESCRIPTION OF THE DRAWINGS

FIG. 1 depicts stall bedding bacterial levels separated by bedding type. Black lines indicate median levels of bacteria. Bacteria levels for each bedding type were compared to sand bedding. No difference was observed between sand bedding and digested RMS, but levels of coliforms and E. coli were significantly higher (p<0.05) in composted RMS (recycled manure solids) and RMS compared to sand. Presumptive Klebsiella levels were significantly higher (p<0.05) in RMS compared to sand, while group D streptococci were higher in composted RMS compared to sand.

FIG. 2 depicts pile and stall bedding bacterial levels. Black lines indicate median levels of bacteria. Target bacteria levels were all significantly higher (p<0.05) when comparing Pile to Stall bedding.

FIG. 3 depicts Pre-pile, Pile and Stall bacteria levels were compared by sample location. Black lines indicate median levels of bacteria. Pre-pile samples were statistically higher for all target bacteria (p<0.05) compared to Pile samples except for the group D streptococci. Pile samples compared to Stall samples indicated all bacterial levels significantly increased for all target bacteria (p<0.05).

FIG. 4 depicts a profile of isolates harvested from MacConkeys-Inositol-Carbenicillin Agar (MCIC) and identified by Sanger sequencing of the amplified 16S rDNA gene. Isolates (n=3,049) from the MCIC agar were most frequently identified as Klebsiella (46.6%) and E. coli/Shigella/Salmonella (41.9%). Other genera of interested included: Enterobacter (2.3%), Proteus (0.1%), Pseudomonas (0.2%), and Serratia (0.6%).

FIG. 5 depicts a profile of isolates harvested from Bile Esculin Agar (BEA) and identified by Sanger sequencing of the amplified 16S rDNA gene. Isolates (n=2,801) harvested from BEA were most frequently identified as Enterococcus (34.7%), Staphylococcus (12.5%) and Klebsiella (10.4%). Other genera of interest included: Enterobacter (0.5%), E. coli/Shigella/Salmonella (3.1%), Proteus (5.1%), Serratia (2.7%), and Streptococcus (2.2%).

FIG. 6 depicts bulk tank SCC count for the pretreatment period (Mar. 10, 2019, to Dec. 21, 2019) to the trial period (Mar. 10, 2020, to Dec. 21, 2020) in Farm A in South Dakota. The bulk tank SCC counts significantly decreased (<0.01) comparing the pretreatment, average 236,000, to the trial period, average 160,000.

FIG. 7 depicts monthly mastitis events for the pretreatment period (March 2019, to December 2019) to the trial period (March 2020 to December 2020) in Farm A in South Dakota. The monthly mastitis events significantly decreased (<0.01) comparing the pretreatment period, average 24 events per month, to the trial period, average 14 events per month.

FIG. 8 depicts stall bedding bacterial levels in Farm A in South Dakota separated by sampling point. Black lines indicate median levels of bacteria. Bacteria levels were compared by sampling point for each bacteria type. The stall bedding samples collected during the treatment period had significantly lower levels of E. coli (p<0.01) and presumptive Klebsiella (p<0.01) compared to the pretreatment bedding samples. The coliform levels were not significantly impacted (p=0.18). The average level of group D streptococci in the treated stall bedding samples significantly increased compared to the pretreatment (p<0.01).

FIG. 9 depicts a profile of isolates in Farm A in South Dakota harvested from MacConkey-Inositol-Carbenicillin Agar (MCIC) and identified by Sanger sequencing of the amplified 16S rDNA gene. Bar graph is comparing the pretreatment sample isolates to the treatment period sample isolates.

FIG. 10 depicts a profile of isolates in Farm A in South Dakota harvested from Bile Esculin Agar (BEA) and identified by Sanger sequencing of the amplified 16S rDNA gene. Bar graph is comparing the pretreatment sample isolates to the treatment period sample isolates.

FIG. 11 depicts a profile of isolates in Farm A in South Dakota harvested from fresh pile samples on Bile Esculin Agar (BEA) and identified by Sanger sequencing of the amplified 16S rDNA gene. Bar graph is comparing the pretreatment sample isolates to the treatment period sample isolates.

FIG. 12 depicts bulk tank SCC for the pretreatment period (Aug. 25, 2019 to Jun. 30, 2020) to the trial period (Aug. 25, 2020 to Jun. 30, 2021) in Farm B in South Dakota. Black lines indicate the average bulk tank SCC. The bulk tank SCC counts significantly decreased (p<0.01) comparing the pretreatment (average 574,000) to the treatment period (average 497,000).

FIG. 13 depicts monthly mastitis events for the pretreatment period (September 2019 to June 2020) to the trial period (September 2020 to June 2021) in Farm B in South Dakota. Black lines indicate the average monthly mastitis events. The monthly mastitis events significantly decreased (p<0.01) comparing the pretreatment period (29 average events per month) to the treatment period (16 average events per month).

FIG. 14 depicts stall bedding bacterial levels separated by sampling point in Farm B in South Dakota. Black lines indicate median levels of bacteria. Bacteria levels were compared by sampling point for each bacteria type. The stall bedding samples collected during the treatment period had significantly lower levels of E. coli (p<0.01) and coliforms (p<0.01) compared to the pretreatment bedding samples. The presumptive Klebsiella (p=0.20) and group D streptococci (p>0.99) levels were not significantly impacted.

FIG. 15 depicts profiles of the pretreatment sample isolates and the treated sample isolates in Farm B in South Dakota harvested from MacConkey-Inositol-Carbenicillin Agar (MCIC) and identified by Sanger sequencing of the amplified 16S rDNA gene.

FIG. 16 depicts profiles of the pretreatment sample isolates and the treated sample isolates in Farm B in South Dakota harvested from Bile Esculin Agar (BEA) and identified by Sanger sequencing of the amplified 16S rDNA gene.

FIG. 17 depicts water activity measurements comparing the pretreatment samples to the treated samples in Farm B in South Dakota. Black lines indicate the average water activity.

FIG. 18 depicts bulk tank SCC for the pretreatment period (Dec. 1, 2020, to May 31, 2021) to the trial period (Dec. 1, 2021, to May 31, 2022) in Farm C in Minnesota. Black lines indicate the average bulk tank SCC. The bulk tank SCC counts significantly decreased (p<0.01) comparing the pretreatment, average 252,000, to the trial period, average 225,000.

FIG. 19 depicts monthly mastitis events for the pretreatment period (December 2020, to May 2021) to the trial period (December 2021 to May 2022) in Farm C in Minnesota. Black lines indicate the average monthly mastitis events. The monthly mastitis events significantly decreased (p<0.01) comparing the pretreatment period, which had an average of 21 mastitis events per month, to the trial period, which had an average of 0 mastitis events per month.

FIG. 20 depicts stall bedding bacterial levels separated by sampling point in Farm C in Minnesota. Black lines indicate median levels of bacteria. Bacteria levels were compared by sampling point for each bacteria type. The stall bedding samples collected during the treatment period had significantly lower levels of E. coli (p<0.01), coliforms (p<0.01), and presumptive Klebsiella (p<0.01) compared to the pretreatment bedding samples. The group D streptococci levels were not significantly impacted (p=0.41).

FIG. 21 depicts water activity measurements comparing the pretreatment samples to the treated samples in Farm C in Minnesota. Black lines indicate the average water activity.

FIG. 22 depicts bulk tank SCC for the pretreatment period (Mar. 2, 2021, to Jul. 27, 2021) to the trial period (Mar. 2, 2022, to Jul. 27, 2022) in Farm D in Minnesota. Black lines indicate the average bulk tank SCC. The bulk tank SCC counts significantly decreased (p<0.01) comparing the pretreatment, average 218,000, to the trial period, average 161,000.

FIG. 23 depicts monthly mastitis events for the pretreatment period (March 2021, to July 2021) to the trial period (March 2022 to July 2022) in Farm D in Minnesota. Black lines indicate the average monthly mastitis events. The monthly mastitis events were not significantly impacted (p=0.36) comparing the pretreatment period, which had an average of 51 mastitis events per month, to the trial period, which had an average of 46 mastitis events per month.

FIG. 24 depicts stall bedding bacterial levels separated by sampling point in Farm D in Minnesota. Black lines indicate median levels of bacteria. Bacteria levels were compared by sampling point for each bacteria type. The stall bedding samples collected during the treatment period were not significantly different for any target bacterial group.

FIG. 25 depicts water activity measurements comparing the pretreatment samples to the treated samples in Farm D in Minnesota. Black lines indicate the average water activity. The average water activity for the pretreatment samples was significantly higher compared to the treatment period (p=0.04).

FIG. 26 depicts bulk tank SCC for the pretreatment period (November 2020 to June 2021) to the trial period (November 2021 to June 2022) in Farm E in Wisconsin. Black lines indicate the average bulk tank SCC. The bulk tank SCC counts significantly decreased (p=0.02) comparing the pretreatment, average SCC of 137,000, to the trial period, average SCC of 108,000.

FIG. 27 depicts monthly mastitis events for the pretreatment period (November 2020, to June 2021) to the trial period (November 2021 to June 2022) in Farm E in Wisconsin. Black lines indicate the average monthly mastitis events. The monthly mastitis events significantly increased (p<0.01) comparing the pretreatment period, 13 average mastitis events per month, to the trial period, 22 average mastitis events per month.

FIG. 28 depicts stall bedding bacterial levels separated by sampling point in Farm E in Wisconsin. Black lines indicate median levels of bacteria. Bacteria levels were compared by sampling point for each bacteria type. The stall bedding samples collected during the treatment period were not significantly different for any target bacteria.

FIG. 29 depicts Isolates in Farm E in Wisconsin harvested from MacConkeys-Inositol-Carbenicillin Agar (MCIC) and identified by Sanger sequencing of the amplified 16S rDNA gene. The bar graph is comparing the pretreatment sample isolates to the treated sample isolates.

FIG. 30 depicts profiles of the pretreatment sample isolates and the treated sample isolates in Farm E in Wisconsin harvested from Bile Esculin Agar (BEA) and identified by Sanger sequencing of the amplified 16S rDNA gene.

FIG. 31 depicts water activity measurements comparing the pretreatment samples to the treated samples in Farm E in Wisconsin. Black lines indicate the average water activity.

FIG. 32 depicts bacterial levels in the control and Bacillus strain composition-treated stall bedding sampled at days 30, 60, 90 and 150 post treatment. Black lines indicate median levels of bacteria. Bacteria levels were compared for each bacteria type using an unpaired t-test (* indicates P<0.05).

FIG. 33 depicts stall bedding bacterial levels separated by sampling point. Bacteria levels were compared by sampling point for each bacteria type. * indicates P<0.05; ** indicates P<0.01; **** indicates P<0.0001.

FIG. 34 depicts average monthly bulk tank SCC for the pretreatment period (blue box, January 2022 through July 2022) to the trial period (white, August 2022 to Nov. 16, 2022, and Dec. 6, 2022, through February 2023) and the three-week period that the treatment was not applied (yellow box, Nov. 17 to Dec. 6, 2022).

FIG. 35 depicts individual bulk tank SCC values for the pretreatment period (blue box, January 2022 through July 2022) to the trial period (white, August 2022 to Nov. 16, 2022, and Dec. 6, 2022, through February 2023) and the three-week period that the treatment was not applied (yellow box, Nov. 17 to Dec. 6, 2022).

FIGS. 36A-36D depict bacterial enumeration results for control and treated stall samples collected during windrow Bacillus strain composition application, at Week 0 and Week 5. Scatter plots represent bacterial levels of: E. coli (FIG. 36A), total coliforms (FIG. 36B), presumptive Klebsiella (FIG. 36C), and group D streptococci (FIG. 36D). Black lines indicate the median level of each bacterium. * indicates P≤0.05, ns indicates not significant P>0.05.

FIGS. 37A-37D depict bacterial enumeration results for control and treated stall samples collected during stall Bacillus strain composition application, at Week −1 and Week 4. Scatter plots represent bacterial levels of: E. coli (FIG. 37A), total coliforms (FIG. 37B), presumptive Klebsiella (FIG. 37C), and group D streptococci (FIG. 37D). Black lines indicate the median level of each bacterium. * indicates P≤0.05, ns indicates not significant P>0.05.

### DETAILED DESCRIPTION

The present disclosure now will be described more fully hereinafter. The disclosure may be embodied in many different forms and should not be construed as limited to the embodiments set forth herein; rather, these embodiments are provided so that this disclosure will satisfy applicable legal requirements. Like numbers refer to like elements throughout. As used in this specification and the claims, the singular forms “a,” “an,” and “the” include plural references unless the context clearly dictates otherwise.

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property, such as, for example, molecular weight, melt index, temperature etc., is from 100 to 1,000, it is intended that all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, relative amounts of components in a mixture, and various temperature and other parameter ranges recited in the methods.

As used herein, “administer” or “apply” is meant the action of introducing the bacterial strain or the bacterial strain composition to an environment.

As used herein, the term “animal” includes but is not limited to human, mammal, amphibian, bird, reptile, pigs, cows, cattle, goats, horses, sheep, poultry, and other animals kept or raised on a farm or ranch, sheep, big-horn sheep, buffalo, antelope, oxen, donkey, mule, deer, elk, caribou, water buffalo, camel, llama, alpaca, rabbit, mouse, rat, guinea pig, hamster, ferret, dog, cat, and other pets, primate, monkey, ape, and gorilla. In some embodiments, the animals are pig, including but not limited to sows, piglets and grow-finish.

By “at least one strain” is meant a single strain but also mixtures of strains comprising at least two strains of bacteria. By “a mixture of at least two strains,” is meant a mixture of two, three, four, five, six or more strains. In some embodiments of a mixture of strains, the proportions can vary from 1% to 99%. In certain embodiments, the proportion of a strain used in the mixture is at least 5%, 10%, 15%, 20%, 25%, 30%, 35%, 40%, 45%, 50%, 55%, 60%, 65%, 70%, 75%, 80%, 85%, 90%, or 95%. Other embodiments of a mixture of strains are from 25% to 75%. Additional embodiments of a mixture of strains are approximately 50% for each strain. When a mixture comprises more than two strains, the strains can be present in substantially equal proportions or in different proportions in the mixture. “Equal” proportions or amounts as used herein in the context of two or more strains refer to the presence of each strain in similar or substantially same proportions. For example, “equal” proportions or amounts include the presence of two or more strains at proportions or in amounts that are within 0, 1, 2, 3, 4, 5, 6, 7, 8, 9, 10, 11, 12, 13, 14, 15, 16, 17, 18, 19, or 20% difference between each other (or among one another).

As used herein, “effective amount” is meant a quantity of strain, and/or the combination of strains thereof to produce desired effect, e.g., reducing amount or growth of mastitis-causing organisms, reducing a symptom, sign, or occurrence of mastitis, reducing milk somatic cell count, or improving performance of an animal. Improvement in performance can be measured as described herein or by other methods known in the art.

As used herein, “performance” refers to the growth of an animal, such as a dairy animal, measured by one or more of the following parameters: average dairy milk production, average daily gain (ADG), weight, scours, mortality, feed conversion (both feed:gain and gain:feed), and feed intake.

As used herein with respect to a parameter, the term “increased” or “increasing” or “increase” refers to a detectable (e.g., at least about 5%, 10%, 15%, 20%, 25%, 30%, 35%, 40%, 45%, 50%, 55%, 60%, 65%, 70%, 75%, 80%, 85%, 90%, 95%, 96%, 97%, 98%, 99%, 100%, 120%, 150%, 200%, 300%, 400%, 500%, or more) positive change in the parameter from a comparison control, e.g., an established normal or reference level of the parameter, or an established standard control. Accordingly, the terms “increased,” “increase,” and the like encompass both a partial increase and a significant increase compared to a control.

As used herein with respect to a parameter, the term “decreased” or “decreasing” or “decrease” or “reduced” or “reducing” or “reduce” or “lower” or “loss” refers to a detectable (e.g., at least about 5%, 10%, 15%, 20%, 25%, 30%, 35%, 40%, 45%, 50%, 55%, 60%, 65%, 70%, 75%, 80%, 85%, 90%, 95%, 96%, 97%, 98%, 99%, or 100%) negative change in the parameter from a comparison control, e.g., an established normal or reference level of the parameter, or an established standard control. Accordingly, the terms “decreased,” “reduced,” and the like encompass both a partial reduction and a complete reduction compared to a control.

### I. Overview

Mastitis can negatively impact the well-being of the dairy animals and lower the quality and amount of milk production. “Contagious mastitis” refers to mastitis that is contracted through interaction with other cows. “Environmental mastitis” refers to mastitis that is contracted through interaction with the environment, e.g., bedding and other farm facilities. Environmental mastitis is a result of interaction of the animal with organisms (e.g., microorganisms) in a captive setting, or an industrial environment, such as a farm, that is different from the natural environment (e.g., in the wild). Stall bedding is considered to be a key source of environmental mastitis as cows lay down 12 to 14 hours a day, and their teats are in direct contact with the bedding material (Hogan and Smith, 2012 Vet. Clin. North Am. Food Anim. Pract. 28, 217-224). During this time teats become contaminated with environmental bacteria through contact with bedding (Rowbotham and Ruegg, 2015 J. Dairy Sci. 98, 7865-7885). Once the bedding is inoculated with pathogens, factors that influence pathogen growth include: temperature, moisture/humidity, management (bedding frequency), and availability of nutrient sources (Godden et al., 2008 J. Dairy Sci. 91, 151-159). Bedding types can vary in both biochemical and nutritional properties. Bedding such as recycled manure solids (RMS) has been shown to support more bacterial growth compared to sand and shavings for certain mastitis-causing pathogens (Godden et al., 2008). Recent work suggests that low dry matter bedding is associated with higher bacterial counts and lower milk quality (Robles et al., 2020 Animal 14, 1052-1066). “Milk quality” or “quality of milk” as used herein, used interchangeably with “milk hygiene,” refers to quality of milk as measured by amount of bacteria in the milk. “High milk quality” or “high milk hygiene” refers to low amount of bacteria in the milk that allows for, for example, long shelf life. “Low milk quality” or “poor milk hygiene” refers to high amount of bacteria in the milk that results in, for example, milk spoilage or short shelf life. “Improved milk quality” or “improving milk quality” refers to less amount of bacteria or reducing amount of bacteria in the milk, which can result in longer shelf life or improving shelf life.

“Mastitis-causing pathogens” or “mastitis-causing organisms” as used herein in the context of mastitis in dairy animals refers to any microbes, e.g., bacteria, that can cause mastitis, e.g., environmental mastitis, in dairy animals (e.g., ruminants, cows). “Mastitis-causing organisms” include Staphylococcus, Streptococcus, Enterococcus, Enterobacter, Escherichia, Klebsiella, Serratia, Pseudomonas, and Proteus, which are the most frequently observed environmental mastitis-causing bacterial genera ((Hogan and Smith, 2012 Vet. Clin. North Am. Food Anim. Pract. 28, 217-224; Singh et al., 2016 J. Livestock Sci. 7, 46-48). In some embodiments, mastitis-causing organisms include pathogenic coliforms, E. coli, and/or Klebsiella. In some embodiments, mastitis-causing organisms include Proteus, Serratia, Streptococcus, Klebsiella, Salmonella, and/or Entrobacter. These organisms are known to be common on dairy farms. Many of the species associated with environmental mastitis are considered opportunistic pathogens causing a host immune response after colonizing the teat canal which negatively impacts animal performance as well as milk quality (Cheng and Han, 2020 J. Anim. Sci. 33, 1699-1713). Reducing the exposure to these organisms is attempted through management practices such as reducing moisture content in the bedding. However, this can be challenging on commercial dairies and due to limitations or challenges with equipment, storage structures, labor or other environmental or structural factors this practice is not always attainable. More frequent bedding application is another practice to reduce the growth or contamination of pathogens. However, due to labor challenges or available bedding material this is not always practical. Interventions such as composting and heating organic bedding material reduces the levels of mastitis-causing bacteria in the bedding (Wu et al., 2020 Biology 10, 13). However, due to the nutrients and moisture within bedding, bacteria continue to grow in the stalls, and the equipment to support these interventions can be costly.

While Bacilli, such as B. cereus, have been associated with mastitis and have the ability to produce toxins (Turnbull et al., 1979 J. Clin. Pathol. 32, 289-293), many Bacillus species strains do not produce toxins and are used to promote well-being of a subject. For instance, Bacillus species can be used as probiotics to positively impact gut health (Almada-Érix et al., 2021 Front. Microbiol. 12, 623951; Amer et al. 2018 Alternative Therapies. Vol. 24, No. 3; Keerqin et al., 2021 Poult. Sci. 100, 100981). The term “probiotics” has been defined by the Food and Agriculture

Organization of the United Nations (FAO) and World Health Organization (WHO) as live microorganisms which when administered in adequate amounts confer a health benefit on the host. Probiotics include beneficial bacteria that when consumed or otherwise administered to the gastrointestinal tract improve the health of the subject. The beneficial bacteria can colonize the gut, allowing for a more persistent beneficial effect.

Importantly, certain members of the Bacillus genus are known to produce antimicrobial compounds capable of inhibiting competing bacteria in the surrounding environment and have demonstrated efficacy in controlling the growth of mastitis-causing organisms. Accordingly, the present disclosure provides specific Bacillus strains and compositions comprising those Bacillus strains for application to bedding to control the growth of mastitis-causing organisms.

Provided herein are Bacillus strains, Bacillus subtilis 839, Bacillus subtilis 4976, and active variants thereof, along with compositions and methods comprising the Bacillus strains for inhibiting the growth of mastitis-causing organisms in the bedding to reduce symptoms and occurrences of mastitis in dairy animals. Bacillus strain compositions provided herein can comprise a bacterial cell, a spore, a forespore, and/or a combination of cells, spores, and/or forespores of Bacillus subtilis 839 or an active variant thereof, and a bacterial cell, a spore, a forespore, and/or a combination of cells, spores, and/or forespores of Bacillus subtilis 4976 or an active variant thereof. The Bacillus strain compositions provided herein can be applied to a bedding at an amount of about 7.5×10⁵ CFU/gram of bedding to about 1×10⁶ CFU/gram of bedding to reduce growth of mastitis-causing organisms. Also provided herein are beddings for dairy cows comprising an effective amount of the Bacillus strain composition provided herein.

Further provided herein are methods for reducing symptoms and/or occurrences of mastitis (e.g., environmental mastitis) in dairy cows, by contacting the bedding with an effective amount of the Bacillus strain composition of the present disclosure. The methods provided herein can reduce growth of one or more mastitis-causing organisms in the bedding, reduce symptoms and/or occurrences of environmental mastitis, and/or reduce somatic cell counts in mile produced by the dairy cow.

### II. Composition Comprising a Bacterial Strain

### A. Bacterial Strains

Bacterial strains are provided which can reduce growth of mastitis-causing organisms. Examples of mastitis-causing organisms include, but are not limited to microorganisms of the genus Staphylococcus, Streptococcus, Enterococcus, Enterobacter, Escherichia, Shigella, Salmonella, Klebsiella, Serratia, Pseudomonas, and Proteus. Such bacterial strains include the Bacillus subtilis strain 839, the Bacillus subtilis strain 4976, and active variants thereof. Cell populations comprising the Bacillus subtilis strain 839, the Bacillus subtilis strain 4976, and/or an active variant thereof are provided, as well as populations of spores derived from each of these strains, or any preparation thereof. Thus, bacterial strains or bacterial strain compositions provided herein comprise as an active ingredient a cell population, spore, forespore, or combination thereof, of the Bacillus subtilis strain 839, the Bacillus subtilis strain 4976, and/or an active variant thereof. In specific embodiments, bacterial strains or bacterial strain compositions provided herein comprise a bacterial cell, a spore, a forespore, and/or a combination of cells, spores, and/or forespores of Bacillus subtilis 839 or an active variant thereof, and a bacterial cell, a spore, a forespore, and/or a combination of cells, spores, and/or forespores of Bacillus subtilis 4976 or an active variant thereof.

Bacillus subtilis strain 839 was deposited with the Patent Depository of the National Center for Agricultural Utilization Research Agricultural Research Service, U.S. Department of Agriculture, 1815 North University Street, Peoria, Illinois 61604 U.S.A. on Apr. 12, 2020 and assigned NRRL No. B-67951.

Bacillus subtilis strain 4976 was deposited with the Patent Depository of the National Center for Agricultural Utilization Research Agricultural Research Service, U.S. Department of Agriculture, 1815 North University Street, Peoria, Illinois 61604 U.S.A. on Apr. 13, 2020 and assigned NRRL No. B-67953.

Each of the deposits identified above will be maintained under the terms of the Budapest Treaty on the International Recognition of the Deposit of Microorganisms for the Purposes of Patent Procedure. Each deposit was made merely as a convenience for those of skill in the art and is not an admission that a deposit is required under 35 U.S.C. § 112.

The term “isolated” encompasses a bacterium, spore, or other entity or substance that has been (1) separated from at least some of the components with which it was associated when initially produced (whether in nature or in an experimental setting), and/or (2) produced, prepared, purified, and/or manufactured by the hand of man. Isolated bacteria may be separated from at least about 10%, about 20%, about 30%, about 40%, about 50%, about 60%, about 70%, about 80%, about 90%, or more of the other components with which they were initially associated.

As used herein, a substance is “pure” if it is substantially free of other components. The terms “purify,” “purifying” and “purified” refer to a bacterium, spore, or other material that has been separated from at least some of the components with which it was associated either when initially produced or generated (e.g., whether in nature or in an experimental setting), or during any time after its initial production. A bacterium or spore or a bacterial population or a spore population may be considered purified if it is isolated at or after production, such as from a material or environment containing the bacterium or bacterial population or spore, and a purified bacterium or bacterial population or spore may contain other materials up to about 10%, about 20%, about 30%, about 40%, about 50%, about 60%, about 70%, about 80%, about 90%, or above about 90% and still be considered purified. In some embodiments, purified bacteria or spores and bacterial populations or spore populations are more than about 80%, about 85%, about 90%, about 91%, about 92%, about 93%, about 94%, about 95%, about 96%, about 97%, about 98%, about 99%, or more than about 99% pure. In specific embodiments, a culture of bacteria contains no other bacterial species in quantities to be detected by normal bacteriological techniques.

By “population” is intended a group or collection that comprises two or more (i.e., 10, 100, 1,000, 10,000, 1×10⁶, 1×10⁷, or 1×10⁸ or greater) cells, spores, forespores, or combination thereof of a given bacterial strain. Various compositions are provided herein that comprise a population of at least one bacterial strain or a mixed population of individuals from more than one bacterial strain. A colony forming unit (CFU) is the viable cell count of a sample resulting from standard microbiological plating methods. The term is derived from the fact that a single cell when plated on appropriate medium will grow and become a viable colony in the agar medium. Since multiple cells may give rise to one visible colony, the term colony forming unit can be a more useful unit measurement than cell number. In specific embodiments, the population of Bacillus subtilis 839, Bacillus subtilis 4976, an active variant thereof, or combination thereof comprises a concentration of at least about 10⁴ CFU/ml to about 10¹² CFU/ml, about 10⁵ CFU/ml to about 10¹² CFU/ml, about 10⁶ CFU/ml to about 10¹² CFU/ml, about 10⁷ CFU/ml to about 10¹² CFU/ml, about 10⁸ CFU/ml to about 10¹² CFU/ml, about 10⁹ CFU/ml to about 10¹² CFU/ml, about 10¹⁰ CFU/ml to about 10¹² CFU/ml, about 10¹¹ CFU/ml to about 10¹² CFU/ml, about 10⁴ CFU/ml to about 10¹¹ CFU/ml, about 10⁵ CFU/ml to about 10¹¹ CFU/ml, about 10⁶ CFU/ml to about 10¹¹ CFU/ml, about 10⁷ CFU/ml to about 10¹¹ CFU/ml, about 10⁸ CFU/ml to about 10¹¹ CFU/ml, about 10⁹ CFU/ml to about 10¹¹ CFU/ml, about 10¹⁰ CFU/ml to about 10¹¹ CFU/ml, about 10⁴ CFU/ml to about 10¹⁰ CFU/ml, about 10⁵ CFU/ml to about 10¹⁰ CFU/ml, about 10⁶ CFU/ml to about 10¹⁰ CFU/ml, about 10⁷ CFU/ml to about 10¹⁰ CFU/ml, about 10⁸ CFU/ml to about 10¹⁰ CFU/ml, about 10⁹ CFU/ml to about 10¹⁰ CFU/ml, about 10⁵ CFU/ml to about 10⁹ CFU/ml, about 10⁵ CFU/ml to about 10⁸ CFU/ml, about 10⁵ CFU/ml to about 10⁷ CFU/ml, or about 10⁵ CFU/ml to about 10⁶ CFU/ml. In other embodiments, the concentration of the bacterial strain provided herein, an active variant thereof, or combination thereof comprises or consists of at least about 10⁴ CFU/ml, at least about 10⁵ CFU/ml, at least about 10⁶ CFU/ml, at least about 10⁷ CFU/ml, at least about 10⁸ CFU/ml, at least about 10⁹ CFU/ml, at least about 10¹⁰ CFU/ml, at least about 10¹¹ CFU/ml, or at least about 10¹² CFU/ml. In specific embodiments, the population of Bacillus subtilis 839, Bacillus subtilis 4976, an active variant thereof, or combination thereof comprises a concentration of at least about 10⁴ CFU/g to about 10¹² CFU/g, about 10⁵ CFU/g to about 10¹² CFU/g, about 10⁶ CFU/g to about 10¹² CFU/g, about 10⁷ CFU/g to about 10¹² CFU/g, about 10⁸ CFU/g to about 10¹² CFU/g, about 10⁹ CFU/g to about 10¹² CFU/g, about 10¹⁰ CFU/g to about 10¹² CFU/g, about 10¹¹ CFU/g to about 10¹² CFU/g, about 10⁵ CFU/g to about 10¹¹ CFU/g, about 10⁵ CFU/g to about 10¹¹ CFU/g, about 10⁶ CFU/g to about 10¹¹ CFU/g, about 10⁷ CFU/g to about 10¹¹ CFU/g, about 10⁸ CFU/g to about 10¹¹ CFU/g, about 10⁹ CFU/g to about 10¹¹ CFU/g, about 10¹⁰ CFU/g to about 10¹¹ CFU/g, about 10⁵ CFU/g to about 10¹⁰ CFU/g, about 10⁶ CFU/g to about 10¹⁰ CFU/g, about 10⁷ CFU/g to about 10¹⁰ CFU/g, about 10⁸ CFU/g to about 10¹⁰ CFU/g, about 10⁹ CFU/g to about 10¹⁰ CFU/g, about 10⁵ CFU/g to about 10⁹ CFU/g, about 10⁵ CFU/g to about 10⁸ CFU/g, about 10⁵ CFU/g to about 10⁷ CFU/g, or about 10⁵ CFU/g to about 10⁶ CFU/g. In other embodiments, the concentration of the bacterial strain provided herein, active variant thereof, or combination thereof comprises or consists of at least about 10⁴ CFU/g, at least about 10⁵ CFU/g, at least about 10⁶ CFU/g, at least about 10⁷ CFU/g, at least about 10⁸ CFU/g, at least about 10⁹ CFU/g, at least about 10¹⁰ CFU/g, at least about 10¹¹ CFU/g, or at least about 10¹² CFU/g. A “spore” or “endospore” refers to at least one dormant (at application) but viable reproductive unit of a bacterial species. Non-limiting methods by which spores are formed from each of Bacillus subtilis 839 and Bacillus subtilis 4976 (or variants of any thereof) are disclosed elsewhere herein. It is further recognized the populations disclosed herein can comprise a combination of vegetative cells and “forespores” (also referred to as “prespores;” the smaller of the two compartments that are formed by asymmetric division of cells in an intermediate stage of spore formation); a combination of forespores and spores; or a combination of forespores, vegetative cells and/or spores. In specific embodiments, the Bacillus subtilis 839 or Bacillus subtilis 4976 (or variant of any thereof) is a viable cell, spore, or forespore.

### B. Active Variants of a Bacterial Strain

Further provided are active variants of Bacillus subtilis 839 or Bacillus subtilis 4976. Active variants of the various bacterial strains provided herein include, for example, any isolate or mutant of Bacillus subtilis 839 or Bacillus subtilis 4976 that retains the ability to inhibit (e.g., reduce the growth of) one or more mastitis-causing organisms. An active variant of Bacillus subtilis 839 or Bacillus subtilis 4976 can, for example, retain at least 60% (e.g., 60%, 65%, 70%, 75%, 80%, 85%, 90%, 95%, 96%, 97%, 98%, 99%, or 100%) inhibitory activity of mastitis-causing organisms (e.g., Staphylococcus, Streptococcus, Enterococcus, Enterobacter, Escherichia, Shigella, Salmonella, Klebsiella, Serratia, Pseudomonas, and Proteus) as compared to Bacillus subtilis 839 or Bacillus subtilis 4976. An active variant includes a strain having all of the identifying characteristics of the recited strain. A “strain of the invention” or a “strain provided herein” includes active variants thereof.

By “modified bacterial strain” is intended a population wherein the strain has been modified (by selection and/or transformation) to have one or more additional traits of interest. Modified bacterial strains can be made through genetic engineering techniques and such engineered or recombinant bacterial strains grown to produce a modified population of bacterial strains. A recombinant bacterial strain can be produced by introducing polynucleotides into the bacterial host cell by transformation or by otherwise altering the native bacterial chromosome sequence, including but not limited to, gene editing approaches. Methods for transforming microorganisms are known and available in the art. See, generally, Hanahan, D. (1983) Studies on transformation of Escherichia coli with plasmids J. Mol. Biol. 166, 557-77; Seidman, C. E. (1994) In: Current Protocols in Molecular Biology, Ausubel, F. M. et al. eds., John Wiley and Sons, NY; Choi et al. (2006) J. Microbiol. Methods 64:391-397; Wang et al. 2010. J Chem. Technol. Biotechnol. 85:775-778. Transformation may occur by natural uptake of naked DNA by competent eel is from their environment in the laboratory. Alternatively, cells can be made competent by exposure to divalent cations under cold conditions, by electroporation, by exposure to polyethylene glycol, by treatment with fibrous nanoparticles, or other methods well known in the art.

Active variants of the various bacteria provided herein can be identified by employing, for example, methods that determine the sequence identity relatedness between the 16S ribosomal RNA, methods to identify groups of derived and functionally identical or nearly identical strains include Multi-locus sequence typing (MLST), concatenated shared genes trees, Whole Genome Alignment (WGA), Average Nucleotide Identity, and MinHash (Mash) distance metric.

In one aspect, the active variants of Bacillus subtilis 839 or Bacillus subtilis 4976 include strains that are closely related to any of the disclosed strains by employing the Bishop MLST method of organism classification as defined in Bishop et al. (2009) BMC Biology 7 (1)1741-7007-7-3. Thus, in specific embodiments, an active variant of a bacterial strain disclosed herein includes a bacterial strain that falls within at least a 80%, 85%, 86%, 87%, 88%, 89%, 90%, 91%, 92%, 93%. 94%, 95%, 96%, 97%, 98%, 98.5%, 98.8%, 99%, 99.1%, 99.2%, 99.3%, 99.4%, 99.5%, 99.6%, 99.7%, 99.8%, or 99.9% sequence cut off employing the Bishop method of organism classification as set forth in Bishop et al. (2009) BMC Biology 7 (1)1741-7007-7-3, which is herein incorporated by reference in its entirety. Active variants of the bacteria identified by such methods will retain the ability to inhibit (e.g., reduce the growth of) one or more mastitis-causing organisms (e.g., Staphylococcus, Streptococcus, Enterococcus, Enterobacter, Escherichia, Shigella, almonella, Klebsiella, Serratia, Pseudomonas, and Proteus).

In some embodiments, the active variant of the bacterial strain(s) disclosed herein include strains that are closely related to any of the disclosed strains on the basis of the Average Nucleotide Identity (ANI) method of organism classification. ANI (see, for example, Konstantinidis, K. T., et al., (2005) PNAS USA 102 (7):2567-72; and Richter, M., et al., (2009) PNAS 106(45):19126-31) and variants (see, for example, Varghese, N. J., et al., Nucleic Acids Research (Jul. 6, 2015): gkv657) are based on summarizing the average nucleotides shared between the genomes of strains that align in WGAs. Thus, in specific embodiments, an active variant of bacterial strain Bacillus subtilis 839 or Bacillus subtilis 4976 disclosed herein includes a bacterial strain that falls within at least a 90%, 95%, 96%, 97%, 97.5%, 98%, 98.5%, 98.8%, 99%, 99.5%, or 99.8% sequence cut off employing the ANI method of organism classification as set forth in Konstantinidis, K. T., et al., (2005) PNAS USA 102 (7):2567-72, which is herein incorporated by reference in its entirety. Active variants of the bacteria identified by such methods will retain the ability to reduce growth or amount of one or more mastitis-causing organisms.

In particular embodiments, the active variants of the isolated bacterial strain(s) disclosed herein include strain(s) that are closely related to Bacillus subtilis 839 or Bacillus subtilis 4976 on the basis of 16S rDNA sequence identity. See Stackebrandt E, et al., “Report of the ad hoc committee for the re-evaluation of the species definition in bacteriology,” Int Syst Evol Microbiol. 52 (3):1043-7 (2002) regarding use of 16S rDNA sequence identity for determining relatedness in bacteria. In an embodiment, the active variant is at least 95% identical to any of the above strains on the basis of 16S rDNA sequence identity, at least 96% identical to any of the above strains on the basis of 16S rDNA sequence identity, at least 97% identical to any of the above strains on the basis of 16S rDNA sequence identity, at least 98% to any of the above strains on the basis of 16S rDNA sequence identity, at least 98.5% identical to any of the above strains on the basis of 16S rDNA sequence identity, at least 99% identical to any of the above strains on the basis of 16S rDNA sequence identity, at least 99.5% to any of the above strains on the basis of 16S rDNA sequence identity or at least 100% to any of the above strains on the basis of 16S rDNA sequence identity. Active variants of the bacteria identified by such methods will retain the ability to reduce amount of growth of one or more mastitis-causing organisms.

The MinHash (Mash) distance metric is a comparison method that defines thresholds for hierarchical classification of microorganisms at high resolution and requires few parameters and steps (Ondov et al. (2016) Genome Biology 17:132). The Mash distance estimates the mutation rate between two sequences directly from their MinHash sketches (Ondov et al. (2016) Genome Biology 17:132). Mash distance strongly corresponds to Average Nucleotide Identity method (ANI) for hierarchical classification (See, Konstantinidis, K. T. et al. (2005) PNAS USA 102(7):2567-72, herein incorporated by reference in its entirety). That is, an ANI of 97% is approximately equal to a Mash distance of 0.03, such that values put forth as useful classification thresholds in the ANI literature can be directly applied with the Mash distance.

Active variants of the bacterial strain(s) disclosed herein include strains that are closely related to Bacillus subtilis 839 or Bacillus subtilis 4976 on the basis of the Minhash (Mash) distance between complete genome DNA sequences. Thus, in specific embodiments, an active variant of a bacterial strain disclosed herein includes bacterial strains having a genome within a Mash distance of less than about 0.015 to the disclosed strains. In other embodiments, an active variant of a bacterial strain disclosed herein includes a distance metric of less than about 0.001, 0.0025, 0.005, 0.010, 0.015, 0.020, 0.025, or 0.030. A genome, as it relates to the Mash distance includes both bacterial chromosomal DNA and bacterial plasmid DNA. In other embodiments, the active variant of a bacterial strain has a genome that is above a Mash distance threshold to the disclosed strains that is greater than dissimilarity caused by technical variance. In further instances, the active variant of a bacterial strain has a genome that is above a Mash distance threshold to the disclosed strains that is greater than dissimilarity caused by technical variance and has a Mash distance of less than about 0.015. In other instances, the active variant of a bacterial strain has a genome that is above a Mash distance threshold to the disclosed strains that is greater than dissimilarity caused by technical variance and has a Mash distance of less than about 0.001, 0.0025, 0.005, 0.010, 0.015, 0.020, 0.025, or 0.030.

As used herein, “above technical variation” means above the Mash distance between two strains caused by errors in the genome assemblies provided the genomes being compared were each DNA sequenced with at least 20× coverage with the Illumina HiSeq 2500 DNA sequencing technology and the genomes are at least 99% complete with evidence for contamination of less than 2%. While 20× coverage is an art recognized term, for clarity, an example of 20× coverage is as follows: for a genome size of 5 megabases (MB), 100 MB of DNA sequencing from the given genome is required to have 20× sequencing coverage on average at each position along the genome. There are many suitable collections of marker genes to use for genome completeness calculations including the sets found in Campbell et al. (2013) PNAS USA 110 (14):5540-45, Dupont et al. (2012) ISMEJ 6:1625-1628, and the CheckM framework (Parks et al. (2015) Genome Research 25:1043-1055); each of these references is herein incorporated in their entirety. Contamination is defined as the percentage of typically single copy marker genes that are found in multiple copies in the given genome sequence (e.g. Parks et al. (2015) Genome Research 25:1043-1055); each of these references is herein incorporated in their entirety. Completeness and contamination are calculated using the same collection of marker genes. Unless otherwise stated, the set of collection markers employed in the completeness and contamination assay is those set forth in Campbell et al. (2013) PNAS USA 110 (14):5540-45, herein incorporated by reference.

Exemplary steps to obtain a distance estimate between the genomes in question are as follows: (1) Genomes of sufficient quality for comparison must be produced. A genome of sufficient quality is defined as a genome assembly created with enough DNA sequence to amount to at least 20× genome coverage using Illumina HiSeq 2500 technology. The genome must be at least 99% complete with contamination of less than 2% to be compared to the claimed microbe's genome. (2) Genomes are to be compared using the Minhash workflow as demonstrated in Ondov et al. (2016) Genome Biology 17:132, herein incorporated by reference in its entirety. Unless otherwise stated, parameters employed are as follows: “sketch” size of 1000, and “k-mer length” of 21. (3) Confirm that the Mash distance between the two genomes is less than 0.001, 0.0025, 0.005, 0.010, 0.015, 0.020, 0.025, or 0.030. Using the parameters and methods stated above, a Mash distance of 0.015 between two genomes means the expected mutation rate is 0.015 mutations per homologous position. Active variants of the bacteria identified by such methods will retain the ability to inhibit (e.g., reduce the growth of) one or more mastitis-causing organisms (e.g., Staphylococcus, Streptococcus, Enterococcus, Enterobacter, Escherichia, Shigella, Salmonella, Klebsiella, Serratia, Pseudomonas, and Proteus).

### C. Methods of Cultivating Bacterial Strains

Populations or cultures of Bacillus subtilis 839, Bacillus subtilis 4976, and/or active variants thereof can be produced by cultivation of the bacterial strain. Cultivation can be started by scaling-up a seed culture. This involves repeatedly and aseptically transferring the culture to a larger and larger volume to serve as the inoculum for the fermentation, which can be carried out in large stainless steel fermentors in medium containing proteins, carbohydrates, and minerals necessary for optimal growth of the strain. Non-limiting exemplary media is Tryptic Soy Broth (TSB) for the Bacillus strains or MRS (de Man, Rogosa, and Sharpe (1960) J. Appl. Bacteriol . 23:130, which is herein incorporated by reference in its entirety) for the Pediococcus strains. After the bacterial inoculum is added to the fermentation vessel, the temperature and agitation are controlled to allow maximum growth. Once the culture reaches a maximum population density, the culture is harvested by separating the cells from the fermentation medium. This separation is commonly performed by centrifugation. The concentration of the bacterial culture can be measured from any sample of fermentation broth or bacterial strain composition.

The various compositions and formulations disclosed herein can comprise an amount of at least one of a bacterial strain (i.e., cells of Bacillus subtilis 839, Bacillus subtilis 4976, or an active variant thereof, or spores or forespores or a combination of cells, forespores and/or spores, formed from Bacillus subtilis 839, Bacillus subtilis 4976, or an active variant thereof). Such an amount can comprise a concentration of at least one (one, two, or more than two) bacterial strains of at least about 10⁴ CFU/g to about 10¹² CFU/g, about 10⁵ CFU/g to about 10¹² CFU/g, about 10⁶ CFU/g to about 10¹² CFU/g, about 10⁷ CFU/g to about 10¹² CFU/g, about 10⁸ CFU/g to about 10¹² CFU/g, about 10⁹ CFU/g to about 10¹² CFU/g, about 10¹⁰ CFU/g to about 10¹² CFU/g, about 10¹¹ CFU/g to about 10¹² CFU/g, about 10⁵ CFU/g to about 10¹¹ CFU/g, about 10⁵ CFU/g to about 10¹¹ CFU/g, about 10⁶ CFU/g to about 10¹¹ CFU/g, about 10⁷ CFU/g to about 10¹¹ CFU/g, about 10⁸ CFU/g to about 10¹¹ CFU/g, about 10⁹ CFU/g to about 10¹¹ CFU/g, about 10¹⁰ CFU/g to about 10¹¹ CFU/g, about 10⁵ CFU/g to about 10¹⁰ CFU/g, about 10⁶ CFU/g to about 10¹⁰ CFU/g, about 10⁷ CFU/g to about 10¹⁰ CFU/g, about 10⁸ CFU/g to about 10¹⁰ CFU/g, about 10⁹ CFU/g to about 10¹⁰ CFU/g, about 10⁵ CFU/g to about 10⁹ CFU/g, about 10⁵ CFU/g to about 10⁸ CFU/g, about 10⁵ CFU/g to about 10⁷ CFU/g, or about 10⁵ CFU/g to about 10⁶ CFU/g. In other embodiments, the concentration of at least one (e.g., one, two, more than two) of the bacterial strains provided herein or active variant thereof comprises or consists of at least about 10⁴ CFU/g, at least about 10⁵ CFU/g, at least about 10⁶ CFU/g, at least about 10⁷ CFU/g, at least about 10⁸ CFU/g, at least about 10⁹ CFU/g, at least about 10¹⁰ CFU/g, at least about 10¹¹ CFU/g, or at least about 10¹² CFU/g. Another such an amount can comprise a concentration of at least one bacterial strain of at least about 10⁴ CFU/ml to about 10¹² CFU/ml, about 10⁵ CFU/ml to about 10¹² CFU/ml, about 10⁶ CFU/ml to about 10¹⁰ CFU/ml, about 10⁷ CFU/ml to about 10¹² CFU/ml, about 10⁸ CFU/ml to about 10¹² CFU/ml, about 10⁹ CFU/ml to about 10¹² CFU/ml, about 10¹⁰ CFU/ml to about 10¹² CFU/ml, about 10¹¹ CFU/ml to about 10¹² CFU/ml, about 10⁵ CFU/ml to about 10¹¹ CFU/ml, about 10⁵ CFU/ml to about 10¹¹ CFU/ml, about 10⁶ CFU/ml to about 10¹¹ CFU/ml, about 10⁷ CFU/ml to about 10¹¹ CFU/ml, about 10⁸ CFU/ml to about 10¹¹ CFU/ml, about 10⁹ CFU/ml to about 10¹¹ CFU/ml, about 10¹⁰ CFU/ml to about 10¹¹ CFU/ml, about 10⁵ CFU/ml to about 10¹⁰ CFU/ml, about 10⁶ CFU/ml to about 10¹⁰ CFU/ml, about 10⁷ CFU/ml to about 10¹⁰ CFU/ml, about 10⁸ CFU/ml to about 10¹⁰ CFU/ml, about 10⁹ CFU/ml to about 10¹⁰ CFU/ml, about 10⁵ CFU/ml to about 10⁹ CFU/ml, about 10⁵ CFU/ml to about 10⁸ CFU/ml, about 10⁵ CFU/ml to about 10⁷ CFU/ml, or about 10⁵ CFU/ml to about 10⁶ CFU/ml. In other embodiments, the concentration of at least one of the bacterial strains provided herein or active variant thereof comprises or consists of at least about 10⁴ CFU/ml, at least about 10⁵ CFU/ml, at least about 10⁶ CFU/ml, at least about 10⁷ CFU/ml, at least about 10⁸ CFU/ml, at least about 10⁹ CFU/ml, at least about 10¹⁰ CFU/ml, at least about 10¹¹ CFU/ml, or at least about 10¹² CFU/ml.

### D. Formulation of a Bacterial Strain

Bacterial strain compositions comprising one or more Bacillus strain of the present disclosure are provided. Such Bacillus strain compositions can reduce growth of one or more mastitis-causing organisms (e.g., Staphylococcus, Streptococcus, Enterococcus, Enterobacter, Escherichia, Shigella, Salmonella, Klebsiella, Serratia, Pseudomonas, and Proteus) in the surroundings, e.g., in a bedding of a dairy animal. The Bacillus strain composition provided herein can comprise a bacterial cell, a spore, a forespore, and/or a combination of cells, spores, and/or forespores of Bacillus subtilis 839, Bacillus subtilis 4976, and/or an active variant thereof.

In some embodiments, the Bacillus strain composition comprises a bacterial cell, a spore, a forespore, and/or a combination of cells, spores, and/or forespores of Bacillus subtilis 839 or an active variant thereof, and a bacterial cell, a spore, a forespore, and/or a combination of cells, spores, and/or forespores of Bacillus subtilis 4976 or an active variant thereof, and inhibits (e.g., reduce growth of) one or more mastitis-causing organisms (e.g., Staphylococcus, Streptococcus, Enterococcus, Enterobacter, Escherichia, Shigella, Salmonella, Klebsiella, Serratia, Pseudomonas, and Proteus). The Bacillus strain composition provided herein can comprise a population (e.g., cells, spores, forespores, or a combination of any thereof) of Bacillus subtilis 839 or an active variant thereof (“Bacillus subtilis 839 population”) and a population (e.g., cells, spores, forespores, or a combination of any thereof) of Bacillus subtilis 4976 (“Bacillus subtilis 4976 population”) at any proportions (e.g., ratios). For example, the Bacillus strain composition can comprise the Bacillus subtilis 839 population and the Bacillus subtilis 4976 population at the ratio of 1% to 99%, 2% to 98%, 5% to 95%, 10% to 90%, 15% to 85%, 20% to 80%, 25% to 75%, 30% to 70%, 35% to 65%, 40% to 60%, 45% to 55%, 50% to 50%, 55% to 45%, 60% to 40%, 65% to 35%, 70% to 30%, 75% to 25%, 80% to 20%, 85% to 15%, 90% to 10%, 95% to 5%, 98% to 2%, or 99% to 1%. In specific embodiments, the Bacillus strain composition comprises the Bacillus subtilis 839 population the Bacillus subtilis 4976 population in equal proportions (i.e., 50% to 50%).

The Bacillus strain composition provided herein can comprise Bacillus strains (e.g., Bacillus subtilis 839, Bacillus subtilis 4976, and/or an active variant thereof), at least one of which can be a powdered and/or lyophilized strain. Lyophilization, or freeze-drying, refers to a process of removing the water from a sample, by freezing and then drying the sample under a vacuum at low temperatures. In the process of lyophilization, the water component in bacterial cells is removed, transforming them into a non-naturally occurring product. Lyophilized Bacillus strains or compositions comprising one or more lyophilized Bacillus strains do not exist in nature and can have significantly increased stability, shelf life, and/or storage duration relative to a non-lyophilized or naturally occurring Bacillus strain counterpart, or a composition comprising the same. For example, a lyophilized Bacillus strain or a composition comprising the same can have stability, shelf life, and/or storage duration that is increased, e.g., increased by about 10%, 15%, 20%, 25%, 30%, 35%, 40%, 45%, 50%, 55%, 60%, 65%, 70%, 75%, 80%, 85%, 90%, 95%, 100%, 200%, 300%, 400%, 500%, 600%, 700%, 800%, 900%, 1000%, or more, or at least 10%, 15%, 20%, 25%, 30%, 35%, 40%, 45%, 50%, 55%, 60%, 65%, 70%, 75%, 80%, 85%, 90%, 95%, 100%, 200%, 300%, 400%, 500%, 600%, 700%, 800%, 900%, 1000%, or more relative to a non-lyophilized or naturally occurring Bacillus strain or composition counterpart. When germinated, a lyophilized Bacillus strain or a composition comprising the same can have significantly different (e.g., increased) biological function, e.g., ability to reduce the growth of one or more mastitis-causing organisms relative to a non-lyophilized or naturally occurring Bacillus strain or composition counterpart stored for the same duration of time. For example, when germinated, a lyophilized Bacillus strain or a composition comprising the same can have inhibitory activity against one or more mastitis-causing organisms that is increased by about 10-100%, 20-100%, 30-100%, 40-100%, 50-100%, 60-100%, 70-100%, 80-100%, 20-90%, 30-90%, 40-90%, 50-90%, 60-90%, 70-90%, 100-1000%, 200-1000%, 300-1000%, 400-1000%, 500-1000%, 600-1000%, 700-1000%, 800-1000%, 200-900%, 300-900%, 400-900%, 500-900%, 600-900%, 700-900%, or more than 1000% (e.g., by about 10-20%, 20-30%, 30-40%, 40-50%, 50-60%, 60-70%, 70-80%, 80-90%, 90-100%, 100-200%, 200-300%, 300-400%, 400-500%, 500-600%, 600-700%, 700-800%, 800-900%, 900-1000%, or more than 1000%), e.g., increased by about 10%, 15%, 20%, 25%, 30%, 35%, 40%, 45%, 50%, 55%, 60%, 65%, 70%, 75%, 80%, 85%, 90%, 95%, 100%, 200%, 300%, 400%, 500%, 600%, 700%, 800%, 900%, 1000%, or more, or at least 10%, 15%, 20%, 25%, 30%, 35%, 40%, 45%, 50%, 55%, 60%, 65%, 70%, 75%, 80%, 85%, 90%, 95%, 100%, 200%, 300%, 400%, 500%, 600%, 700%, 800%, 900%, 1000%, or more relative to a non-lyophilized or naturally occurring Bacillus strain or composition counterpart stored for the same duration of time.

The Bacillus strain composition provided herein can further comprise a cryoprotectant. A “cryoprotectant” as used herein refers to a compound that prevents damage to cells (e.g., bacterial cells) or bacterial strain during freezing. Exemplary cryoprotectants include skim milk (e.g., 10%), glycerin (e.g., 15%), a natural deep eutectic solvent, ice recrystallization inhibitors (e.g., vinyl alcohol, ethylene glycol), sucrose, trehalose, and sodium glutamate. In specific embodiments, the cryoprotectant is not naturally-occurring (i.e., not found in nature) and/or does not naturally occur with the Bacillus strain. In specific embodiments, the cryoprotectant that does not naturally occur with the Bacillus strain improves at least one property of the strain such as stability, activity over time, or solubilization. The Bacillus strain composition provided herein, comprising a cryoprotectant, can be stored at a freezing temperature (e.g., −80° C., −20° C.) (i.e., cryopreservation). Cryopreservation of the Bacillus strain or the Bacillus strain composition provided herein allows for a long storage time, wide range of applications, and low biological mutation rate, and increased inhibitory activity against one or more mastitis-causing organisms as compared to a control composition not comprising a cryoprotectant. In some embodiments, the inhibitory activity against one or more mastitis-causing organisms of the Bacillus strain composition comprising a cryoprotectant is increased by about 10-100%, 20-100%, 30-100%, 40-100%, 50-100%, 60-100%, 70-100%, 80-100%, 20-90%, 30-90%, 40-90%, 50-90%, 60-90%, 70-90%, 100-1000%, 200-1000%, 300-1000%, 400-1000%, 500-1000%, 600-1000%, 700-1000%, 800-1000%, 200-900%, 300-900%, 400-900%, 500-900%, 600-900%, 700-900%, or more than 1000% (e.g., by about 10-20%, 20-30%, 30-40%, 40-50%, 50-60%, 60-70%, 70-80%, 80-90%, 90-100%, 100-200%, 200-300%, 300-400%, 400-500%, 500-600%, 600-700%, 700-800%, 800-900%, 900-1000%, or more than 1000%), e.g., increased by about 10%, 15%, 20%, 25%, 30%, 35%, 40%, 45%, 50%, 55%, 60%, 65%, 70%, 75%, 80%, 85%, 90%, 95%, 100%, 200%, 300%, 400%, 500%, 600%, 700%, 800%, 900%, 1000%, or more, or at least 10%, 15%, 20%, 25%, 30%, 35%, 40%, 45%, 50%, 55%, 60%, 65%, 70%, 75%, 80%, 85%, 90%, 95%, 100%, 200%, 300%, 400%, 500%, 600%, 700%, 800%, 900%, 1000%, or more relative to a control Bacillus strain composition comprising no cryoprotectant.

The Bacillus strain composition provided herein can further comprise a preservative. A “preservative” as used herein refers to a compound that facilitates preservation or prevents decay of cells (e.g., bacterial cells) or bacterial strain. Exemplary preservatives include sulfites (e.g., sodium sulfite, sodium bisulfite, sodium metabisulfite, potassium bisulfite, potassium metabisulfite, sulphur dioxidide), benzoates (e.g., sodium benzoate), and nitrites (e.g., sodium nitrite). In specific embodiments, the preservative is not naturally-occurring (i.e., not found in nature) and/or does not naturally occur with the Bacillus strain. In specific embodiments, the preservative that does not naturally occur with the Bacillus strain improves at least one property of the strain such as stability, activity over time, or solubilization. The Bacillus strain composition comprising a preservative can have increased inhibitory activity against one or more mastitis-causing organisms as compared to a control composition not comprising a preservative. In some embodiments, the inhibitory activity against one or more mastitis-causing organisms of the Bacillus strain composition comprising a preservative is increased by about 10-100%, 20-100%, 30-100%, 40-100%, 50-100%, 60-100%, 70-100%, 80-100%, 20-90%, 30-90%, 40-90%, 50-90%, 60-90%, 70-90%, 100-1000%, 200-1000%, 300-1000%, 400-1000%, 500-1000%, 600-1000%, 700-1000%, 800-1000%, 200-900%, 300-900%, 400-900%, 500-900%, 600-900%, 700-900%, or more than 1000% (e.g., by about 10-20%, 20-30%, 30-40%, 40-50%, 50-60%, 60-70%, 70-80%, 80-90%, 90-100%, 100-200%, 200-300%, 300-400%, 400-500%, 500-600%, 600-700%, 700-800%, 800-900%, 900-1000%, or more than 1000%), e.g., increased by about 10%, 15%, 20%, 25%, 30%, 35%, 40%, 45%, 50%, 55%, 60%, 65%, 70%, 75%, 80%, 85%, 90%, 95%, 100%, 200%, 300%, 400%, 500%, 600%, 700%, 800%, 900%, 1000%, or more, or at least 10%, 15%, 20%, 25%, 30%, 35%, 40%, 45%, 50%, 55%, 60%, 65%, 70%, 75%, 80%, 85%, 90%, 95%, 100%, 200%, 300%, 400%, 500%, 600%, 700%, 800%, 900%, 1000%, or more relative to a control Bacillus strain composition comprising no preservative.

The bacterial strains provided herein (i.e., cells of Bacillus subtilis 839, Bacillus subtilis 4976, or an active variant of any thereof, or spores or forespores or a combination of cells, forespores and/or spores, formed from one or more of Bacillus subtilis 839 or Bacillus subtilis 4976, or an active variant thereof) can be formulated as a paste (e.g., cell paste), a powder, a capsule, a tablet, a granule, a cell pellet, dust, a slurry, aqueous or oil based liquid products, gel, and the like.

Common bacterial strain compositions, such as antibiotic or probiotic preparations, include liquid solutions and concentrates or lyophilized powders for resuspension, which can be enclosed in a capsule, vial, or pouch. Such formulations will comprise the bacterial strains provided herein or an active variant thereof, in addition to carriers and other agents. As used herein, the term “carrier” refers to an inert compound that is compatible with any other ingredients in the formulation and is not deleterious to the active compound (i.e., bacterial strains) or a subject that the formulation is administered thereto. Suitable carriers can be added to improve recovery, efficacy, or physical properties and/or to aid in packaging and administration. Such carriers may be added individually or in combination. Non-limiting examples of carriers include inert diluents (e.g., sodium and calcium carbonate, sodium and calcium phosphate, and lactose), disintegrating agents (e.g., corn starch, alginic acid), binding agents (e.g., starch, gelatin), lubricating agents (e.g., magnesium stearate, stearic acid, talc), sweetening agents, flavoring agents, coloring agents, preservatives, coating agents (e.g., glyceryl monostearate, glyceryl distearate).

In some embodiments, the bacterial strain composition comprises a pharmaceutical composition wherein the bacterial strains provided herein are formulated as a pharmaceutical composition along with a pharmaceutically acceptable carrier. Such pharmaceutically acceptable carriers are known in the art and include an inert vehicle, adjuvants, preservatives etc.

The carrier(s) or pharmaceutically acceptable carrier(s) may comprise about 30% weight per weight, weight per volume, or volume per volume, of the final composition. In some embodiments, the carrier(s) or pharmaceutically acceptable carrier(s) may comprise about 40%, about 50%, about 60%, about 70%, about 80%, about 90%, about 91%, about 92%, about 93%, about 94%, about 95%, about 96%, about 97%, about 98%, about 98.5%, about 99.0%, about 99.5%, or about 99.9% weight per weight, weight per volume, or volume per volume of the final composition.

In some embodiments, the carrier or pharmaceutically acceptable carrier comprises one that is not naturally-occurring (i.e., not found in nature). In particular embodiments, the carrier or pharmaceutically acceptable carrier is a naturally-occurring carrier that is not found with a bacterial strain of the invention in the native environment of the bacterial strain (i.e., a carrier or a pharmaceutically acceptable carrier that is not naturally-occurring with a bacterial cell, spore, or forespore of a bacterial strain of the invention) such that the resulting bacterial strain composition is not naturally occurring.

In some embodiments, the bacterial strain composition disclosed herein is formulated as a liquid formulation or a solid formulation (also referred to as a dry formulation). When the bacterial strain composition is a solid formulation or a dry formulation, it may be formulated as a tablet, a sucking tablet, a chewing tablet, a chewing gum, a capsule, a sachet, a powder, a granule, a coated particle, a coated tablet, an enterocoated tablet, an enterocoated capsule, a melting strip, or a film. When the bacterial strain composition (e.g., pharmaceutical composition) is a liquid formulation, it may be formulated as an oral solution, a suspension, an emulsion or syrup. The composition may further comprise a carrier material independently selected from, but not limited to, the group consisting of vegetables, lactic acid fermented foods, fermented dairy products, resistant starch, dietary fibers, carbohydrates, proteins, and glycosylated proteins. In a specific embodiment, the Bacillus strain composition is in a dry formulation, and comprises a carrier comprising maltodextrin, sucrose, and BAYLITH (zeolite comprising, e.g., silicon dioxide and aluminum oxide). In another specific embodiment, the Bacillus strain composition is in a dry formulation, and comprises a carrier comprising limestone, maltodextrin, and BAYLITH (zeolite comprising, e.g., silicon dioxide and aluminum oxide).

Bacterial compositions of the invention can comprise an enzyme potentiator (i.e., cofactor). Enzyme potentiators may be used to enhance the Bacillus strain's activity to inhibit (e.g., reduce the growth of) one or more mastitis-causing organisms. The enzyme potentiator may be obtained from a natural source, or it may be produced synthetically. In some embodiments, the enzyme potentiator comprises ascorbic acid, also known as ascorbate or vitamin C.

In some embodiments, the bacterial strain composition comprises the bacterial strains (e.g., Bacillus subtilis 839, Bacillus subtilis 4976, or an active variant thereof, e.g., Bacillus subtilis 839 or an active variant thereof, and Bacillus subtilis 4976 or an active variant thereof) at a concentration (e.g., of the two bacterial strains together) of at least about 10⁴ CFU/g to about 10¹² CFU/g, about 10⁵ CFU/g to about 10¹² CFU/g, about 10⁶ CFU/g to about 10¹² CFU/g, about 10⁷ CFU/g to about 10¹² CFU/g, about 10⁸ CFU/g to about 10¹² CFU/g, about 10⁹ CFU/g to about 10¹² CFU/g, about 10¹⁰ CFU/g to about 10¹² CFU/g, about 10¹¹ CFU/g to about 10¹² CFU/g, about 10⁵ CFU/g to about 10¹¹ CFU/g, about 10⁵ CFU/g to about 10¹¹ CFU/g, about 10⁶ CFU/g to about 10¹¹ CFU/g, about 10⁷ CFU/g to about 10¹¹ CFU/g, about 10⁸ CFU/g to about 10¹¹ CFU/g, about 10⁹ CFU/g to about 10¹¹ CFU/g, about 10¹⁰ CFU/g to about 10¹¹ CFU/g, about 10⁵ CFU/g to about 10¹⁰ CFU/g, about 10⁶ CFU/g to about 10¹⁰ CFU/g, about 10⁷ CFU/g to about 10¹⁰ CFU/g, about 10⁸ CFU/g to about 10¹⁰ CFU/g, about 10⁹ CFU/g to about 10¹⁰ CFU/g, about 10⁵ CFU/g to about 10⁹ CFU/g, about 10⁵ CFU/g to about 10⁸ CFU/g, about 10⁵ CFU/g to about 10⁷ CFU/g, or about 10⁵ CFU/g to about 10⁶ CFU/g. In other embodiments, the total concentration of the bacterial strains provided herein or active variant thereof comprises or consists of at least about 10⁴ CFU/g, at least about 10⁵ CFU/g, at least about 10⁶ CFU/g, at least about 10⁷ CFU/g, at least about 10⁸ CFU/g, at least about 10⁹ CFU/g, at least about 10¹⁰ CFU/g, at least about 10¹¹ CFU/g, or at least about 10¹² CFU/g. In specific embodiments, the bacterial strain composition comprises bacterial cell, a spore, a forespore, and/or a combination of cells, spores, and/or forespores of Bacillus subtilis 839 or an active variant thereof and Bacillus subtilis 4976 or an active variant thereof at a concentration of about 7.5×10⁵ CFU/gram to about 1×10⁶ CFU/gram.

In liquid compositions and formulations, the bacterial strains (e.g., Bacillus subtilis 839, Bacillus subtilis 4976, or an active variant thereof, e.g., Bacillus subtilis 839 or an active variant thereof, and Bacillus subtilis 4976 or an active variant thereof) of the composition can comprise a concentration (e.g., of the two bacterial strains together) of at least about 10⁴ CFU/ml to about 10¹² CFU/ml, about 10⁵ CFU/ml to about 10¹² CFU/ml, about 10⁶ CFU/ml to about 10¹² CFU/ml, about 10⁷ CFU/ml to about 10¹² CFU/ml, about 10⁸ CFU/ml to about 10¹² CFU/ml, about 10⁹ CFU/ml to about 10¹² CFU/ml, about 10¹⁰ CFU/ml to about 10¹² CFU/ml, about 10¹¹ CFU/ml to about 10¹² CFU/ml, about 10⁵ CFU/ml to about 10¹¹ CFU/ml, about 10⁵ CFU/ml to about 10¹¹ CFU/ml, about 10⁶ CFU/ml to about 10¹¹ CFU/ml, about 10⁷ CFU/ml to about 10¹¹ CFU/ml, about 10⁸ CFU/ml to about 10¹¹ CFU/ml, about 10⁹ CFU/ml to about 10¹¹ CFU/ml, about 10¹⁰ CFU/ml to about 10¹¹ CFU/ml, about 10⁵ CFU/ml to about 10¹⁰ CFU/ml, about 10⁶ CFU/ml to about 10¹⁰ CFU/ml, about 10⁷ CFU/ml to about 10¹⁰ CFU/ml, about 10⁸ CFU/ml to about 10¹⁰ CFU/ml, about 10⁹ CFU/ml to about 10¹⁰ CFU/ml, about 10⁵ CFU/ml to about 10⁹ CFU/ml, about 10⁵ CFU/ml to about 10⁸ CFU/ml, about 10⁵ CFU/ml to about 10⁷ CFU/ml, or about 10⁵ CFU/ml to about 10⁶ CFU/ml. In other embodiments, the concentration of at least one of the bacterial strains provided herein or active variant thereof comprises or consists of at least about 10⁴ CFU/ml, at least about 10⁵ CFU/ml, at least about 10⁶ CFU/ml, at least about 10⁷ CFU/ml, at least about 10⁸ CFU/ml, at least about 10⁹ CFU/ml, at least about 10¹⁰ CFU/ml, at least about 10¹¹ CFU/ml, or at least about 10¹² CFU/ml. In specific embodiments, the bacterial strain composition comprises bacterial cell, a spore, a forespore, and/or a combination of cells, spores, and/or forespores of Bacillus subtilis 839 or an active variant thereof and Bacillus subtilis 4976 or an active variant thereof at a concentration of about 7.5×10⁵ CFU/ml to about 1×10⁶ CFU/ml.

The Bacillus strain composition provided herein can reduce amount or growth of one or more mastitis-causing organisms (e.g., Staphylococcus, Streptococcus, Enterococcus, Enterobacter, Escherichia, Shigella, Salmonella, Klebsiella, Serratia, Pseudomonas, and Proteus) in a bedding of a dairy cow having been applied an effective amount of said Bacillus strain composition. In some embodiments, the effective amount of the Bacillus strain composition for reducing growth of one or more mastitis-causing organisms in the bedding comprises the Bacillus strains (e.g., Bacillus subtilis 839 or an active variant thereof and Bacillus subtilis 4976 or an active variant thereof) of about 7.5×10⁵ CFU/gram of bedding to about 1×10⁶ CFU/gram of bedding. For example, the effective amount of the Bacillus strain composition can reduce (e.g., inhibit) the growth of one Bacillus strain composition in the bedding by about 5-100%, 10-100%, 20-100%, 30-100%, 40-100%, 50-100%, 60-100%, 70-100%, 80-100%, 20-90%, 30-90%, 40-90%, 50-90%, 60-90%, or 70-90% (e.g., by about 10-20%, 20-30%, 30-40%, 40-50%, 50-60%, 60-70%, 70-80%, 80-90%, or 90-100%), e.g., by about 10%, 15%, 20%, 25%, 30%, 35%, 40%, 45%, 50%, 55%, 60%, 65%, 70%, 75%, 80%, 85%, 90%, 95%, or 100%, or at least 5%, 10%, 15%, 20%, 25%, 30%, 35%, 40%, 45%, 50%, 55%, 60%, 65%, 70%, 75%, 80%, 85%, 90%, 95%, or 100%, as compared to a control bedding not having been applied the Bacillus strain composition provided herein. (e.g., no application or prior to application of the Bacillus strain composition provided herein).

In some embodiments, the Bacillus strain composition provided herein changes the profile of the organisms (e.g., % amount or each organism) present in the bedding. For example, the method can reduce the levels of one or more of Escherichia coli, Klebsiella, total coliforms, Escherichia, Shigella, Staphylococcus, Pseudomonas, Proteus, Serratia, Streptococcus, Salmonella, Entrobacter, and/or Aerococcus in the bedding, and/or increase the levels of one or more of group D streptococci, Enterococcus, Pseudomonas in the bedding. The Bacillus strain composition can produce no significant change in the level of one or more of the organisms provided herein, while producing increase or decrease in other organisms provided herein in the bedding. In some embodiments, the Bacillus strain composition provided herein reduces the diversity (i.e., total number of genera, species, and/or strains) of organisms present in the bedding. For example, the method can reduce (e.g., inhibit) the diversity of mastitis-causing organisms in the bedding by about 1-5%, 5-99%, 10-99%, 20-99%, 30-99%, 40-99%, 50-99%, 60-99%, 70-99%, 80-99%, 20-90%, 30-90%, 40-90%, 50-90%, 60-90%, or 70-90% (e.g., by about 10-20%, 20-30%, 30-40%, 40-50%, 50-60%, 60-70%, 70-80%, 80-90%, or 90-99%), e.g., by about 10%, 15%, 20%, 25%, 30%, 35%, 40%, 45%, 50%, 55%, 60%, 65%, 70%, 75%, 80%, 85%, 90%, 95%, or 99%, or at least 5%, 10%, 15%, 20%, 25%, 30%, 35%, 40%, 45%, 50%, 55%, 60%, 65%, 70%, 75%, 80%, 85%, 90%, 95%, or 99%, as compared to a control bedding (e.g., no application or prior to application of the Bacillus strain composition provided herein).

The change in the amount, growth, profile, and/or diversity of mastitis-causing organisms can be measured by any standard methods for measuring amount of organisms in a sample at a given time or sequentially. For example, amount or growth of mastitis-causing organisms can be measured by obtaining bedding samples at desired locations and timepoints, processing the samples, applying the processed samples onto agar, and incubating for certain time (e.g., 24 hours) for detection of organisms, and analyzing levels of bacteria by sample time point for each sample location using statistical analysis (e.g., one-way ANOVA). For example, CHROMagar™ can be used for the detection of E. coli and total coliforms; MacConkeys-Inositol-Carbenicillin Agar (MCIC) can be used for the detection of presumptive Klebsiella; and Bile Esculin Agar (BEA) can be used for the detection of group D streptococci. Select colonies can be harvested into Tryptic Soy Broth (TSB) for further incubation, the DNA can be extracted from pelleted and lysed cells of isolates, and the 16S rDNA gene can be amplified via PCR for Sanger sequencing of the amplified 16S rDNA gene. Sequences can be identified by comparison to bacterial type strains. In some embodiments, changes in color of the agar can differentiate the isolates grown thereon. For example, the CHROMagar isolates can be differentiated based on color change on the petri plates as E. coli or total coliforms.

Additional beneficial microbes may be combined with a bacterial strain of the invention into a formulated product. Alternatively, additional formulated microbes may be combined or mixed with a formulated bacterial strain of the invention into a composition and applied to, e.g., an animal bedding. Alternatively, the additional microbes may be administered at a different time. The additional beneficial microbes can exhibit an additional or synergistic effect with the Bacillus strain and/or Bacillus strain composition provided herein to inhibit (e.g., reduce the growth of) one or more mastitis-causing organisms. Alternatively, the additional beneficial microbes can exhibit an additional health promoting effect to animals, e.g., dairy cows, for instance by inhibiting other harmful organisms. These additional beneficial microbes may be selected from species of Saccharomyces, species of Bacillus such as Bacillus subtilis, Bacillus licheniformis, Bacillus lentus, Bacillus pumilus, Bacillus laterosporus, Bacillus coagulans, Bacillus alevi, Bacillus cereus, Bacillus clausii, Bacillus coagulans, Bacillus inaquosorum, Bacillus mojavensis, Bacillus velezensis, Bacillus vallismortis, Bacillus amyloliquefaciens, Bacillus atropheus, Bacillus altitudinis, Bacillus safensis, Bacillus alcalophilus, Bacillus badius, or Bacillus thurigiensis; from species of Enterococcus such as Enterococcus faecium; from species of Clostridium such as Clostridium butyricum; from species of Lactococcus such as Lactococcus lactis or Lactoccus cremoris; from species of Bifidobacterium such as Bifidobacterium adolescentis, Bifidobacterium animalis, Bifidobacterium bifidum, Bifidobacterium infantis, Bifidobacterium longum, Bifidobacterium pseudolongum, or Bifidobacterium thermophilum; from species of Lactobacillus such as Lactobacillus alactosus, Lactobacillus alimentarius, Lactobacillus amylovorans, Lactobacillus amylophilus, Lactobacillus amylovorans, Lactobacillus acidophilus, Lactobacillus agilis, Lactobacillus animalis, Lactobacillus batatas, Lactobacillus bavaricus, Lactobacillus bifermentans, Lactobacillus bidifus, Lactobacillus brevis, Lactobacillus buchnerii, Lactobacillus bulgaricus, Lactobacillus catenaforme, Lactobacillus casei, Lactobacillus cellobiosus, Lactobacillus collinoides, Lactobacillus curvatus, Lactobacillus coprohilus, Lactobacillus delbrueckii, Lactobacillus fermentum, Lactobacillus gasseri, Lactobacillus jugurti, Lactobacillus kefir, Lactobacillus lactis, Lactobacillus leichmannii, Lactobacillus mali, Lactobacillus malefermentans, Lactobacillus minor, Lactobacillus minutus, Lactobacillus mobilis, Lactobacillus murinus, Lactobacillus pentosus, Lactobacillus plantarum, Lactobacillus pseudoplantarum, Lactobacillus reuteri, Lactobacillus rhamnosus, Lactobacillus tolerans, Lactobacillus torquens, Lactobacillus ruminis, Lactobacillus sake, Lactobacillus saliverius, Lactobacillus sharpeae, Lactobacillus sobrius, Lactobacillus trichodes, Lactobacillus vaccinostercus, Lactobacillus viridescens, Lactobacillus vitulinus, Lactobacillus xylosus, Lactobacillus yamanashiensis, or Lactobacillus zeae; from species of Megasphaera such as Megasphaera elsdenil; from species of Prevotella such as Prevotella bryantii; from species of Pediococcus such as Pediococcus acidilactici, or Pediococcus pentosaceus; from species of Streptococcus such as Streptococcus cremoris, Streptococcus discetylactis, Streptococcus faecium, Streptococcus lactis, Streptococcus thermophilus, or Streptococcus intermedius; or from species of Propionibacterium such as Propionibacterium freudenreichii, Propionibacterium acidipropionici, Propionibacterium jensenii, Propionibacterium thoenii, Propionibacterium australiense, or Propionibacterium avidum, and/or a combination thereof.

### III. Bedding Comprising a Bacterial Strain

Beddings for dairy animals (e.g., cows) are provided which comprise a Bacillus strain composition and can have reduced growth of mastitis-causing organisms (e.g., Staphylococcus, Streptococcus, Enterococcus, Enterobacter, Escherichia, Shigella, Salmonella, Klebsiella, Serratia, Pseudomonas, and Proteus) therein. A “dairy animal” as used herein refers to any animals domesticated for production of milk or dairy products, including a cow, a goat, a sheep, a water buffalo, or other hooved mammals. In specific embodiments, dairy animals comprises cows (i.e., cattle). A “bedding” as used herein refers to a material for dairy animals (e.g., cows) to support their bodies when resting, sleeping, lying down, or otherwise stationary. In some embodiments, a bedding is a stall bedding. A “stall bedding” as used herein refers to bedding laid in an animal's housing. In a narrower definition, a stall bedding or “stall” refers to used bedding that had been laid on, and “pile” refers to unused bedding prior to going into the stalls. Any types of bedding (e.g., stall bedding) can be used in accordance with the present disclosure, including recycled manure solids (RMS) bedding, composted RMS bedding, digested RMS bedding, sand bedding, recycled sand bedding, corn fodder bedding, corn stalk bedding, riverbed rock bedding, saw dust bedding, straw bedding, and wood shavings bedding.

The beddings provided herein can include an effective amount of the Bacillus strain composition provided herein, e.g., a composition comprising a cell population, spore, forespore, or combination of any thereof, of the Bacillus subtilis strain 839, the Bacillus subtilis strain 4976, and/or an active variant thereof. In specific embodiments, the bedding for dairy animals (e.g., cows) include an effective amount of a Bacillus strain composition comprising a bacterial cell, a spore, a forespore, and/or a combination of cells, spores, and/or forespores of Bacillus subtilis 839 or an active variant thereof, and a bacterial cell, a spore, a forespore, and/or a combination of cells, spores, and/or forespores of Bacillus subtilis 4976 or an active variant thereof.

An “effective amount” of the bacterial strain composition is determined based on the intended goal. The term “unit dose” refers to a physically discrete unit suitable for use in a subject or agricultural animal, e.g., dairy cow, each unit containing a predetermined quantity of the bacterial strain composition calculated to produce the desired response in association with its application. The quantity to be applied, both according to number of applications and unit dose, depends on the animal, the bedding to be treated, the state and environmental conditions of the bedding, and the result desired. Precise amounts of the bacterial strain composition also depend on the judgment of the practitioner and can be unique to each individual.

The effective amount of the Bacillus strain composition in a bedding provided herein can reduce growth of one or more mastitis-causing organisms (e.g., Staphylococcus, Streptococcus, Enterococcus, Enterobacter, Escherichia, Shigella, Salmonella, Klebsiella, Serratia, Pseudomonas, and Proteus) in the bedding. For example, the effective amount of the Bacillus strain composition can reduce (e.g., inhibit) the growth of one or more mastitis-causing organisms (e.g., Staphylococcus, Streptococcus, Enterococcus, Enterobacter, Escherichia, Shigella, Salmonella, Klebsiella, Serratia, Pseudomonas, and Proteus) in the bedding by about 5-100%, 10-100%, 20-100%, 30-100%, 40-100%, 50-100%, 60-100%, 70-100%, 80-100%, 20-90%, 30-90%, 40-90%, 50-90%, 60-90%, or 70-90% (e.g., by about 10-20%, 20-30%, 30-40%, 40-50%, 50-60%, 60-70%, 70-80%, 80-90%, or 90-100%), e.g., by about 10%, 15%, 20%, 25%, 30%, 35%, 40%, 45%, 50%, 55%, 60%, 65%, 70%, 75%, 80%, 85%, 90%, 95%, or 100%, or at least 5%, 10%, 15%, 20%, 25%, 30%, 35%, 40%, 45%, 50%, 55%, 60%, 65%, 70%, 75%, 80%, 85%, 90%, 95%, or 100%, as compared to a control bedding not having been applied the Bacillus strain composition provided herein. In some embodiments, the effective amount of the Bacillus strain composition in a bedding changes the profile of the organisms (e.g., % amount or each organism) present in the bedding. For example, the method can reduce the levels of one or more of Escherichia coli, Klebsiella, total coliforms, Escherichia, Shigella, Staphylococcus, Pseudomonas, Proteus, Serratia, Streptococcus, Salmonella, Entrobacter, and/or Aerococcus in the bedding, and/or increase the levels of one or more of group D streptococci, Enterococcus, Pseudomonas in the bedding. In some embodiments, the effective amount of the Bacillus strain composition can produce no significant change in the level of one or more of the organisms provided herein, while producing increase or decrease in other organisms provided herein in the bedding. In some embodiments, the effective amount of the Bacillus strain composition in a bedding reduces the diversity (i.e., total number of genera, species, and/or strains) of organisms present in the bedding. For example, the method can reduce (e.g., inhibit) the diversity of mastitis-causing organisms in the bedding by about 1-5%, 5-99%, 10-99%, 20-99%, 30-99%, 40-99%, 50-99%, 60-99%, 70-99%, 80-99%, 20-90%, 30-90%, 40-90%, 50-90%, 60-90%, or 70-90% (e.g., by about 10-20%, 20-30%, 30-40%, 40-50%, 50-60%, 60-70%, 70-80%, 80-90%, or 90-99%), e.g., by about 10%, 15%, 20%, 25%, 30%, 35%, 40%, 45%, 50%, 55%, 60%, 65%, 70%, 75%, 80%, 85%, 90%, 95%, or 99%, or at least 5%, 10%, 15%, 20%, 25%, 30%, 35%, 40%, 45%, 50%, 55%, 60%, 65%, 70%, 75%, 80%, 85%, 90%, 95%, or 99%, as compared to a control bedding (e.g., no application or prior to application of the Bacillus strain composition provided herein). The change in the amount, growth, profile, and/or diversity of mastitis-causing organisms can be measured by any standard methods for measuring amount of organisms in a sample at a given time or sequentially. For example, amount or growth of mastitis-causing organisms can be measured by obtaining bedding samples at desired locations and timepoints, processing the samples, applying the processed samples onto agar, and incubating for certain time (e.g., 24 hours) for detection of organisms, and analyzing levels of bacteria by sample time point for each sample location using statistical analysis (e.g., one-way ANOVA). For example, CHROMagar™ can be used for the detection of E. coli and total coliforms; MacConkeys-Inositol-Carbenicillin Agar (MCIC) can be used for the detection of presumptive Klebsiella; and Bile Esculin Agar (BEA) can be used for the detection of group D streptococci. Select colonies can be harvested into Tryptic Soy Broth (TSB) for further incubation, the DNA can be extracted from pelleted and lysed cells of isolates, and the 16S rDNA gene can be amplified via PCR for Sanger sequencing of the amplified 16S rDNA gene. Sequences can be identified by comparison to bacterial type strains. In some embodiments, changes in color of the agar can differentiate the isolates grown thereon. For example, the CHROMagar isolates can be differentiated based on color change on the petri plates as E. coli or total coliforms.

In some embodiments, the bedding comprises an effective amount of the Bacillus strain composition for reducing growth of one or more mastitis-causing organisms, and the effective amount comprises the bacterial strains (e.g., Bacillus subtilis 839, Bacillus subtilis 4976, or an active variant thereof, e.g., Bacillus subtilis 839 or an active variant thereof, and Bacillus subtilis 4976 or an active variant thereof) at a concentration (e.g., of the two bacterial strains together) of at least about 10⁴ CFU/gram of bedding to about 10¹² CFU/gram of bedding, about 10⁵ CFU/gram of bedding to about 10¹² CFU/gram of bedding, about 10⁶ CFU/gram of bedding to about 10¹² CFU/gram of bedding, about 10⁷ CFU/gram of bedding to about 10¹² CFU/gram of bedding, about 10⁸ CFU/gram of bedding to about 10¹² CFU/gram of bedding, about 10⁹ CFU/gram of bedding to about 10¹² CFU/gram of bedding, about 10¹⁰ CFU/gram of bedding to about 10¹² CFU/gram of bedding, about 10¹¹ CFU/gram of bedding to about 10¹² CFU/gram of bedding, about 10⁵ CFU/gram of bedding to about 10¹¹ CFU/gram of bedding, about 10⁵ CFU/gram of bedding to about 10¹¹ CFU/gram of bedding, about 10⁶ CFU/gram of bedding to about 10¹¹ CFU/gram of bedding, about 10⁷ CFU/gram of bedding to about 10¹¹ CFU/gram of bedding, about 10⁸ CFU/gram of bedding to about 10¹¹ CFU/gram of bedding, about 10⁹ CFU/gram of bedding to about 10¹¹ CFU/gram of bedding, about 10¹⁰ CFU/gram of bedding to about 10¹¹ CFU/gram of bedding, about 10⁵ CFU/gram of bedding to about 10¹⁰ CFU/gram of bedding, about 10⁶ CFU/gram of bedding to about 10¹⁰ CFU/gram of bedding, about 10⁷ CFU/gram of bedding to about 10¹⁰ CFU/gram of bedding, about 10⁸ CFU/gram of bedding to about 10¹⁰ CFU/gram of bedding, about 10⁹ CFU/gram of bedding to about 10¹⁰ CFU/gram of bedding, about 10⁵ CFU/gram of bedding to about 10⁹ CFU/gram of bedding, about 10⁵ CFU/gram of bedding to about 10⁸ CFU/gram of bedding, about 10⁵ CFU/gram of bedding to about 10⁷ CFU/gram of bedding, or about 10⁵ CFU/gram of bedding to about 10⁶ CFU/gram of bedding, e.g., at least about 10⁴ CFU/gram of bedding, at least about 10⁵ CFU/gram of bedding, at least about 10⁶ CFU/gram of bedding, at least about 10⁷ CFU/gram of bedding, at least about 10⁸ CFU/gram of bedding, at least about 10⁹ CFU/gram of bedding, at least about 10¹⁰ CFU/gram of bedding, at least about 10¹¹ CFU/gram of bedding, or at least about 10¹² CFU/gram of bedding. In specific embodiments, the bedding comprises an effective amount of the Bacillus strain composition for reducing growth of one or more mastitis-causing organisms, and the effective amount comprises bacterial cells, spores, forespores, and/or a combination of cells, spores, and/or forespores of the Bacillus strains (e.g., Bacillus subtilis 839 or an active variant thereof and Bacillus subtilis 4976 or an active variant thereof) of about 7.5×10⁵ CFU/gram of bedding to about 1×10⁶ CFU/gram of bedding.

The bedding provided herein can comprise a Bacillus strain composition comprising a population (e.g., cells, spores, forespores, or a combination of any thereof) of Bacillus subtilis 839 or an active variant thereof (“Bacillus subtilis 839 population”) and a population (e.g., cells, spores, forespores, or a combination of any thereof) of Bacillus subtilis 4976 (“Bacillus subtilis 4976 population”) at any proportions (e.g., ratios). For example, the bedding can comprise a Bacillus strain composition comprising the Bacillus subtilis 839 population and the Bacillus subtilis 4976 population at the ratio of 1% to 99%, 2% to 98%, 5% to 95%, 10% to 90%, 15% to 85%, 20% to 80%, 25% to 75%, 30% to 70%, 35% to 65%, 40% to 60%, 45% to 55%, 50% to 50%, 55% to 45%, 60% to 40%, 65% to 35%, 70% to 30%, 75% to 25%, 80% to 20%, 85% to 15%, 90% to 10%, 95% to 5%, 98% to 2%, or 99% to 1%. In specific embodiments, the bedding comprises a Bacillus strain composition comprising the Bacillus subtilis 839 population the Bacillus subtilis 4976 population in equal proportions (i.e., 50% to 50%).

The bedding can comprise a Bacillus strain composition provided herein comprising Bacillus strains (e.g., Bacillus subtilis 839, Bacillus subtilis 4976, and/or an active variant thereof), at least one of which can be a powdered and/or lyophilized strain. Lyophilized Bacillus strains, compositions comprising one or more lyophilized Bacillus strains, or beddings comprising lyophilized Bacillus strain compositions do not exist in nature, and can have significantly increased stability, shelf life, and/or storage duration relative to a non-lyophilized or naturally occurring Bacillus strain counterpart, or a composition or a bedding comprising the same. For example, a lyophilized Bacillus strain or a composition comprising the same can have stability, shelf life, and/or storage duration that is increased by about 10-100%, 20-100%, 30-100%, 40-100%, 50-100%, 60-100%, 70-100%, 80-100%, 20-90%, 30-90%, 40-90%, 50-90%, 60-90%, 70-90%, 100-1000%, 200-1000%, 300-1000%, 400-1000%, 500-1000%, 600-1000%, 700-1000%, 800-1000%, 200-900%, 300-900%, 400-900%, 500-900%, 600-900%, 700-900%, or more than 1000% (e.g., by about 10-20%, 20-30%, 30-40%, 40-50%, 50-60%, 60-70%, 70-80%, 80-90%, 90-100%, 100-200%, 200-300%, 300-400%, 400-500%, 500-600%, 600-700%, 700-800%, 800-900%, 900-1000%, or more than 1000%), e.g., increased by about 10%, 15%, 20%, 25%, 30%, 35%, 40%, 45%, 50%, 55%, 60%, 65%, 70%, 75%, 80%, 85%, 90%, 95%, 100%, 200%, 300%, 400%, 500%, 600%, 700%, 800%, 900%, 1000%, or more, or at least 10%, 15%, 20%, 25%, 30%, 35%, 40%, 45%, 50%, 55%, 60%, 65%, 70%, 75%, 80%, 85%, 90%, 95%, 100%, 200%, 300%, 400%, 500%, 600%, 700%, 800%, 900%, 1000%, or more relative to a non-lyophilized or naturally occurring Bacillus strain or composition counterpart. When germinated and as applied to a bedding, a lyophilized Bacillus strain or a composition comprising the same can have significantly different (e.g., increased) biological function, e.g., ability to reduce the growth of one or more mastitis-causing organisms relative to a non-lyophilized or naturally occurring Bacillus strain or composition counterpart that was stored for the same duration of time. For example, when germinated and as applied to the bedding, a lyophilized Bacillus strain or a composition comprising the same can have inhibitory activity against one or more mastitis-causing organisms that is increased by about 10-100%, 20-100%, 30-100%, 40-100%, 50-100%, 60-100%, 70-100%, 80-100%, 20-90%, 30-90%, 40-90%, 50-90%, 60-90%, 70-90%, 100-1000%, 200-1000%, 300-1000%, 400-1000%, 500-1000%, 600-1000%, 700-1000%, 800-1000%, 200-900%, 300-900%, 400-900%, 500-900%, 600-900%, 700-900%, or more than 1000% (e.g., by about 10-20%, 20-30%, 30-40%, 40-50%, 50-60%, 60-70%, 70-80%, 80-90%, 90-100%, 100-200%, 200-300%, 300-400%, 400-500%, 500-600%, 600-700%, 700-800%, 800-900%, 900-1000%, or more than 1000%), e.g., increased by about 10%, 15%, 20%, 25%, 30%, 35%, 40%, 45%, 50%, 55%, 60%, 65%, 70%, 75%, 80%, 85%, 90%, 95%, 100%, 200%, 300%, 400%, 500%, 600%, 700%, 800%, 900%, 1000%, or more, or at least 10%, 15%, 20%, 25%, 30%, 35%, 40%, 45%, 50%, 55%, 60%, 65%, 70%, 75%, 80%, 85%, 90%, 95%, 100%, 200%, 300%, 400%, 500%, 600%, 700%, 800%, 900%, 1000%, or more relative to a non-lyophilized or naturally occurring Bacillus strain or composition counterpart that was stored for the same duration of time.

The bedding can comprise a Bacillus strain composition that further comprises a cryoprotectant. Exemplary cryoprotectants include skim milk (e.g., 10%), glycerin (e.g., 15%), a natural deep eutectic solvent, ice recrystallization inhibitors (e.g., vinyl alcohol, ethylene glycol), sucrose, trehalose, and sodium glutamate. In specific embodiments, the cryoprotectant is not naturally-occurring (i.e., not found in nature). The Bacillus strain composition provided herein, comprising a cryoprotectant, can be stored at a freezing temperature (e.g., −80° C., −20° C.) (i.e., cryopreservation), allowing for a long storage time, low biological mutation rate, and increased inhibitory activity against one or more mastitis-causing organisms as applied to the bedding as compared to a control composition not comprising a cryoprotectant. In some embodiments, the inhibitory activity against one or more mastitis-causing organisms of the bedding comprising the Bacillus strain composition comprising a cryoprotectant is increased by about 10-100%, 20-100%, 30-100%, 40-100%, 50-100%, 60-100%, 70-100%, 80-100%, 20-90%, 30-90%, 40-90%, 50-90%, 60-90%, 70-90%, 100-1000%, 200-1000%, 300-1000%, 400-1000%, 500-1000%, 600-1000%, 700-1000%, 800-1000%, 200-900%, 300-900%, 400-900%, 500-900%, 600-900%, 700-900%, or more than 1000% (e.g., by about 10-20%, 20-30%, 30-40%, 40-50%, 50-60%, 60-70%, 70-80%, 80-90%, 90-100%, 100-200%, 200-300%, 300-400%, 400-500%, 500-600%, 600-700%, 700-800%, 800-900%, 900-1000%, or more than 1000%), e.g., increased by about 10%, 15%, 20%, 25%, 30%, 35%, 40%, 45%, 50%, 55%, 60%, 65%, 70%, 75%, 80%, 85%, 90%, 95%, 100%, 200%, 300%, 400%, 500%, 600%, 700%, 800%, 900%, 1000%, or more, or at least 10%, 15%, 20%, 25%, 30%, 35%, 40%, 45%, 50%, 55%, 60%, 65%, 70%, 75%, 80%, 85%, 90%, 95%, 100%, 200%, 300%, 400%, 500%, 600%, 700%, 800%, 900%, 1000%, or more relative to a bedding comprising a control Bacillus strain composition comprising no cryoprotectant.

The bedding can comprise a Bacillus strain composition that further comprises a preservative. Exemplary preservatives include sulfites (e.g., sodium sulfite, sodium bisulfite, sodium metabisulfite, potassium bisulfite, potassium metabisulfite, sulphur dioxidide), benzoates (e.g., sodium benzoate), and nitrites (e.g., sodium nitrite). In specific embodiments, the preservative is not naturally-occurring (i.e., not found in nature). The bedding comprising a Bacillus strain composition comprising a preservative can have increased inhibitory activity against one or more mastitis-causing organisms as compared to a control bedding not comprising a preservative within the Bacillus strain composition. In some embodiments, the inhibitory activity against one or more mastitis-causing organisms of the bedding comprising the Bacillus strain composition comprising a preservative is increased by about 10-100%, 20-100%, 30-100%, 40-100%, 50-100%, 60-100%, 70-100%, 80-100%, 20-90%, 30-90%, 40-90%, 50-90%, 60-90%, 70-90%, 100-1000%, 200-1000%, 300-1000%, 400-1000%, 500-1000%, 600-1000%, 700-1000%, 800-1000%, 200-900%, 300-900%, 400-900%, 500-900%, 600-900%, 700-900%, or more than 1000% (e.g., by about 10-20%, 20-30%, 30-40%, 40-50%, 50-60%, 60-70%, 70-80%, 80-90%, 90-100%, 100-200%, 200-300%, 300-400%, 400-500%, 500-600%, 600-700%, 700-800%, 800-900%, 900-1000%, or more than 1000%), e.g., increased by about 10%, 15%, 20%, 25%, 30%, 35%, 40%, 45%, 50%, 55%, 60%, 65%, 70%, 75%, 80%, 85%, 90%, 95%, 100%, 200%, 300%, 400%, 500%, 600%, 700%, 800%, 900%, 1000%, or more, or at least 10%, 15%, 20%, 25%, 30%, 35%, 40%, 45%, 50%, 55%, 60%, 65%, 70%, 75%, 80%, 85%, 90%, 95%, 100%, 200%, 300%, 400%, 500%, 600%, 700%, 800%, 900%, 1000%, or more relative to a control bedding comprising a Bacillus strain composition comprising no preservative.

The bedding can comprise a Bacillus strain composition (i.e., comprising cells of Bacillus subtilis 839, Bacillus subtilis 4976, or an active variant of any thereof, or spores or forespores or a combination of cells, forespores and/or spores, formed from one or more of Bacillus subtilis 839 or Bacillus subtilis 4976, or an active variant thereof) that is formulated as a paste (e.g., cell paste), a powder, a capsule, a tablet, a granule, a cell pellet, dust, a slurry, aqueous or oil based liquid products, gel, and the like.

### IV. Methods Comprising a Bacterial Strain

Methods are provided herein for reducing signs, symptoms, and/or occurrences of mastitis (e.g., environmental mastitis) in subjects. By “subject” as used herein is intended mammals, such as mammals that can contract mastitis and can benefit from methods provided herein. In specific embodiments, subjects are dairy animals, e.g., cows, goats, sheep, buffalos, water buffalos. In a specific embodiment, subjects are dairy cows.

The methods can comprise contacting a bedding of a dairy animal (e.g., cow) with an effective amount of a Bacillus strain composition provided herein, e.g., Bacillus subtilis strain 839, the Bacillus subtilis strain 4976, or an active variant thereof. In specific embodiments, the Bacillus strain composition comprises a bacterial cell, a spore, a forespore, and/or a combination of cells, spores, and/or forespores of Bacillus subtilis 839 or an active variant thereof, and a bacterial cell, a spore, a forespore, and/or a combination of cells, spores, and/or forespores of Bacillus subtilis 4976 or an active variant thereof.

Mastitis (e.g., environmental mastitis) can be clinical mastitis or subclinical mastitis. Signs and symptoms of clinical mastitis can include swelling, redness, or warmness to touch of the udder; pain or discomfort in the udder when touched; increase in body temperature; loss of appetite; sunken eyes; reduction in mobility; diarrhea; dehydration; an increased somatic cell count in milk produced; reduction in milk yields; and other changes in milk, e.g., decrease in milk quality (e.g., increased bacteria in milk, reduced shelf life of milk), watery appearance, or milk containing flakes, clots, blood, or pus. In severe cases of clinical mastitis, the animals appear ill. Signs and symptoms of subclinical mastitis may be limited to an increased somatic cell count in milk and a few other symptoms of clinical mastitis. Mastitis in a dam (e.g., high somatic cell count in milk from a dam) can negatively affect milk production from offspring.

The effective amount of the Bacillus strain composition to be applied to a bedding of a dairy animal (e.g., cow) according to the methods provided herein can reduce one or more signs or symptoms of mastitis (e.g., environmental mastitis) in dairy animals. For example, contacting the bedding with the effective amount of the Bacillus strain composition according to the methods provided herein can reduce one or more signs or symptoms of mastitis (e.g., environmental mastitis) in dairy animals (e.g., cows) by about 5-100%, 10-100%, 20-100%, 30-100%, 40-100%, 50-100%, 60-100%, 70-100%, 80-100%, 20-90%, 30-90%, 40-90%, 50-90%, 60-90%, or 70-90% (e.g., by about 10-20%, 20-30%, 30-40%, 40-50%, 50-60%, 60-70%, 70-80%, 80-90%, or 90-100%), e.g., by about 10%, 15%, 20%, 25%, 30%, 35%, 40%, 45%, 50%, 55%, 60%, 65%, 70%, 75%, 80%, 85%, 90%, 95%, or 100%, or at least 5%, 10%, 15%, 20%, 25%, 30%, 35%, 40%, 45%, 50%, 55%, 60%, 65%, 70%, 75%, 80%, 85%, 90%, 95%, or 100%, as compared to a control animal. As used herein, a proper control includes but is not limited to an animal bedding of which the Bacillus strain composition provided herein is not applied to, or an animal prior to application of the Bacillus strain composition to the bedding. One of skill in the art would be able to identify proper controls in order to measure a change (e.g., a reduction) in the signs, symptoms, or occurrences of mastitis in dairy animals.

The effective amount of the Bacillus strain composition to be applied to a bedding of a dairy animal (e.g., cow) according to the methods provided herein can reduce occurrences (e.g., events) of mastitis (e.g., environmental mastitis) (e.g., clinical mastitis, subclinical mastitis) in dairy animals. For example, contacting the bedding with the effective amount of the Bacillus strain composition according to the methods provided herein can reduce mastitis occurrences (e.g., events) in dairy animals (e.g., cows) by about 5-100%, 10-100%, 20-100%, 30-100%, 40-100%, 50-100%, 60-100%, 70-100%, 80-100%, 20-90%, 30-90%, 40-90%, 50-90%, 60-90%, or 70-90% (e.g., by about 10-20%, 20-30%, 30-40%, 40-50%, 50-60%, 60-70%, 70-80%, 80-90%, or 90-100%), e.g., by about 10%, 15%, 20%, 25%, 30%, 35%, 40%, 45%, 50%, 55%, 60%, 65%, 70%, 75%, 80%, 85%, 90%, 95%, or 100%, or at least 5%, 10%, 15%, 20%, 25%, 30%, 35%, 40%, 45%, 50%, 55%, 60%, 65%, 70%, 75%, 80%, 85%, 90%, 95%, or 100%, as compared to a control animal. Contacting the bedding with the effective amount of the Bacillus strain composition according to the methods provided herein can reduce monthly mastitis events in a dairy farm by about 1-5, 1-10, 1-20, 1-30, 1-40, 1-50, 1-100 events (e.g., by about 5-10, 10-20, 30-40, 40-50, 50-60, 60-70, 70-80, 80-90, 90-100 events), e.g., by about 1, 5, 10, 15, 20, 30, 40, 50, 60, 70, 80, 90, 100, or more than 100 events, or at least 1, 5, 10, 15, 20, 25, 30, 35, 40, 45, 50, 60, 70, 80, 90, or 100 events per 1,000 dairy animals (e.g., 1,000 milk cows) as compared to control animals in a control farm (e.g., where the Bacillus strain composition provided herein were not applied to the bedding).

The methods provided herein can be used in any farm having any number of dairy animals (e.g., cows), such as 1, 5, 10, 50, 100, 200, 300, 400, 500, 600, 700, 800, 900, 1000, 1500, or more dairy animals. The methods provided herein can be used in a farm having two or more types of dairy animals, such as cows and goats, or cows and buffalos, by applying an effective amount of the Bacillus strain composition to the bedding of the respective animals.

In some embodiments, the effective amount of the Bacillus strain composition for reducing signs, symptoms, or occurrences of mastitis according to the methods provided herein is at least about 10⁴ CFU to about 10¹² CFU, about 10⁵ CFU to about 10¹² CFU, about 10⁶ CFU to about 10¹² CFU, about 10⁷ CFU to about 10¹² CFU, about 10⁸ CFU to about 10¹² CFU, about 10⁹ CFU to about 10¹² CFU, about 10¹⁰ CFU to about 10¹² CFU, about 10¹¹ CFU to about 10¹² CFU, about 10⁵ CFU to about 10¹¹ CFU, about 10⁵ CFU to about 10¹¹ CFU, about 10⁶ CFU to about 10¹¹ CFU, about 10⁷ CFU to about 10¹¹ CFU, about 10⁸ CFU to about 10¹¹ CFU, about 10⁹ CFU to about 10¹¹ CFU, about 10¹⁰ CFU to about 10¹¹ CFU, about 10⁵ CFU to about 10¹⁰ CFU, about 10⁶ CFU to about 10¹⁰ CFU, about 10⁷ CFU to about 10¹⁰ CFU, about 10⁸ CFU to about 10¹⁰ CFU, or about 10⁹ CFU to about 10¹⁰ CFU. In other embodiments, the effective amount is at least about 10⁴ CFU, at least about 10⁵ CFU, at least about 10⁶ CFU, at least about 10⁷ CFU, at least about 10⁸ CFU, at least about 10⁹ CFU, at least about 10¹⁰ CFU, at least about 10¹¹ CFU, or at least about 10¹² CFU.

In some embodiments, the effective amount of the Bacillus strain composition for reducing signs, symptoms, or occurrences of mastitis according to the methods provided herein comprises the bacterial strains (e.g., Bacillus subtilis 839, Bacillus subtilis 4976, or an active variant thereof, e.g., Bacillus subtilis 839 or an active variant thereof, and Bacillus subtilis 4976 or an active variant thereof) at a concentration (e.g., of the two bacterial strains together) of at least about 10⁴ CFU/gram of bedding to about 10¹² CFU/gram of bedding, about 10⁵ CFU/gram of bedding to about 10¹² CFU/gram of bedding, about 10⁶ CFU/gram of bedding to about 10¹² CFU/gram of bedding, about 10⁷ CFU/gram of bedding to about 10¹² CFU/gram of bedding, about 10⁸ CFU/gram of bedding to about 10¹² CFU/gram of bedding, about 10⁹ CFU/gram of bedding to about 10¹² CFU/gram of bedding, about 10¹⁰ CFU/gram of bedding to about 10¹² CFU/gram of bedding, about 10¹¹ CFU/gram of bedding to about 10¹² CFU/gram of bedding, about 10⁵ CFU/gram of bedding to about 10¹¹ CFU/gram of bedding, about 10⁵ CFU/gram of bedding to about 10¹¹ CFU/gram of bedding, about 10⁶ CFU/gram of bedding to about 10¹¹ CFU/gram of bedding, about 10⁷ CFU/gram of bedding to about 10¹¹ CFU/gram of bedding, about 10⁸ CFU/gram of bedding to about 10¹¹ CFU/gram of bedding, about 10⁹ CFU/gram of bedding to about 10¹¹ CFU/gram of bedding, about 10¹⁰ CFU/gram of bedding to about 10¹¹ CFU/gram of bedding, about 10⁵ CFU/gram of bedding to about 10¹⁰ CFU/gram of bedding, about 10⁶ CFU/gram of bedding to about 10¹⁰ CFU/gram of bedding, about 10⁷ CFU/gram of bedding to about 10¹⁰ CFU/gram of bedding, about 10⁸ CFU/gram of bedding to about 10¹⁰ CFU/gram of bedding, about 10⁹ CFU/gram of bedding to about 10¹⁰ CFU/gram of bedding, about 10⁵ CFU/gram of bedding to about 10⁹ CFU/gram of bedding, about 10⁵ CFU/gram of bedding to about 10⁸ CFU/gram of bedding, about 10⁵ CFU/gram of bedding to about 10⁷ CFU/gram of bedding, about 10⁵ CFU/gram of bedding to about 10⁶ CFU/gram of bedding, e.g., at least about 10⁴ CFU/gram of bedding, at least about 10⁵ CFU/gram of bedding, at least about 10⁶ CFU/gram of bedding, at least about 10⁷ CFU/gram of bedding, at least about 10⁸ CFU/gram of bedding, at least about 10⁹ CFU/gram of bedding, at least about 10¹⁰ CFU/gram of bedding, at least about 10¹¹ CFU/gram of bedding, or at least about 10¹² CFU/gram of bedding. In specific embodiments, the effective amount of the Bacillus strain composition for reducing signs, symptoms, or occurrences of mastitis in dairy animals according to the methods provided herein comprises the bacterial strains (e.g., Bacillus subtilis 839, Bacillus subtilis 4976, or an active variant thereof, e.g., Bacillus subtilis 839 or an active variant thereof, and Bacillus subtilis 4976 or an active variant thereof) of about 7.5×10⁵ CFU/gram of bedding to about 1×10⁶ CFU/gram of bedding.

The Bacillus strain composition according to the methods provided herein can comprise a population (e.g., cells, spores, forespores, or a combination of any thereof) of Bacillus subtilis 839 or an active variant thereof (“Bacillus subtilis 839 population”) and a population (e.g., cells, spores, forespores, or a combination of any thereof) of Bacillus subtilis 4976 (“Bacillus subtilis 4976 population”) at any proportions (e.g., ratios). For example, the Bacillus strain composition can comprise the Bacillus subtilis 839 population and the Bacillus subtilis 4976 population at the ratio of 1% to 99%, 2% to 98%, 5% to 95%, 10% to 90%, 15% to 85%, 20% to 80%, 25% to 75%, 30% to 70%, 35% to 65%, 40% to 60%, 45% to 55%, 50% to 50%, 55% to 45%, 60% to 40%, 65% to 35%, 70% to 30%, 75% to 25%, 80% to 20%, 85% to 15%, 90% to 10%, 95% to 5%, 98% to 2%, or 99% to 1%. In specific embodiments, a Bacillus strain composition comprises the Bacillus subtilis 839 population the Bacillus subtilis 4976 population in equal proportions (i.e., 50% to 50%).

The Bacillus strain composition according to the methods provided herein can comprise Bacillus strains (e.g., Bacillus subtilis 839, Bacillus subtilis 4976, and/or an active variant thereof), at least one of which can be a powdered and/or lyophilized strain. Lyophilized Bacillus strains or compositions comprising one or more lyophilized Bacillus strains can have significantly increased stability, shelf life, and/or storage duration relative to a non-lyophilized or naturally occurring Bacillus strain counterpart, or a composition comprising the same. When germinated and as applied to a bedding according to the methods provided herein, a lyophilized Bacillus strain or a composition comprising the same can have significantly different (e.g., increased) biological function, e.g., ability to reduce the growth of one or more mastitis-causing organisms relative to a non-lyophilized or naturally occurring Bacillus strain or composition counterpart that was stored for the same duration of time.

The Bacillus strain composition according to the methods provided herein can further comprise a cryoprotectant, e.g., skim milk (e.g., 10%), glycerin (e.g., 15%), a natural deep eutectic solvent, ice recrystallization inhibitors (e.g., vinyl alcohol, ethylene glycol), sucrose, trehalose, and sodium glutamate. The Bacillus strain composition comprising a cryoprotectant can be stored at a freezing temperature (e.g., −80° C., −20° C.) (i.e., cryopreservation), allowing for a long storage time, low biological mutation rate, and increased inhibitory activity against one or more mastitis-causing organisms as applied to the bedding as compared to a control composition not comprising a cryoprotectant.

The Bacillus strain composition according to the methods provided herein can further comprise a preservative, e.g., sulfites (e.g., sodium sulfite, sodium bisulfite, sodium metabisulfite, potassium bisulfite, potassium metabisulfite, sulphur dioxidide), benzoates (e.g., sodium benzoate), and nitrites (e.g., sodium nitrite). The Bacillus strain composition comprising a preservative can have increased inhibitory activity against one or more mastitis-causing organisms as applied to the bedding as compared to a control composition not comprising a preservative.

The Bacillus strain composition according to the methods provided herein (i.e., comprising cells of Bacillus subtilis 839, Bacillus subtilis 4976, or an active variant of any thereof, or spores or forespores or a combination of cells, forespores and/or spores, formed from one or more of Bacillus subtilis 839 or Bacillus subtilis 4976, or an active variant thereof) can be formulated as a paste (e.g., cell paste), a powder, a capsule, a tablet, a granule, a cell pellet, dust, a slurry, aqueous or oil based liquid products, gel, and the like, for application onto a bedding of a dairy animal.

A. Contacting a Bedding with a Bacillus Composition

The methods provided herein can comprise contacting (e.g., applying to) a bedding of a dairy animal (e.g., cow) with an effective amount of a Bacillus strain composition provided herein, e.g., Bacillus subtilis strain 839 or an active variant thereof and the Bacillus subtilis strain 4976 or an active variant thereof. Any method of contacting or application can be used, which allows the bacterial strain composition of the invention to come into contact with the bedding. For example, the Bacillus strain composition can be applied to the bedding (e.g., can contact the bedding) by spraying said Bacillus strain composition in liquid formulation onto said bedding. The liquid formulation of the Bacillus strain composition can be prepared from other formulation such as a powder, a capsule, a tablet, a granule, a cell pellet, dust, or a slurry formulation, by, for example, dissolving the composition into an aqueous or oil-based solvent. Any solvent can be used to prepare liquid formulation of the composition, including water. Alternatively or additionally, the Bacillus strain composition can be applied to the bedding (e.g., can contact the bedding) in dry formulation (e.g., in powder form). The dry formulation of the Bacillus strain composition can comprise a carrier, such as a carrier comprising maltodextrin, sucrose, and BAYLITH (zeolite comprising, e.g., silicon dioxide and aluminum oxide), or a carrier comprising limestone, maltodextrin, and BAYLITH (zeolite comprising, e.g., silicon dioxide and aluminum oxide).

An exemplary bedding treatment application protocol includes the following steps to be performed:
1. Turn off pump, remove lid and hose from the 55-gallon drum.
2. Empty the 55-gallon drum remaining liquid into waste holding area.
3. Fill the 55-gallon drum to the black line on the side of the drum with water.
4. Fill white 3.5-gallon bucket ⅔ with water.
5. Add two scoops of the Bacillus strain composition in powder formulation into the 3.5-gallon bucket of water.
6. Whisk powder into water in 3.5-gallon bucket.
7. Pour contents of mixture from the 3.5-gallon bucket into the 55-gallon drum of water.
8. Place hose back in the 55-gallon drum and secure lid.
9. Turn on pump.
10. Spray the water in the drum containing the Bacillus strain composition onto beddings.

The Bacillus strain composition can be applied to the bedding, for example according to the protocol exemplified above in any suitable application schedule (e.g., as to frequency, duration, and dosage). The method can comprise application of multiple doses of the Bacillus strain composition to a bedding. The method may comprise administration of 1, 2, 3, 4, 5, 6, 7, 8, 9, 10, 15, 20, 25, 30, 35, 40, or more effective doses of a bacterial strain composition provided herein. In case of a multiple dose application, the Bacillus strain composition can be applied to the bedding in a regular interval, such as daily (once a day), multiple times a day (e.g., twice a day, three times a day), once in two days, once in three days, once in four days, once in five days, once in six days, once in a week, once in two weeks, once in three weeks, once in two months, or in a longer interval. Alternatively, the Bacillus strain composition can be applied to the bedding in a varied interval, such as daily for 7 days and once in two days thereafter. In some embodiments, doses are administered over the course of 1 day, 2 days, 3 days, 4 days, 5 days, 6 days, 7 days, 10 days, 14 days, 21 days, 30 days, 60 days, 90 days, 100 days, 120 days, 150 days, 180 days, 200 days, 210 days, 240 days, 270 days, 300 days, 330 days, one year, or more than one year. The effective amount or dosage of a bacterial strain composition may increase or decrease over the course of the application. Changes in dosage may result and become apparent from the results of assessment of changes in symptoms, signs, and/or occurrences of mastitis (e.g., environmental mastitis) known in the art and described herein.

The frequency, duration, and dosage of application of multiple doses of the Bacillus strain composition in the methods provided herein can be determined by one skilled in the art so as to reduce symptoms, signs, and/or occurrences of mastitis (e.g., environmental mastitis) when compared to an appropriate control.

In certain embodiments, a bacterial strain or an active variant thereof disclosed herein is administered to a subject or to bedding that is also administered (simultaneously or sequentially) with an additional beneficial microbe. Additional beneficial microbes, such as those described elsewhere herein, may be combined with a bacterial strain of the invention into a formulated product or the beneficial microbes may be administered separately from (before, during, or after) a bacterial strain of the invention. The bacterial strains or an active variants thereof disclosed herein can also be administered to a subject or to bedding that is also administered (simultaneously or sequentially) with an antimicrobial compound, such as an antibiotic compound.

An additional beneficial component (e.g., microbes, probiotics, antimicrobial) may be combined with a bacterial strain of the invention into a formulated product and used in the methods provided herein. Alternatively, additional formulated component may be combined or mixed with a formulated Bacillus strain of the invention into a composition and applied to, e.g., an animal bedding. Alternatively, the additional component may be applied at a different time. The additional component can exhibit an additional or synergistic effect with the Bacillus strain and/or Bacillus strain composition provided herein to inhibit (e.g., reduce the growth of) one or more mastitis-causing organisms and/or to reduce a symptom, sign, or occurrences of mastitis (e.g., environmental mastitis) in dairy animals. Alternatively, the additional component can exhibit an additional health promoting effect to animals, e.g., dairy cows, for instance by inhibiting other harmful organisms.

In the embodiments wherein an additional component is administered separately from a bacterial strain of the invention, the bacterial strain composition may be administered before, during, or after the additional component. The bacterial strain of the invention and the additional component (e.g., beneficial microbe, prebiotic, antibiotic) can be administered to an animal within minutes (e.g., 1, 2, 5, 10, 15, 30, 45 minutes), hours (e.g., 1, 2, 3, 4, 5, 6, 7, 8, 9, 10, 12, 15, 20 hours), or days (e.g., 1, 2, 3, 4, 5, 6, 7 days) of each other.

The Bacillus strain compositions provided herein can be applied along with (simultaneously or sequentially) any other mastitis prevention or treatment modality (e.g., environmental mastitis, contagious mastitis) known in the art. As used herein, “treatment” or “treating” refers to therapeutic (e.g., curing, healing, alleviating, relieving, altering, remedying, ameliorating, improving, or affecting the condition or the symptoms of a subject) and preventative effects. “Prevention” or “preventing” as used herein refers to avoiding occurrence of disease or condition, or signs or symptoms of disease or condition. The prophylactic administration (wherein a therapeutic modality is administered in advance of symptoms or manifestation of the disease or condition) serves to prevent or attenuate any subsequent symptom. When provided at (or shortly after) the onset of a symptom, the therapeutic modality may serve to attenuate any subsequent symptom. Such mastitis prevention or treatment modalities that can be used along with the methods provided herein include but not limited to clean milking practice (e.g., wearing gloves when milking, cleaning or sterilizing milking device, cleaning or sterilizing teats prior to milking), prevention of pathogen contamination or dissemination (e.g., keeping animals standing for at least thirty minutes after milking, using separate milking cups and cleaning items for each cow, separating animals into a high risk group (e.g., having high somatic cell count in milk) and a low risk group (e.g., having low somatic cell count in milk)), and administration of antibiotics or probiotics to the animals (topically or systemically).

The Bacillus strain composition can be applied to any types of bedding according to the methods provided herein, including bedding laid in the stall, used bedding that has been laid by an animal, or fresh bedding inside or outside the stall that has not been laid by an animal. For example, the bedding can be recycled manure solids (RMS) bedding, composted RMS bedding, digested RMS bedding, sand bedding, recycled sand bedding, corn fodder bedding, corn stalk bedding, riverbed rock bedding, saw dust bedding, straw bedding, and wood shavings bedding.

B. Outcomes Associated with the Methods

Methods provided herein for reducing signs, symptoms, and/or occurrences of mastitis (e.g., environmental mastitis) in subjects (e.g., dairy animals) can have outcomes associated with the reduction of signs, symptoms, and/or occurrences of mastitis. In some embodiments, the method reduces amount or growth of one or more mastitis-causing organisms (e.g., Staphylococcus, Streptococcus, Enterococcus, Enterobacter, Escherichia, Shigella, Salmonella, Klebsiella, Serratia, Pseudomonas, and Proteus) in the bedding. In specific embodiments, the method reduces amount or growth of Escherichia coli, Klebsiella, and/or total coliforms in the bedding. For example, the method can reduce (e.g., inhibit) the amount or growth of one or more mastitis-causing organisms (e.g., one or more of Staphylococcus, Streptococcus, Enterococcus, Enterobacter, Escherichia, Shigella, Salmonella, Klebsiella, Serratia, Pseudomonas, and Proteus, e.g., Escherichia coli, Klebsiella, and/or total coliforms) in the bedding by about 5-100%, 10-100%, 20-100%, 30-100%, 40-100%, 50-100%, 60-100%, 70-100%, 80-100%, 20-90%, 30-90%, 40-90%, 50-90%, 60-90%, or 70-90% (e.g., by about 10-20%, 20-30%, 30-40%, 40-50%, 50-60%, 60-70%, 70-80%, 80-90%, or 90-100%), e.g., by about 10%, 15%, 20%, 25%, 30%, 35%, 40%, 45%, 50%, 55%, 60%, 65%, 70%, 75%, 80%, 85%, 90%, 95%, or 100%, or at least 5%, 10%, 15%, 20%, 25%, 30%, 35%, 40%, 45%, 50%, 55%, 60%, 65%, 70%, 75%, 80%, 85%, 90%, 95%, or 100%, as compared to a control bedding (e.g., no application or prior to application of the Bacillus strain composition provided herein).

In some embodiments, the method changes the profile of the organisms (e.g., % amount or each organism) present in the bedding. For example, the method can reduce the levels of one or more of Escherichia coli, Klebsiella, total coliforms, Escherichia, Shigella, Staphylococcus, Pseudomonas, Proteus, Serratia, Streptococcus, Salmonella, Entrobacter, and/or Aerococcus in the bedding, and/or increase the levels of one or more of group D streptococci, Enterococcus, Pseudomonas in the bedding. The method can produce no significant change in the level of one or more of the organisms provided herein, while producing increase or decrease in other organisms provided herein in the bedding. In some embodiments, the method provided herein reduces the diversity (i.e., total number of genera, species, and/or strains) of organisms present in the bedding. For example, the method can reduce (e.g., inhibit) the diversity of mastitis-causing organisms in the bedding by about 1-5%, 5-99%, 10-99%, 20-99%, 30-99%, 40-99%, 50-99%, 60-99%, 70-99%, 80-99%, 20-90%, 30-90%, 40-90%, 50-90%, 60-90%, or 70-90% (e.g., by about 10-20%, 20-30%, 30-40%, 40-50%, 50-60%, 60-70%, 70-80%, 80-90%, or 90-99%), e.g., by about 10%, 15%, 20%, 25%, 30%, 35%, 40%, 45%, 50%, 55%, 60%, 65%, 70%, 75%, 80%, 85%, 90%, 95%, or 99%, or at least 5%, 10%, 15%, 20%, 25%, 30%, 35%, 40%, 45%, 50%, 55%, 60%, 65%, 70%, 75%, 80%, 85%, 90%, 95%, or 99%, as compared to a control bedding (e.g., no application or prior to application of the Bacillus strain composition provided herein).

The change in the amount, growth, profile, and/or diversity of mastitis-causing organisms in beddings can be measured by any standard methods for measuring amount of organisms at a given time or sequentially. For example, amount or growth of mastitis-causing organisms can be measured by obtaining bedding samples at desired locations and timepoints, processing the samples, applying the processed samples onto agar, and incubating for certain time (e.g., 24 hours) for detection of organisms, and analyzing levels of bacteria by sample time point for each sample location using statistical analysis (e.g., one-way ANOVA). For example, CHROMagar™ can be used for the detection of E. coli and total coliforms; MacConkeys-Inositol-Carbenicillin Agar (MCIC) can be used for the detection of presumptive Klebsiella; and Bile Esculin Agar (BEA) can be used for the detection of group D streptococci. Select colonies can be harvested into Tryptic Soy

Broth (TSB) for further incubation, the DNA can be extracted from pelleted and lysed cells of isolates, and the 16S rDNA gene can be amplified via PCR for Sanger sequencing of the amplified 16S rDNA gene. Sequences can be identified by comparison to bacterial type strains. In some embodiments, changes in color of the agar can differentiate the isolates grown thereon. For example, the CHROMagar isolates can be differentiated based on color change on the petri plates as E. coli or total coliforms.

In some embodiments, the method reduces a somatic cell count in milk produced by the animal (e.g., dairy cow). “Somatic cell count” as used herein refers to a total count of somatic cells in a milk specimen. Milk somatic cells comprise a mixture of milk-producing cells and immune cells (e.g., leukocytes) that are secreted in milk during the normal course of milking. Milk somatic cell count is influenced by cow productivity, health, parity, lactation stage, and breed of an animal. Change in environmental conditions, poor management practices, and increase in animal stress levels can increase the amount of somatic cell count in milk. Accordingly, the somatic cell count can be used as an indicator of the quality of milk, with low somatic cell count indicative of low likeliness to contain harmful bacteria, high overall animal wellbeing, high food safety, and a longer shelf life. Somatic cell count in reference (e.g., commercially available, commodity) milk can range from about 130,000 cells/ml to 600,000 cells/ml. The method provided herein can reduce the milk somatic cell count by about 1-5%, 5-99%, 10-99%, 20-99%, 30-99%, 40-99%, 50-99%, 60-99%, 70-99%, 80-99%, 20-90%, 30-90%, 40-90%, 50-90%, 60-90%, or 70-90% (e.g., by about 10-20%, 20-30%, 30-40%, 40-50%, 50-60%, 60-70%, 70-80%, 80-90%, or 90-99%), e.g., by about 10%, 15%, 20%, 25%, 30%, 35%, 40%, 45%, 50%, 55%, 60%, 65%, 70%, 75%, 80%, 85%, 90%, 95%, or 99%, or at least 5%, 10%, 15%, 20%, 25%, 30%, 35%, 40%, 45%, 50%, 55%, 60%, 65%, 70%, 75%, 80%, 85%, 90%, 95%, or 99%, as compared to a control milk (e.g., produced from a control animal without or prior to application of the Bacillus strain composition provided herein). The method can reduce the milk somatic cell count by about 1,000-200,000 cells/ml, 5,000-200,000 cells/ml, 5,000-10,000 cells/ml, 10,000-15,000 cells/ml, 15,000-20,000 cells/ml, or more than 20,000 cells/ml (e.g., by about 1,000-5,000 cells/ml, 5,000-10,000 cells/ml, 10,000-15,000 cells/ml, 15,000-20,000 cells/ml, or more than 20,000 cells/ml), e.g., by 1,000 cells/ml, 2,000 cells/ml, 3,000 cells/ml, 4,000 cells/ml, 5,000 cells/ml, 6,000 cells/ml, 7,000 cells/ml, 8,000 cells/ml, 9,000 cells/ml, 10,000 cells/ml, 11,000 cells/ml, 12,000 cells/ml, 13,000 cells/ml, 14,000 cells/ml, 15,000 cells/ml, 16,000 cells/ml, 17,000 cells/ml, 18,000 cells/ml, 19,000 cells/ml, 20,000 cells/ml, or more than cells/ml, e.g., at least 1,000 cells/ml, 2,000 cells/ml, 3,000 cells/ml, 4,000 cells/ml, 5,000 cells/ml, 6,000 cells/ml, 7,000 cells/ml, 8,000 cells/ml, 9,000 cells/ml, 10,000 cells/ml, 11,000 cells/ml, 12,000 cells/ml, 13,000 cells/ml, 14,000 cells/ml, 15,000 cells/ml, 16,000 cells/ml, 17,000 cells/ml, 18,000 cells/ml, 19,000 cells/ml, or 20,000 cells/ml as compared to control milk (e.g., produced from a control animal without or prior to application of the Bacillus strain composition provided herein). Somatic cell count in milk can be measured by any standard method for measuring cell count in liquid sample. For example, somatic cell count can be measured by obtaining milk samples from desired animals and timepoints, and analyzing cell count therein using manual or automated cytometry or flow cytometry system.

In some embodiments, the method improves quality of milk produced by the cow. Milk quality, also referred to as milk hygiene, can be assessed by the amount of bacteria in the milk. In some embodiments, the method reduces the amount of bacteria (e.g., Staphylococcus, Streptococcus, Enterococcus, Enterobacter, Escherichia, Shigella, Salmonella, Klebsiella, Serratia, Pseudomonas, and Proteus) in the milk. In specific embodiments, the method reduces the amount of bacteria in the milk by about 5-100%, 10-100%, 20-100%, 30-100%, 40-100%, 50-100%, 60-100%, 70-100%, 80-100%, 20-90%, 30-90%, 40-90%, 50-90%, 60-90%, or 70-90% (e.g., by about 10-20%, 20-30%, 30-40%, 40-50%, 50-60%, 60-70%, 70-80%, 80-90%, or 90-100%), e.g., by about 10%, 15%, 20%, 25%, 30%, 35%, 40%, 45%, 50%, 55%, 60%, 65%, 70%, 75%, 80%, 85%, 90%, 95%, or 100%, or at least 5%, 10%, 15%, 20%, 25%, 30%, 35%, 40%, 45%, 50%, 55%, 60%, 65%, 70%, 75%, 80%, 85%, 90%, 95%, or 100%, as compared to control milk (e.g., produced from a control animal without or prior to application of the Bacillus strain composition provided herein).

Methods provided herein can also reduce other signs and symptoms of clinical mastitis in animals (e.g., swelling, redness, or warmness to touch of the udder; pain or discomfort in the udder when touched; increase in body temperature; loss of appetite; sunken eyes; reduction in mobility; diarrhea; dehydration), increase wellbeing of animals, increase milk yields per animal or per farm, increase wellbeing and/or milk production by the animals' offspring, increase shelf life of the milk produced by the animals, prevent inclusion of flakes, clots, blood, or pus in the milk, and improve texture of the milk.

The following examples are offered by way of illustration and not by way of limitation.

### EXPERIMENTAL

### Example 1: Identification of Levels and Types of Mastitis-causing Organisms from Dairy Bedding Samples

### Materials and Methods

Bedding samples (n=847) were collected from 58 different dairies, various bedding types were collected including: recycled manure solids (RMS), composted RMS, digested RMS, corn fodder, corn stalk, riverbed rock, recycled sand, saw dust, straw, and wood shavings. Bedding samples were collected from different locations on the dairies such as: fresh pile samples, where “Pile” refers to unused bedding prior to going into the stalls; and stall samples, where “Stall” refers to used bedding that had been laid on. Stall samples were collected as composite samples from 5-10 stalls, the top 1-2 inches from the surface location that the udder is typically located. If dairies were using composting or heating methods for their RMS preparation, samples were collected directly after the screw press (Pre-pile) and after the intervention (Pile), in addition to stall samples (Stall). Samples were placed on ice and analyzed within twenty-four hours of collection. Samples were mixed thoroughly, then 18 to 22 grams of the bedding material was diluted 1:10 with sterile peptone. Samples were masticated for one minute and target mastitis-causing bacteria were enumerated via streak plate method using: CHROMagar™ ECC (CHROMagar, EF322, Springfield, NJ) for the detection of E. coli and total coliforms; MacConkeys-Inositol-Carbenicillin Agar (MCIC) (Bagley and Seidler, 1978) for the detection of presumptive Klebsiella; and Bile Esculin Agar (BEA, Neogen, NCM0117A, Lansing, MI) for the detection of group D streptococci. Agar plates were incubated at 35° C. (MCIC) or 37° C. (CHROMagar™ ECC and BEA) aerobically for 24 hours. The log transformed levels of bacteria were compared by sample type and sample location using an ordinary one-way ANOVA analysis to determine statistical differences. If present, up to five isolated colonies were harvested from each media type for each sample into Tryptic Soy Broth (TSB) (BD Bacto™, BD211825, Sparks, MD) and incubated aerobically for 24 hours at 37° C. The isolates were stored at −80° C. for later use. The DNA was extracted from pelleted cells of isolates harvested from the MCIC and BEA media types. The CHROMagar isolates were differentiated based on color change on the petri plates as E. coli or total coliforms, for this reason they were not characterized with molecular techniques. Bacterial cells were lysed by incubation for 1 h at 37° C. in 200 μL lysozyme solution (10 mg/mL lysozyme in T50E10) before DNA purification with the Maxwell HT Viral TNA Kit (AX2340, Promega, Madison, WI) according to the manufacturer's methods. To identify bacterial isolates the 16S rDNA gene was amplified via PCR (Barribeau et al., 2014). PCR reactions included 2.5 μl 10× Buffer, 2 mM MgCl₂, 0.2 μM dNTPs, 0.4 μM of each primer, 0.1 μl Platinum® Taq DNA Polymerase (Invitrogen, 10966-018), 2.5 μl template DNA, 16.4 μl ddH₂O for a final volume of 25 μl. The PCR conditions were: 4 minutes at 95° C., followed by 35 cycles of 95° C. for 30 seconds, 50° C. for 30 seconds, 72° C. for 2 minutes finishing with a final elongation of 7 minutes at 72° C. PCR product was sent to Genewiz (genewiz.com) for Sanger sequencing of the amplified 16S rDNA gene. Sequences were identified by comparison to bacterial type strains.

### Results and Discussion

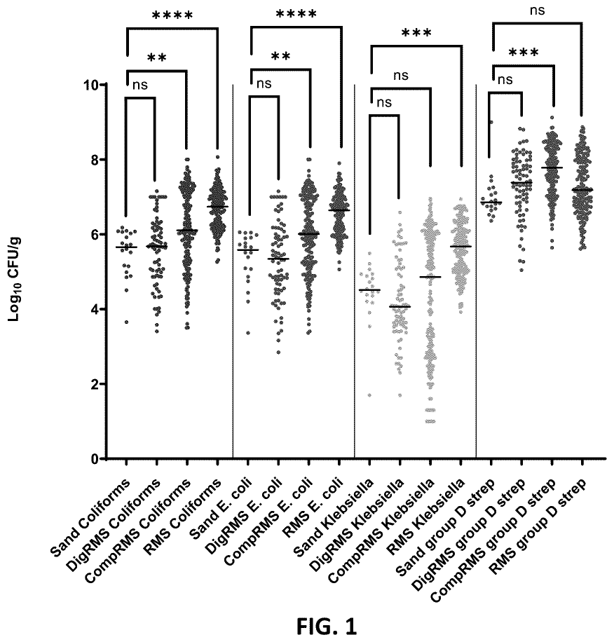

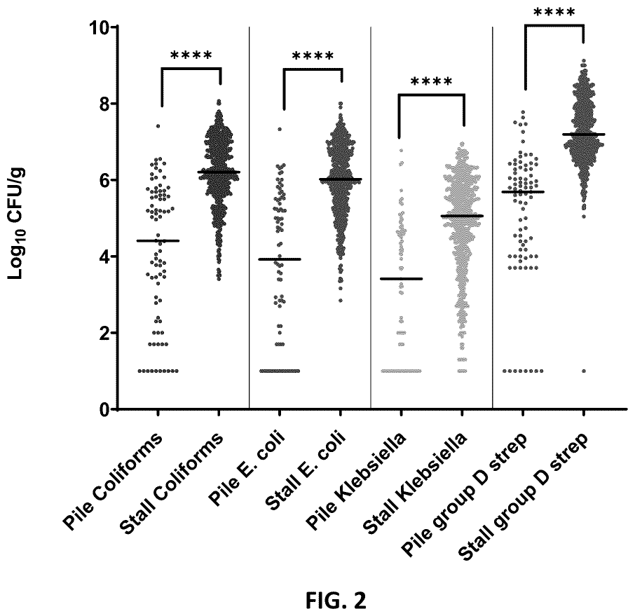

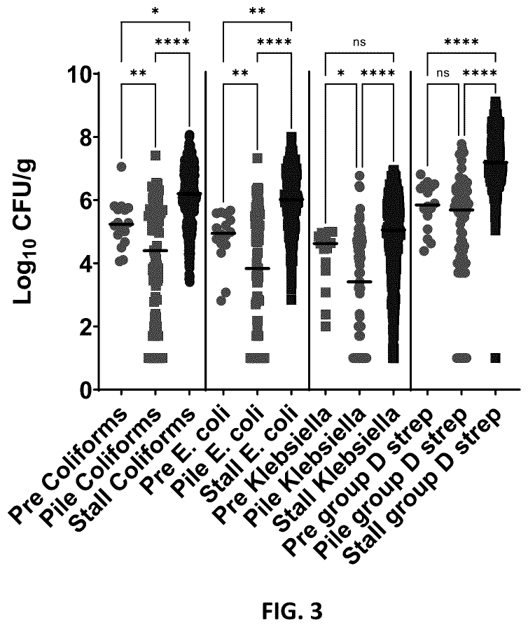

Enumeration results of the 847 bedding samples from 58 different locations, indicated the average level of target bacterial groups are as follows: E. coli of 3.6×10⁶ CFU/g, total coliforms 5.1×10⁶ CFU/g, group D streptococci 6.4×10⁷ CFU/g and presumptive Klebsiella 5.4×10⁵ CFU/g. The most frequently collected Stall bedding types were compared: Sand (n=20), RMS (n=162), Composted RMS (n=78), Digester RMS (n=191). The results were compared using a one-way ANOVA analysis by bedding type for samples collected from the Stall, all bedding material types were compared to sand as this bedding material has less organic material and has been associated with lower bacterial levels. Values were used only if more than four composite stall samples were collected from the dairy to ensure bacterial levels were representative of the dairy bedding. These samples were collected from 18 different dairy farms. Results indicated that Stall Sand bedding E. coli and coliform levels were significantly lower compared to composted RMS and RMS (p<0.05), but not significantly different compared to digester RMS (FIG. 1). Stall Sand bedding presumptive Klebsiella levels were significantly lower than the RMS (p<0.05), but not significantly different compared to the composted or digester RMS. Stall Sand bedding group D streptococci levels were significantly lower compared to the composted RMS (p<0.05), but not significantly different compared to the RMS or digester RMS. Bacterial levels by sample location were also compared using a one-way ANOVA analysis comparing the Pile samples to the Stall samples. Results indicated that all target bacteria levels were significantly higher in the Stall samples compared to the Pile (p<0.05, FIG. 2). Dairies that had Pre-pile interventions such as composting, or heating were also analyzed using a one-way ANOVA analysis. Results indicated that Pre-pile samples were statistically higher for all target bacteria (p<0.05) compared to Pile samples except for the group D streptococci (FIG. 3). However, comparing the Pile samples to the Stall samples, the bacterial levels significantly increased for all target bacteria (p<0.05, FIG. 3).

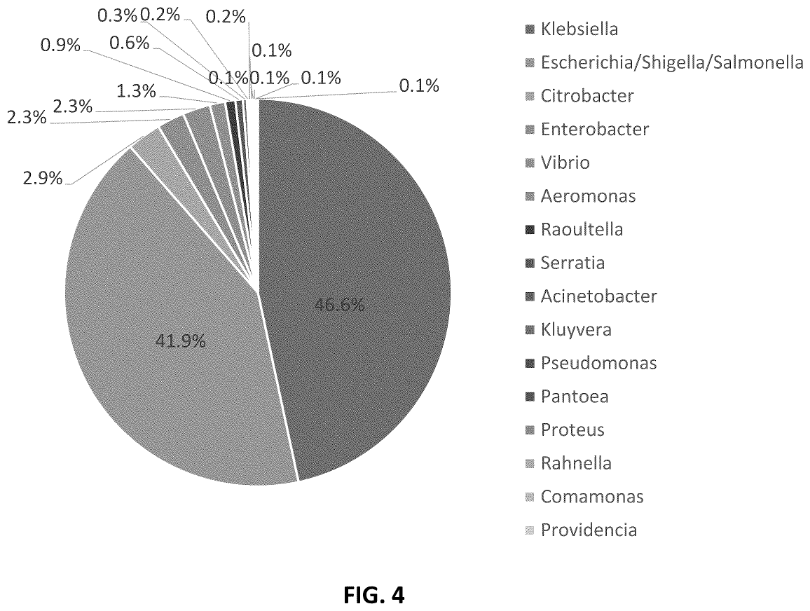

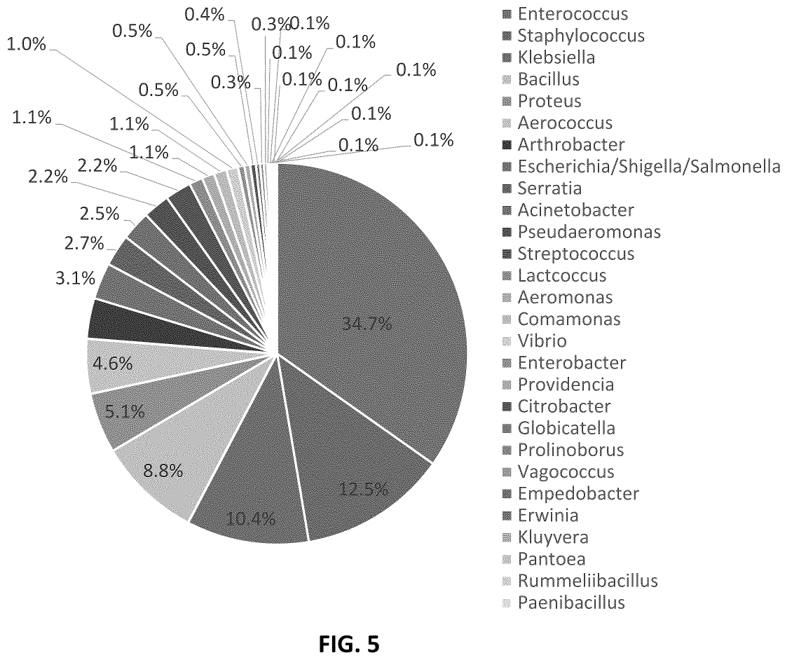

Isolates were harvested from the MCIC agar and the BEA to further characterize these populations. Isolates (n=3,049) from the MCIC agar were most frequently identified as Klebsiella (46.6%) and E. coli/Shigella/Salmonella (41.9%) (FIG. 4). Other genera of interest included: Enterobacter (2.3%), Proteus (0.1%), Pseudomonas (0.2%), and Serratia (0.6%) (FIG. 4). Isolates (n=2,801) harvested from BEA were most frequently identified as Enterococcus (34.7%), Staphylococcus (12.5%) and Klebsiella (10.4%) (FIG. 5). Other genera of interest included: Enterobacter (0.5%), E. coli/Shigella/Salmonella (3.1%), Proteus (5.1%), Serratia (2.7%), and Streptococcus (2.2%) (FIG. 5).

The increased levels of target pathogens in stall samples compared to pile samples indicates bacterial growth or introduction of pathogens from other sources as described in Godden et al. 2008 J. Dairy Sci. 91, 151-159). Using interventions such as composting or heating to reduce pathogen levels was effective as decreased levels of E. coli, total coliforms and presumptive Klebsiella were observed, this has also been observed in previous research (Fournel et al., 2019 J. Dairy Sci. 102, 1847-1865). However, the total levels of all target pathogens increased comparing the post intervention pile to stall samples, indicating that growth or introduction of pathogens from other sources is still occurring. Target pathogenic populations including: Klebsiella, Staphylococcus, Streptococcus, E. coli/Shigella/Salmonella, Enterococcus, Enterobacter, Proteus, Pseudomonas, and Serratia, which have been associated with mastitis (Hogan and Smith, 2012 Vet. Clin. North Am. Food Anim. Pract. 28, 217-224; Singh et al., 2016 J. Livestock Sci. 7, 46-48), were identified and harvested from bedding samples. These data and pathogenic isolates can be used in future research to better understand how to inhibit their growth in bedding systems.

### Example 2: Selection of Bacillus Strains to Inhibit Mastitis-causing Organisms Isolated from Dairy Bedding Samples

### Materials and Methods

Antimicrobial screening was done on representative target mastitis-causing bacterial isolates obtained from bedding samples described in Example 1 to gauge the effectiveness of the antimicrobial supernatant produced by Bacillus subtilis 747, 839, 1704, 1781, 1999, 2018, 4976, and Bacillus licheniformis 15533. Supernatant was harvested by growing each purified Bacillus strain at 32° C. in a shaking incubator at 150 rpms for 12-24 hours in Brain Heart Infusion (BHI) broth. A 1% vol/vol transfer of the 24-hour culture to fresh BHI broth was executed after incubation. The Bacillus were then incubated for 48 hours in a 32° C. shaking incubator at 150 rpms. The culture was then centrifuged at 14,000× g for 20 minutes, supernatant was then filtered with a 0.22 μm filter to remove any residual cells. Sterile aliquots were frozen at −20° C. until used.

A turbidity assay was executed by growing representative target mastitis-causing bacterial strains isolated from bedding samples identified in Example 1 in BHI for 24 hours, aerobically, at 37° C. Overnight culture was transferred (1%) to sterile BHI and immediately used in the assay. Eight replicates of each bacterial isolate were distributed in a sterile 48 well reaction plate. All supernatants were diluted to 25% concentration in sterile peptone prior to the assay to clearly differentiate effectiveness of bacteriocins produced by different strains of Bacillus. Each target isolate was tested as follows: 200 μl of the 1% inoculum in 200 μl BHI (positive control), 200 μl 1% culture with 200 μl bacteriocin from Bacillus subtilis 747, 200 μl 1% culture with 200 μl bacteriocin from Bacillus 839, 200 μl 1% culture with 200 μbacteriocin from Bacillus subtilis 1704, 200 μl 1% culture with 200 μl bacteriocin from Bacillus subtilis 1781, 200 μl 1% culture with 200 μl bacteriocin from Bacillus subtilis 1999, 200 μl 1% culture with 200 μl bacteriocin from Bacillus subtilis 2018, 200 μl 1% culture with 200 μl bacteriocin from Bacillus subtilis 4976, and 400 BHI (negative control). Assay plates were incubated aerobically at 37° C. for 24 hours then read using a BioTek Epoch Microplate Spectrophotometer with readings obtained at a wavelength of 600 nm. Optical density readings from the negative controls were subtracted from all OD readings and percent inhibition was calculated using each treatment well compared to the positive control. Based on results from assay plates, the most effective stains were identified.

### Results and Discussion

Antimicrobial testing using the turbidity assay displayed inhibition of all 64 isolates using supernatant havested from at least one of the following strains 747, 839, 1704, 1781, 1999, 2018, 4976 and 15533 (Table 1). The most effective inhition was observed from Bacillus strains 839 (82%) and 4976 (83%). The least effective inhibition was by Bacillus strain 15533 (34%). To determine each Bacillus strains ability to inhibit individaul isolates, a 60% inhibition threshold was set to identify which Bacillus supernatants were inhibiting the most target mastitis-causing organisms. Bacillus strains 839 and 4976 inhibited the most target organisms 55/64 and 54/61, respectively. Bacillus strain 15533 inhibited the least target organisms 1/27.

Isolates harvested from bedding material described in Example 1 were selected based on previous research of bacteria that have been associated with environmental mastitis (Hogan and Smith, 2012; Singh et al., 2011). The representative isolates in combination with different Bacillus supernatants displayed a wide range of inhibition profiles (Table 1). Not all Bacillus strains inhibited the target organisms equally. These assays indicated that Bacillus subtilis strains 839 and 4976 produced antimicrobial secondary metabolites that were more effective at inhibiting the growth of environmental mastitis-causing organisms compared to the other strains tested. Effectiveness of these strains in inhibiting the growth of mastitis-causing organisms in bedding material to reduce the occurrence of environmental mastitis is evaluated.

TABLE 1
Turbidity assay results displaying each target mastitis-causing bacterial isolate tested
against Bacillus strains 747, 839, 1704, 1781, 1999, 2018, 4976, and 15533

| Sample | | Bacillus strains | | | | | | | |
|---|---|---|---|---|---|---|---|---|---|
| ID | Target 16S ID | 747 | 839 | 1704 | 1781 | 1999 | 2018 | 4976 | 15533 |
| 1 | Proteus | 79% | 74% | 64% | 54% | 67% | N/A | 57% | 50% |
| 2 | Proteus | 99% | 51% | 99% | 99% | 64% | N/A | 70% | 39% |
| 3 | Proteus | 60% | 56% | 43% | 0% | 68% | N/A | 98% | 33% |
| 4 | Proteus | 78% | 69% | 81% | 68% | 75% | N/A | 100% | 42% |
| 5 | Staphylococcus | 69% | 42% | 75% | 83% | 78% | N/A | 72% | 0% |
| 6 | Staphylococcus | 43% | 69% | 82% | 56% | 54% | N/A | 100% | 33% |
| 7 | Staphylococcus | 60% | 64% | 77% | 58% | 73% | N/A | 97% | 45% |
| 8 | Staphylococcus | 25% | 74% | 57% | 52% | 26% | N/A | 75% | 23% |
| 9 | Enterococcus | 86% | 42% | 100% | 100% | 100% | N/A | 42% | 0% |
| 10 | Enterococcus | 65% | 72% | 78% | 76% | 77% | N/A | 68% | 67% |
| 11 | Enterococcus | 78% | 68% | 51% | 56% | 79% | N/A | 100% | 58% |
| 12 | Enterococcus | 72% | 70% | 69% | 73% | 89% | N/A | 67% | 59% |
| 13 | Enterococcus | 22% | 63% | 66% | 76% | 51% | N/A | 66% | 49% |
| 14 | Enterococcus | 59% | 68% | 51% | 52% | 71% | N/A | 64% | 57% |
| 15 | Enterococcus | 92% | 69% | 69% | 74% | 82% | N/A | 71% | 48% |
| 16 | Coliform | 79% | 68% | 61% | 30% | 40% | N/A | 100% | 50% |
| 17 | Coliform | 57% | 58% | 28% | 18% | 34% | N/A | 89% | 52% |
| 18 | Coliform | 63% | 63% | 66% | 64% | 78% | N/A | 57% | 42% |
| 19 | Coliform | 98% | 74% | 98% | 99% | 62% | N/A | 100% | 44% |
| 20 | Coliform | 44% | 87% | 51% | 69% | 64% | N/A | 98% | 10% |
| 21 | Coliform | 73% | 45% | 65% | 53% | 62% | N/A | 93% | 27% |
| 22 | Coliform | 65% | 61% | 59% | 70% | 73% | N/A | 99% | 28% |
| 23 | Klebsiella | 77% | 24% | 55% | 71% | 40% | N/A | 67% | 31% |
| 24 | Klebsiella | 64% | 32% | 63% | 61% | 39% | N/A | 77% | 26% |
| 25 | Coliform | 80% | 97% | 3% | 28% | 28% | 29% | N/A | 0% |
| 26 | Enterobacter | 98% | 99% | 59% | 99% | 68% | 77% | N/A | 3% |
| 27 | Enterobacter | 0% | 98% | 0% | 59% | 4% | 0% | N/A | 0% |
| 28 | E. coli | 79% | 100% | 41% | 100% | 72% | 71% | 91% | N/A |
| 29 | E. coli | 72% | 93% | 96% | 96% | 72% | 88% | 83% | N/A |
| 30 | E. coli | 68% | 100% | 100% | 100% | 76% | 73% | 100% | N/A |
| 31 | E. coli | 19% | 100% | 96% | 99% | 29% | 36% | 70% | N/A |
| 32 | E. coli | 61% | 99% | 91% | 88% | 7% | 67% | 89% | N/A |
| 33 | E. coli | 89% | 100% | 100% | 100% | 0% | 58% | 35% | N/A |
| 34 | E. coli | 40% | 60% | 40% | 51% | 10% | 19% | 62% | N/A |
| 35 | E. coli | 0% | 88% | 76% | 73% | 30% | 13% | 74% | N/A |
| 36 | Enterobacter | 76% | 68% | 33% | 68% | 59% | 58% | 65% | N/A |
| 37 | Enterobacter | 100% | 100% | 39% | 40% | 41% | 73% | 98% | N/A |
| 38 | Enterobacter | 86% | 76% | 49% | 64% | 33% | 56% | 88% | N/A |
| 39 | Enterobacter | 100% | 100% | 70% | 68% | 66% | 73% | 100% | N/A |
| 40 | Klebsiella | 85% | 100% | 100% | 100% | 42% | 72% | 100% | N/A |
| 41 | Klebsiella | 71% | 100% | 100% | 74% | 49% | 72% | 100% | N/A |
| 42 | Klebsiella | 68% | 100% | 100% | 74% | 40% | 57% | 100% | N/A |
| 43 | Klebsiella | 48% | 100% | 93% | 98% | 16% | 42% | 70% | N/A |
| 44 | Klebsiella | 25% | 99% | 75% | 73% | 34% | 73% | 87% | N/A |
| 45 | Klebsiella | 88% | 100% | 100% | 100% | 37% | 77% | 100% | N/A |
| 46 | Klebsiella | 41% | 88% | 81% | 87% | 10% | 41% | 39% | N/A |
| 47 | Proteus | 100% | 100% | 100% | 100% | 100% | 100% | 100% | N/A |
| 48 | Proteus | 100% | 100% | 5% | 76% | 74% | 89% | 100% | N/A |
| 49 | Pseudomonas | 53% | 48% | 10% | 13% | 9% | 24% | 55% | N/A |
| 50 | Pseudomonas | 56% | 94% | 31% | 23% | 50% | 55% | 82% | N/A |
| 51 | Pseudomonas | 100% | 100% | 88% | 80% | 100% | 100% | 73% | N/A |
| 52 | Pseudomonas | 100% | 100% | 45% | 65% | 59% | 75% | 63% | N/A |
| 53 | Pseudomonas | 96% | 98% | 0% | 53% | 58% | 60% | 97% | N/A |
| 54 | Serratia | 100% | 98% | 32% | 57% | 56% | 66% | 100% | N/A |
| 55 | Serratia | 81% | 100% | 100% | 100% | 100% | 100% | 100% | N/A |
| 56 | Serratia | 100% | 98% | 24% | 59% | 60% | 70% | 99% | N/A |
| 57 | Serratia | 63% | 100% | 0% | 73% | 64% | 80% | 100% | N/A |
| 58 | Serratia | 100% | 100% | 43% | 85% | 100% | 100% | 100% | N/A |
| 59 | Streptococcus | 100% | 100% | 12% | 100% | 38% | 55% | 100% | N/A |
| 60 | Streptococcus | 76% | 75% | 3% | 48% | 32% | 45% | 81% | N/A |
| 61 | Streptococcus | 20% | 100% | 100% | 28% | 32% | 100% | 59% | N/A |
| 62 | Streptococcus | 100% | 99% | 5% | 45% | 32% | 45% | 98% | N/A |
| 63 | Streptococcus | 99% | 100% | 100% | 100% | 100% | 100% | 100% | N/A |
| 64 | Streptococcus | 100% | 81% | 9% | 60% | 46% | 62% | 94% | N/A |
| Average Inhibition | | 71% | 82% | 60% | 69% | 54% | 64% | 83% | 34% |
| Number of Isolates <60% | | 16 | 9 | 29 | 22 | 34 | 17 | 7 | 26 |
| Inhibition | | | | | | | | | |

Inhibition was calculated based on the percent of growth for each treatment well compared to the
positive control. “N/A” indicates the Bacillus strain supernatant was not tested in that assay.

### Example 3: The Effect of a Combination of Bacillus Strains Applied to Recycled Manure Solid Bedding on Mastitis-causing Organisms, Somatic Cell Count and Mastitis Events at Farm A in South Dakota

This Example evaluates pathogen inhibition in bedding material and the subsequent impact on SCC and mastitis events on Farm A in South Dakota with the Bacillus strains provided herein (e.g., described in Example 2) in accordance with this embodiment of the present invention (referred to herein as “treated”), over 9.5 months.

### Materials and Methods

A dairy herd in South Dakota, Farm A, was selected to study the impact of the Bacillus product, in accordance with this embodiment of the present invention, on pathogen inhibition in bedding material and the subsequent impact on SCC and mastitis events. The herd consisted of 700 milk cows housed in a free stall, deep bedded barn, bedded with recycled manure solids.

The product, in accordance with this embodiment of the present invention was a combination product of two Bacillus strains in equal proportions: Bacillus subtilis strain 839 and Bacillus subtilis strain 4976, sprayed as liquid application onto the bedding after the screw press at an application of 1×10⁶ CFU per gram of bedding material.

Bedding samples were obtained approximately one month prior to product application. Four composite unused pile samples were collected, each composite sample consisted of five handfuls from different locations in the pile. Stall samples were also collected from the four lactating cow pens. Stall samples were defined as used bedding which had been laid on and had been in the pen for approximately twenty-four hours. A handful of bedding was collected from the top one to two inches from the surface, at the location that the udder is typically located. Approximately every ninth stall in a pen was sampled, these samples were collected as composite samples from five different stalls. Four composite samples were collected from each pen. The same sample collection protocol was used after 102 days of applying the Bacillus to the bedding.

Samples were placed on ice and analyzed within twenty-four hours of collection. Samples were mixed thoroughly, then 18 to 22 grams of the bedding material was diluted 1:10 with sterile peptone. Samples were masticated for one minute and target mastitis-causing bacteria were enumerated via streak plate method using: CHROMagar™ ECC (CHROMagar, EF322, Springfield, NJ) for the detection of E. coli and total coliforms, MacConkeys-Inositol-Carbenicillin Agar (MCIC) (Bagley and Seidler, 1978) for the detection of presumptive Klebsiella, and Bile Esculin Agar (BEA, Neogen, NCM0117A, Lansing, MI) for the detection of group D streptococci. Agar plates were incubated at 35° C. (MCIC) or 37° C. (CHROMagar™ ECC and BEA) aerobically for 24 hours. The log transformed levels of bacteria were compared by sample timepoint for each sample location (pile or stall) using an ordinary one-way ANOVA analysis to determine statistical differences. If present, up to five isolated colonies were harvested from each media type for each sample into Tryptic Soy Broth (TSB) (BD Bacto™, BD211825, Sparks, MD) and incubated aerobically for 24 hours at 37° C. The isolates were stored at −80° C. for later use. The DNA was extracted from pelleted cells of isolates harvested from the MCIC and BEA media types. The CHROMagar isolates were differentiated based on color change on the petri plates as E. coli or total coliforms, for this reason they were not characterized with molecular techniques. Bacterial cells were lysed by incubation for 1 h at 37° C. in 200 μL lysozyme solution (10 mg/mL lysozyme in T50E10) before DNA purification with the Maxwell HT Viral TNA Kit (AX2340, Promega, Madison, WI) according to the manufacturer's methods. To identify bacterial isolates the 16S rDNA gene was amplified via PCR (Barribeau et al., 2014). PCR reactions included 2.5 μl 10× Buffer, 2 mM MgCl₂, 0.2 μM dNTPs, 0.4 μM of each primer, 0.1 μl Platinum® Taq DNA Polymerase (Invitrogen, 10966-018), 2.5 μl template DNA, 16.4 μl ddH₂O for a final volume of 25 μl. The PCR conditions were: 4 minutes at 95° C., followed by 35 cycles of 95° C. for 30 seconds, 50° C. for 30 seconds, 72° C. for 2 minutes finishing with a final elongation of 7 minutes at 72° C. PCR product was sent to Genewiz (genewiz.com) for Sanger sequencing of the amplified 16S rDNA gene. Sequences were identified by comparison to bacterial type strains.

Bulk tank SCC data was received from the milk processing facility. DairyCOMP 305 data was extracted prior to the start of the trial and after the 9.5-month trial period to determine monthly mastitis events. An event gap of 14 days was set prior to analyzing the mastitis event data in DairyCOMP 305 to avoid counting the same mastitis event twice. To avoid confounding effects of seasonality on SCC and mastitis events, data were compared to those from the same time period in the previous year using an unpaired t-test to determine statistical differences between the pretreatment and treatment periods. The data was compared using results from the same 286 days of the trial period from 2020 (Mar. 10, 2020, to Dec. 21, 2020) to the data from the year before Mar. 10, 2019, to Dec. 21, 2019. The dairy was monitored to ensure no major culling events occurred, hospital pen milk was not introduced to the bulk tank and there were no major protocol changes that occurred compared to the year prior that would impact the SCC or mastitis event data.

### Results and Discussion

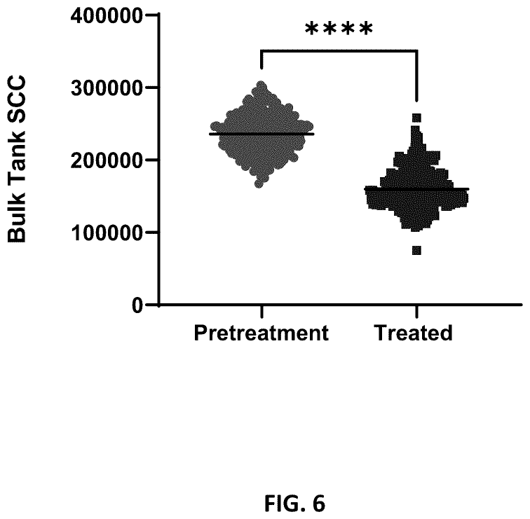

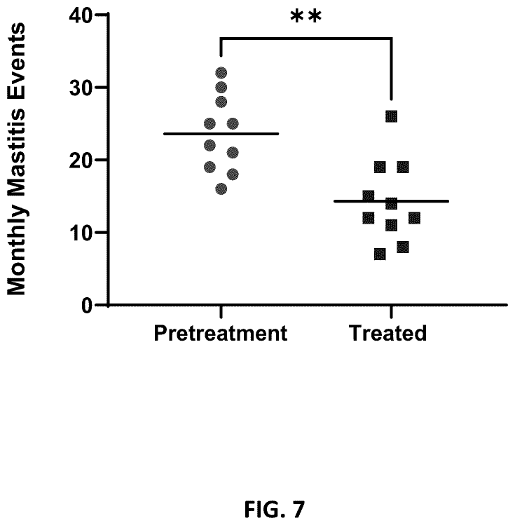

The bulk tank SCC counts significantly decreased (p<0.01) comparing the pretreatment, average 236,000, to the trial period, average 160,000 (FIG. 6). The monthly mastitis events also significantly decreased (p<0.01) comparing the pretreatment period, 24 average events per month, to the trial period, 14 average events per month (FIG. 7).

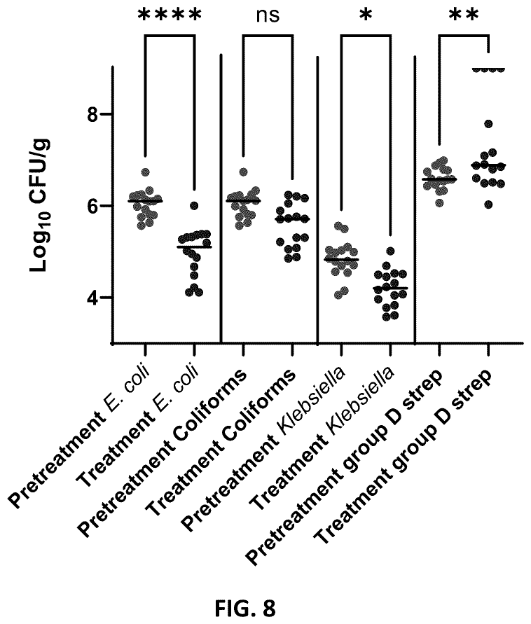

Total coliform levels were not lowered significantly by the bedding treatment (p=0.18), but levels of the potentially pathogenic coliforms, E. coli and Klebsiella were lowered significantly (P<0.01) (FIG. 8). The level of group D streptococci in the treated stall bedding samples were significantly higher compared to the pretreatment stall bedding samples (P<0.03) (FIG. 6). No significant differences were detected in the target bacterial levels comparing the fresh pile samples from the two sampling points (P>0.87).

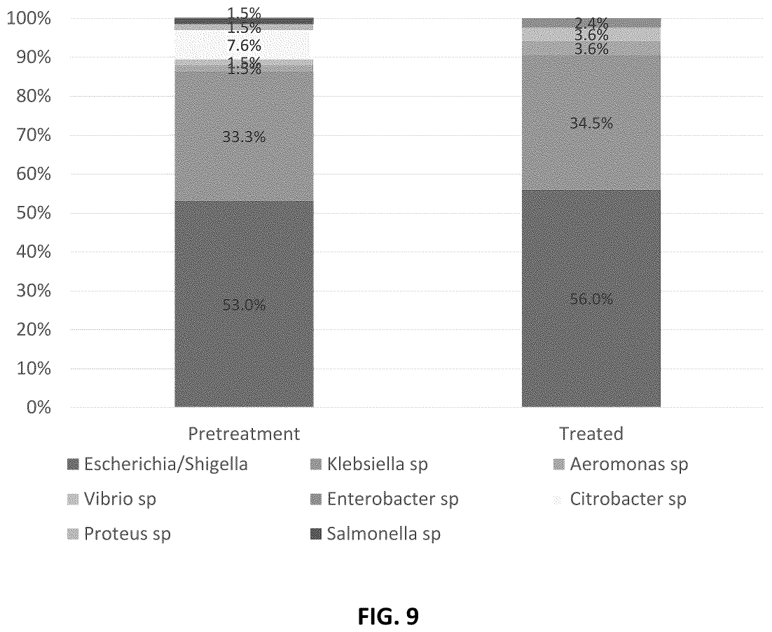

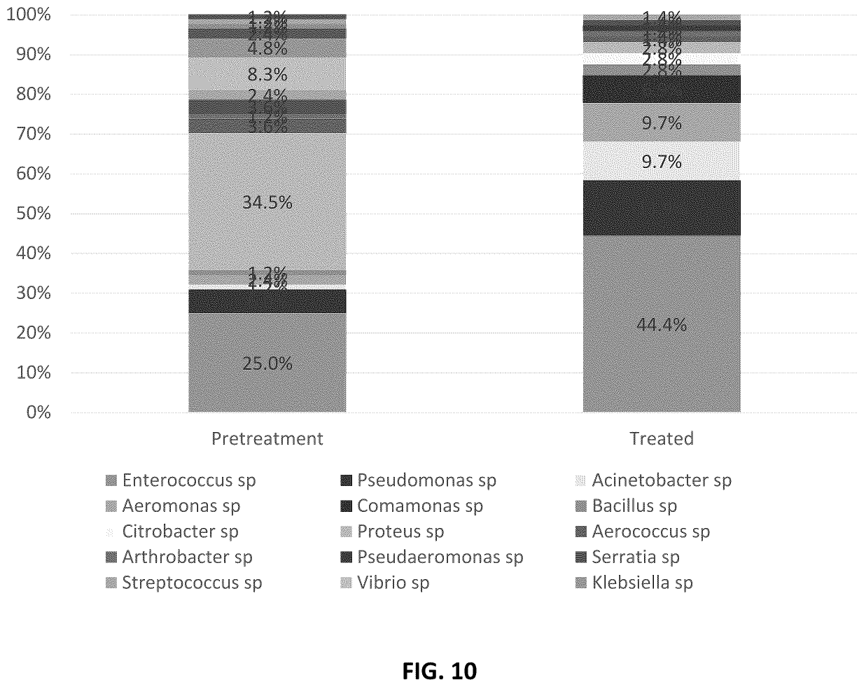

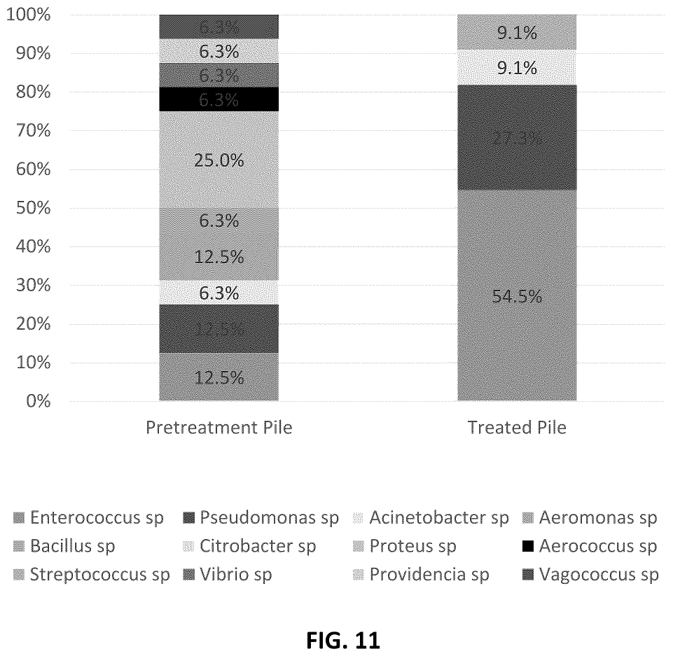

Sanger sequencing of the amplified 16S rDNA gene identification on the isolates harvested from the MacConkey-Inositol-Carbenicillin Agar (presumptive Klebsiella) indicated similar dominant genera comparing the pretreatment and treated samples. The pretreatment isolates were mainly identified as Escherichia/Shigella (53.0%) and Klebsiella (33.3%) which was similar to the treated sample isolates, Escherichia/Shigella (56.0%) and Klebsiella (34.5%) (FIG. 9). Escherichia and Shigella could be distinguished by their sequencing results due to the high degree of similarities between 16S rDNA sanger sequences. Differences in dominant genera were observed in isolates from the Bile Esculin Agar (group D streptococci) comparing the pretreatment to treated samples. The percent of the most abundant genus identified in the pretreatment samples, Proteus (34.5%), decreased in the treated samples to 2.8% (FIG. 10). Enterococcus made up 25.0% of the isolates identified in the pretreatment samples, this was identified as the most dominant genus in treated samples (44.4%). The pile community increased in the percent of Enterococcus isolates from 12.5% to 54.5% and Proteus isolates decreased from 25.0% to 0.0% comparing the pretreatment to treated samples respectively (FIG. 11). Other notable changes that occurred due to treatment were Pseudomonas (6.0%; 13.9%); Serratia (3.6%; 1.4%); Streptococcus (2.4%; 1.4%); Klebsiella (4.8%; 0.0%); Salmonella (2.4%; 0.0%) and Enterobacter (1.2%; 0.0%) comparing the pretreatment to treated samples respectively in Farm A in South Dakota.

The shift in bacterial levels and types of bacteria was accompanied with a decrease of 76,000 SCC and 10 monthly mastitis events during the treatment period. A significant reduction was observed in the levels of E. coli and presumptive Klebsiella in the bedding material during the treatment period. Coliform levels were not significantly different comparing the sampling time points, however the average and median levels of coliforms were lower during the treatment period. The group D streptococci levels were significantly higher during the treatment period, this increase was heavily impacted by four sample values that were much higher compared to the other samples from this sampling point. The increased level of group D streptococci was accompanied by a popluation shift within the representative isolates harvested. The shift indicated a lower percentage of several genera that previous work reported to be assoisated with environmental mastitis: Proteus, Serratia, Streptococcus, Klebsiella, Salmonella and Entrobacter. Although a significant decrease was not observed for all target mastitis-causing organism levels, the decrease in SCC and monthly mastitis events suggests that the populations that were inhibited played a role in the mastitis metrics measured in this study. In conclusion, the blend of Bacillus strains, in accordance with this embodiment of the present invention, significantly reduced E. coli, presumptive Klebsiella, SCC and mastitis events during the treatment period.

### Example 4: The Effect of a Combination of Bacillus Strains Applied to Recycled Manure Solid Bedding on Mastitis-causing Organisms, Somatic Cell Count and Mastitis Events at Farm B in South Dakota

This Example evaluates pathogen inhibition in bedding material and the subsequent impact on SCC and mastitis events on Farm B in South Dakota with the Bacillus strains provided herein (e.g., described in Example 2) in accordance with this embodiment of the present invention (referred to herein as “treated”), over 10 months.

### Materials and Methods

A dairy herd in South Dakota, Farm B, was selected to study the impact of the Bacillus product, in accordance with this embodiment of the present invention, on pathogen inhibition in bedding material and the subsequent impact on SCC and mastitis events. The herd consisted of 750 milk cows housed in a free stall, deep bedded barn, bedded with recycled manure solids.

The product, in accordance with this embodiment of the present invention was two Bacillus strains in equal proportions: Bacillus subtilis strain 839 and Bacillus subtilis strain 4976, sprayed as liquid application onto the bedding after the screw press at an application of 1×10⁶ CFU per gram of bedding material.

Bedding samples were obtained approximately one month prior to product application. One composite unused pile sample was collected, each composite sample consisted of five handfuls from different locations in the pile. Stall samples were also collected from the ten pens. Stall samples were defined as used bedding which had been laid on and had been in the pen for approximately twenty-four hours. A handful of bedding was collected from the top one to two inches from the surface, at the location that the udder is typically located. Approximately every seventh stall in a pen was sampled, these samples were collected as composite samples from five different stalls. Two composite samples were collected from each pen. The same sample collection protocol was used after 112 days of applying the Bacillus to the bedding.

Samples were placed on ice and analyzed within twenty-four hours of collection. Samples were mixed thoroughly, then 18 to 22 grams of the bedding material was diluted 1:10 with sterile peptone. Samples were masticated for one minute and target mastitis-causing bacteria were enumerated via streak plate method using: CHROMagar™ ECC (CHROMagar, EF322, Springfield, NJ) for the detection of E. coli and total coliforms, MacConkeys-Inositol-Carbenicillin Agar (MCIC) (Bagley and Seidler, 1978) for the detection of presumptive Klebsiella, and Bile Esculin Agar (BEA, Neogen, NCM0117A, Lansing, MI) for the detection of group D streptococci. Agar plates were incubated at 35° C. (MCIC) or 37° C. (CHROMagar™ ECC and BEA) aerobically for 24 hours. The log transformed levels of bacteria were compared by sample timepoint for each sample location (pile or stall) using an ordinary one-way ANOVA analysis to determine statistical differences. If present, up to five isolated colonies were harvested from each media type for each sample into Tryptic Soy Broth (TSB) (BD Bacto™, BD211825, Sparks, MD) and incubated aerobically for 24 hours at 37° C. The isolates were stored at −80° C. for later use. The DNA was extracted from pelleted cells of isolates harvested from the MCIC and BEA media types. The CHROMagar isolates were differentiated based on color change on the petri plates as E. coli or total coliforms, for this reason they were not characterized with molecular techniques. Bacterial cells were lysed by incubation for 1 h at 37° C. in 200 μL lysozyme solution (10 mg/mL lysozyme in T50E10) before DNA purification with the Maxwell HT Viral TNA Kit (AX2340, Promega, Madison, WI) according to the manufacturer's methods. To identify bacterial isolates the 16S rDNA gene was amplified via PCR (Barribeau et al., 2014). PCR reactions included 2.5 μl 10× Buffer, 2 mM MgCl2, 0.2 μM dNTPs, 0.4 μM of each primer, 0.1 μl Platinum® Taq DNA Polymerase (Invitrogen, 10966-018), 2.5 μl template DNA, 16.4 μl ddH2O for a final volume of 25 μl. The PCR conditions were: 4 minutes at 95° C., followed by 35 cycles of 95° C. for 30 seconds, 50° C. for 30 seconds, 72° C. for 2 minutes finishing with a final elongation of 7 minutes at 72° C. PCR product was sent to Genewiz (genewiz.com) for Sanger sequencing of the amplified 16S rDNA gene. Sequences were identified by comparison to bacterial type strains.

Stall bedding samples were further composited to six samples, each composited sample was a combination of two to three stall samples. Water activity was measured with a Rotronic HygroPalm water activity meter with HC2-AW Probe, Model #HP23-AW-A-Set (Rotronic, Hauppauge, New York) according to manufacturer's instructions.

Bulk tank SCC data was received from the milk processing facility. DairyCOMP 305 data was extracted prior to the start of the trial and after the 10-month trial period to determine monthly mastitis events. An event gap of 14 days was set prior to analyzing the mastitis event data in DairyCOMP 305 to avoid counting the same mastitis event twice. To avoid confounding effects of seasonality on SCC and mastitis events, data were compared to those from the same time period in the previous year using an unpaired t-test to determine statistical differences between the pretreatment and treatment periods. The data was compared using results from the trial period from 2020 to 2021 (Aug. 25, 2020, to Jun. 30, 2021) to the data from the year before Aug. 25, 2019, to Jun. 30, 2020. The dairy was monitored to ensure no major culling events occurred, hospital pen milk was not introduced to the bulk tank and there were no major protocol changes that occurred compared to the year prior that would impact the SCC or mastitis event data.

### Results and Discussion

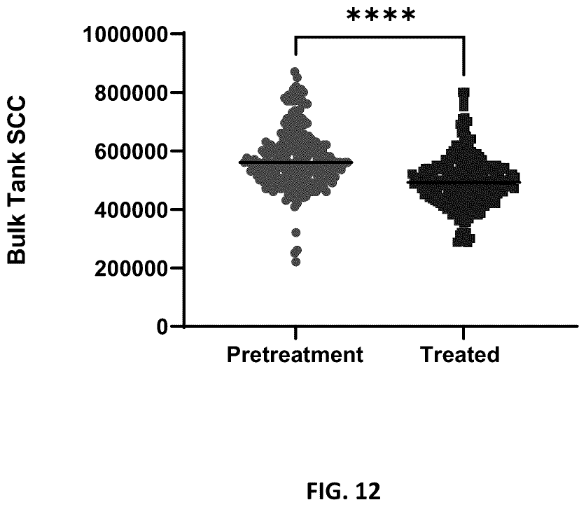

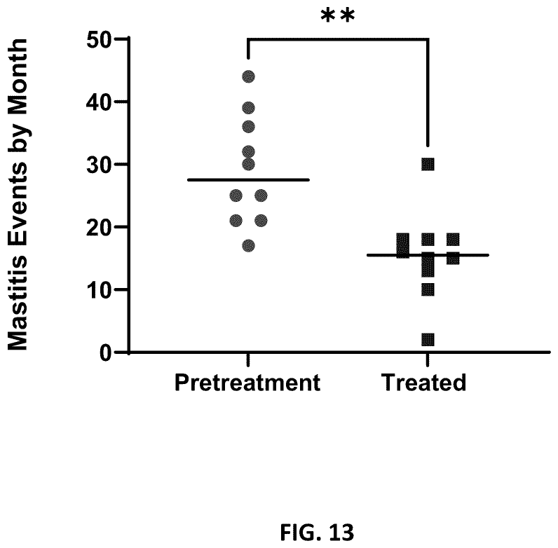

The bulk tank SCC counts significantly decreased (P<0.01) comparing the pretreatment average, 574,000, to the trial period average, 497,000 (FIG. 12). The monthly mastitis events also significantly decreased (P<0.01) comparing the pretreatment period, 29 average events per month, to the treatment period, 16 average events per month (FIG. 13).

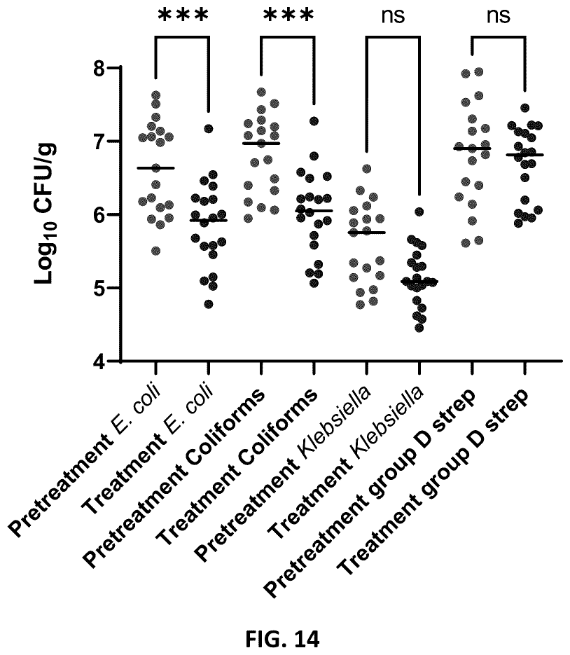

The stall bedding samples collected during the treatment period had significantly lower levels of E. coli (P<0.01) and coliforms (P<0.01) compared to the pretreatment bedding samples (FIG. 14). The presumptive Klebsiella (P=0.20) and group D streptococci (P>0.99) levels were not significantly impacted. One of the twenty pretreatment composite stall samples was compromised during transport and was discarded from the analysis.

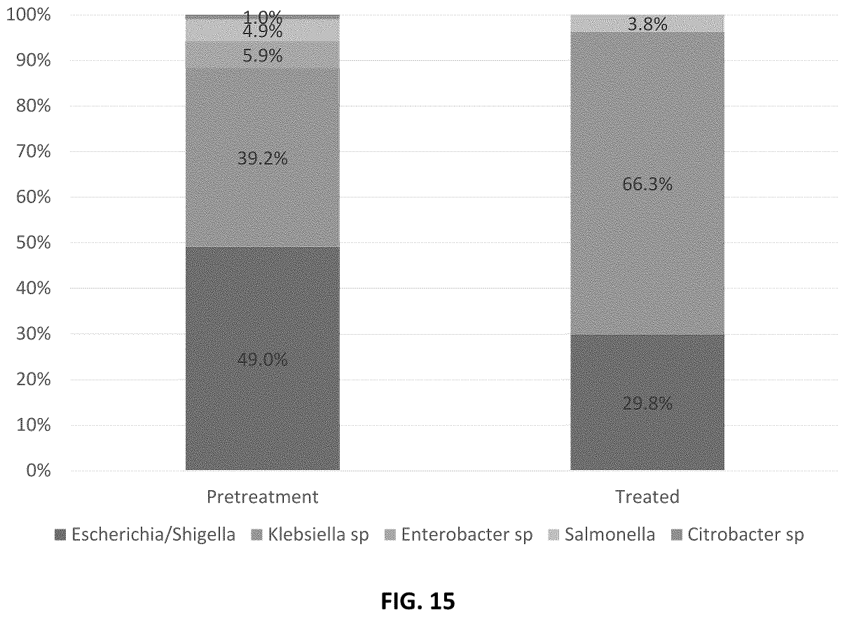

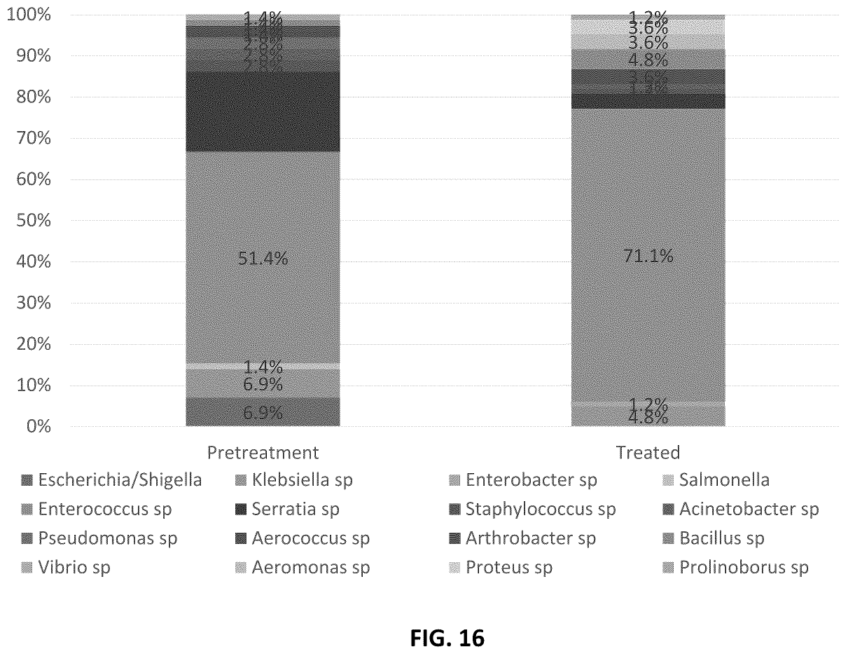

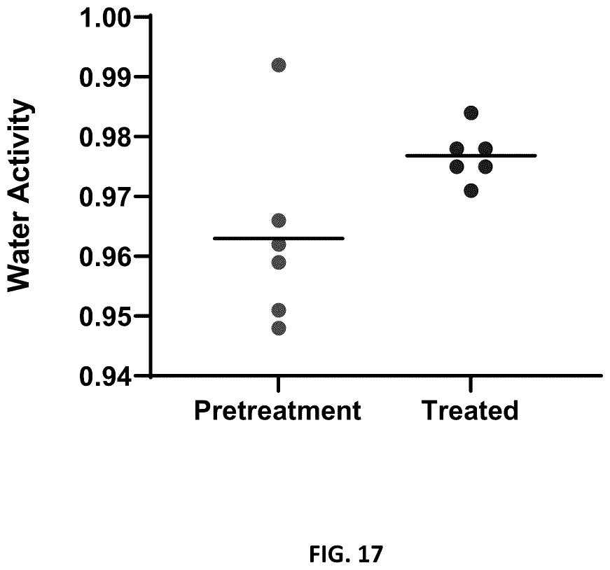

Sanger sequencing of the amplified 16S rDNA gene of isolates harvested from the MacConkey-Inositol-Carbenicillin Agar (presumptive Klebsiella) indicated differences in the dominant genus identified comparing the pretreatment and treated samples. The pretreatment isolates were mainly identified as Escherichia/Shigella (49.0%) followed by Klebsiella (39.2%) which shifted in the treated sample isolates, the most dominant genus was Klebsiella (66.3%) followed by Escherichia/Shigella (29.8%) (FIG. 15). Escherichia and Shigella could be distinguished by their sequencing results due to the high degree of similarities between 16S rDNA sanger sequences. Other notable changes identified from representative isolates harvested from MCIC agar were Enterobacter (5.9%; 0.0%); Salmonella (4.9%; 3.8%) and Citrobacter (1.0%; 0.0%) comparing the pretreatment to treated samples, respectively. Isolates from the Bile Esculin Agar (group D streptococci) had the same dominant genus for both the pretreatment and treated samples (Enterococcus, 51.4% and 71.1% respectively). Other notable changes identified from representative isolates harvested due to treatment were Serratia (19.4%; 3.6%); Escherichia/Shigella (6.9%; 0.0%); Klebsiella (6.9%; 4.8%); Enterobacter (0.0%; 1.2%); Salmonella (1.4%; 0.0%); Staphylococcus (2.8%; 1.2%) and Pseudomonas (2.8%; 0.0%), comparing the pretreatment to treated sample isolates respectively (FIG. 16). The average water activity for the pretreatment samples was 0.96 compared to the average water activity for the treated samples which was 0.98 (FIG. 17).

The shift in bacterial levels and types of bacteria was accompanied with a decrease of SCC and monthly mastitis events (by 77,000 SCC and 13 monthly mastitis events) during the treatment period. A significant reduction was observed in the levels of E. coli and total coliforms in the bedding material during the treatment period. Presumptive Klebsiella were not significantly different comparing the sampling time points, however the average and median levels of presumptive Klebsiella were lower during the treatment period. The group D streptococci were not significantly different, however there was a population shift in the representative isolates harvested. The shift indicated a lower percentage of several genera that previous work reported to be associated with environmental mastitis: Serratia, Escherichia/Shigella, Klebsiella, Salmonella, Staphylococcus, and Pseudomonas. The water activity, or measure of available water to support bacterial growth, had a higher average in the treated samples, indicating that the available water in the bedding was not a factor in reducing the bacterial levels observed in the treated samples. Although a significant decrease was not observed for all target mastitis-causing organism levels, the decrease in SCC and monthly mastitis events suggests that the populations that were inhibited impacted the mastitis metrics measured in this study. In conclusion, the blend of Bacillus strains, in accordance with this embodiment of the present invention, significantly reduced E. coli, total coliforms, SCC and mastitis events during the treatment period.

### Example 5: The Effect of a Combination of Bacillus Strains Applied to Recycled Manure Solid Bedding on Mastitis-causing Organisms, Somatic Cell Count and Mastitis Events at Farm C in Minnesota

This Example evaluates pathogen inhibition in bedding material and the subsequent impact on SCC and mastitis events on Farm C in Minnesota with the Bacillus strains provided herein (e.g., described in Example 2) in accordance with this embodiment of the present invention (referred to herein as “treated”), over 6 months.

### Materials and Methods

A dairy herd in Minnesota, Farm C, was selected to study the impact of the Bacillus product, in accordance with this embodiment of the present invention, on pathogen inhibition in bedding material and the subsequent impact on SCC and mastitis events. The herd consisted of 250 milk cows housed in a free stall, deep bedded barn, bedded with recycled manure solids.

The product, in accordance with this embodiment of the present invention was two Bacillus strains in equal proportions: Bacillus subtilis strain 839 and Bacillus subtilis strain 4976, sprayed as liquid application onto the bedding after the screw press at an application of 7.5×10⁵ CFU per gram of bedding material.

Bedding samples were obtained approximately one week prior to product application. Two composite unused pile samples were collected, each composite sample consisted of five handfuls from different locations in the pile. Stall samples were also collected from the two lactating cow pens. Stall samples were defined as used bedding which had been laid on and had been in the pen for approximately twenty-four hours. A handful of bedding was collected from the top one to two inches from the surface, at the location that the udder is typically located. Approximately every tenth stall in a pen was sampled, these samples were collected as composite samples from six different stalls. Two composite samples were collected from each pen. The same sample collection protocol was used after 133 days of applying the Bacillus to the bedding.

Samples were placed on ice and analyzed within twenty-four hours of collection. Samples were mixed thoroughly, then 18 to 22 grams of the bedding material was diluted 1:10 with sterile peptone. Samples were masticated for one minute and target mastitis-causing bacteria were enumerated via streak plate method using: CHROMagar™ ECC (CHROMagar, EF322, Springfield, NJ) for the detection of E. coli and total coliforms, MacConkeys-Inositol-Carbenicillin Agar (MCIC) (Bagley and Seidler, 1978) for the detection of presumptive Klebsiella, and Bile Esculin Agar (BEA, Neogen, NCM0117A, Lansing, MI) for the detection of group D streptococci. Agar plates were incubated at 35° C. (MCIC) or 37° C. (CHROMagar™ ECC and BEA) aerobically for 24 hours. The log transformed levels of bacteria were compared by sample timepoint for each sample location (pile or stall) using an ordinary one-way ANOVA analysis to determine statistical differences.

Three of the four composite stall bedding samples were further analyzed for water activity. Water activity was measured with a Rotronic HygroPalm water activity meter with HC2-AW Probe, Model #HP23-AW-A-Set (Rotronic, Hauppauge, New York) according to manufacturer's instructions.

Bulk tank SCC data was received from the milk processing facility. DairyCOMP 305 data was extracted prior to the start of the trial and after the 6-month trial period to determine monthly mastitis events. An event gap of 14 days was set prior to analyzing the mastitis event data in DairyCOMP 305 to avoid counting the same mastitis event twice. To avoid confounding effects of seasonality on SCC and mastitis events, data were compared to those from the same time period in the previous year using an unpaired t-test to determine statistical differences between the pretreatment and treatment periods. The data was compared using results from the trial period from 2020 to 2021 (Dec. 1, 2021, to May 31, 2022) to the data from the year before Dec. 1, 2020, to May 31, 2021. The dairy was monitored to ensure no major culling events occurred, hospital pen milk was not introduced to the bulk tank and there were no major protocol changes that occurred compared to the year prior that would impact the SCC or mastitis event data.

### Results and Discussion

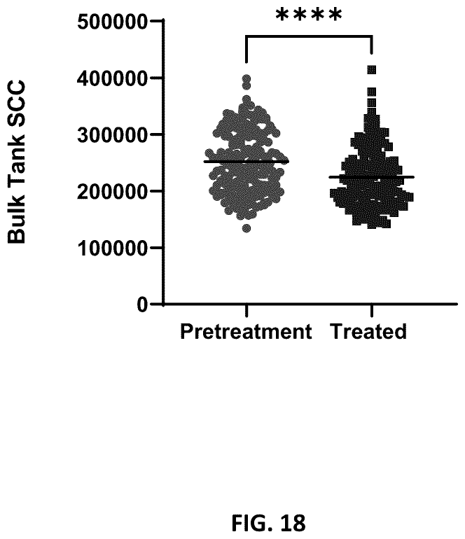

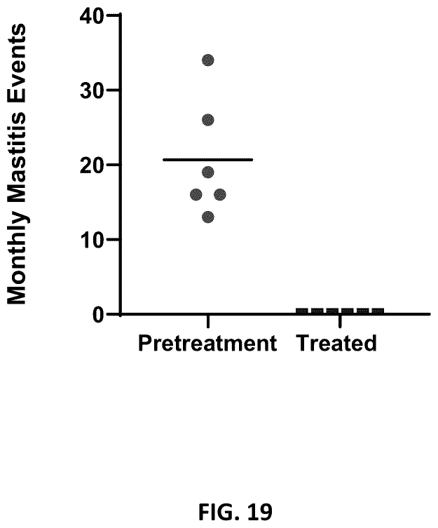

The bulk tank SCC counts significantly decreased (P<0.01) comparing the pretreatment average, 252,000, to the trial period average, 225,000 (FIG. 18). The monthly mastitis events significantly decreased (P<0.01) comparing the pretreatment period, which had an average of 21 mastitis events per month, to the treatment period, which had an average of zero mastitis events per month (FIG. 19).

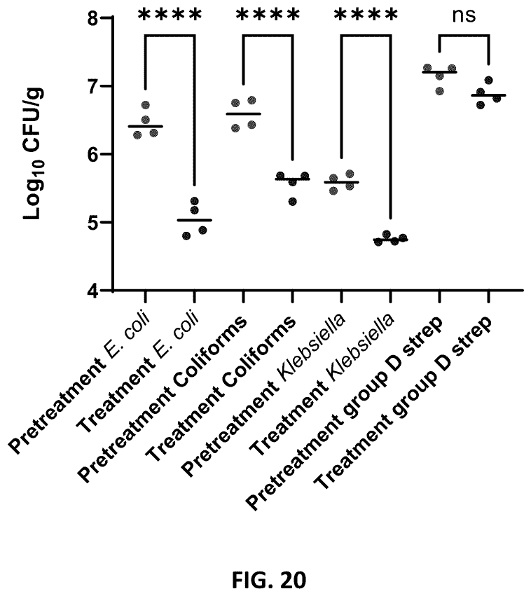

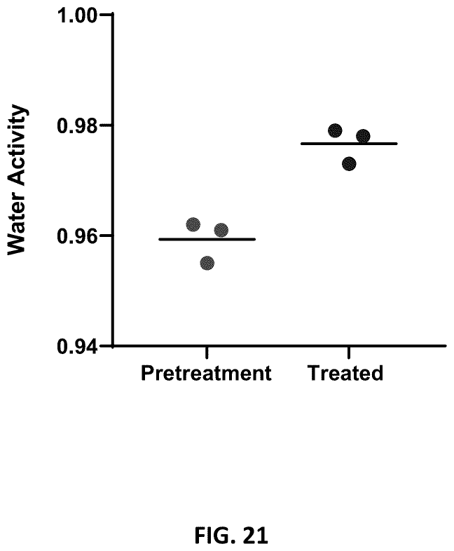

The stall bedding samples collected during the treatment period had significantly lower levels of E. coli (P<0.01), coliforms (P<0.01) and presumptive Klebsiella (P<0.01) compared to the pretreatment bedding samples (FIG. 20). The group D streptococci levels were not significantly impacted (P=0.41) (FIG. 20). The fresh pile samples had average E. coli levels of 8.4×10⁵ CFU/g and 6.4×10⁴ CFU/g, presumptive Klebsiella levels of 5.1×10⁴ CFU/g and 1.0×10⁵ CFU/g, coliforms levels of 1.1×10⁶ CFU/g and 2.1×10⁵ CFU/g and group D streptococci levels of 3.0×10⁶ CFU/g and 5.8×10⁵ CFU/g in the pretreatment and treated samples, respectively. The average water activity for the pretreatment samples was 0.96 which was lower (p<0.05) compared to the average water activity for the treated samples which was 0.98 (FIG. 21).

A significant reduction was observed in the levels of E. coli, total coliforms and presumptive Klebsiella in the bedding material during the treatment period. Group D streptococci were not significantly different comparing the sampling time points, however the average and median levels were lower during the treatment period. The water activity, or measure of available water to support bacterial growth, had a higher average measurement in the treated samples, indicating that the available water in the bedding was not a factor in reducing the bacterial levels observed in the treated samples. The shift in bacterial levels was accompanied with a decrease of SCC by 27,000 and a decrease of monthly mastitis events from 21 to zero during the treatment period. In conclusion, the blend of Bacillus strains, in accordance with this embodiment of the present invention, significantly reduced E. coli, total coliforms, presumptive Klebsiella, SCC and mastitis events during the treatment period.

### Example 6: The Effect of a Combination of Bacillus Strains Applied to Recycled Manure Solid Bedding on Mastitis-causing Organisms, Somatic Cell Count and Mastitis Events at Farm D in Minnesota

This Example evaluates pathogen inhibition in bedding material and the subsequent impact on SCC and mastitis events on Farm D in Minnesota with the Bacillus strains provided herein (e.g., described in Example 2) in accordance with this embodiment of the present invention (referred to herein as “treated”), over four months.

### Materials and Methods

A dairy herd in Minnesota, Farm D, was selected to study the impact of the Bacillus product, in accordance with this embodiment of the present invention, on pathogen inhibition in bedding material and the subsequent impact on SCC and mastitis events. The herd consisted of 580 milk cows housed in a free stall, deep bedded barn, bedded with recycled manure solids.

The product, in accordance with this embodiment of the present invention was two Bacillus strains in equal proportions: Bacillus subtilis strain 839 and Bacillus subtilis strain 4976, sprayed as liquid application onto the bedding after the screw press at an application of 7.5×10⁵ CFU per gram of bedding material.

Bedding samples were obtained approximately five months week prior to product application. Two composite unused pile samples were collected, each composite sample consisted of five handfuls from different locations in the pile. Stall samples were also collected from the eight cow pens. Stall samples were defined as used bedding which had been laid on and had been in the pen for approximately twenty-four hours. A handful of bedding was collected from the top one to two inches from the surface, at the location that the udder is typically located. Approximately every seventh stall in a pen was sampled, these samples were collected as composite samples from five different stalls. Two composite samples were collected from each pen. The same sample collection protocol was used after 152 days of applying the Bacillus to the bedding.

Samples were placed on ice and analyzed within twenty-four hours of collection. Samples were mixed thoroughly, then 18 to 22 grams of the bedding material was diluted 1:10 with sterile peptone. Samples were masticated for one minute and target mastitis-causing bacteria were enumerated via streak plate method using: CHROMagar™ ECC (CHROMagar, EF322, Springfield, NJ) for the detection of E. coli and total coliforms, MacConkeys-Inositol-Carbenicillin Agar (MCIC) (Bagley and Seidler, 1978) for the detection of presumptive Klebsiella, and Bile Esculin Agar (BEA, Neogen, NCM0117A, Lansing, MI) for the detection of group D streptococci. Agar plates were incubated at 35° C. (MCIC) or 37° C. (CHROMagar™ ECC and BEA) aerobically for 24 hours. The log transformed levels of bacteria were compared by sample timepoint for each sample location (pile or stall) using an ordinary one-way ANOVA analysis to determine statistical differences.

Five composite stall bedding samples were further analyzed for water activity. Water activity was measured with a Rotronic HygroPalm water activity meter with HC2-AW Probe, Model #HP23-AW-A-Set (Rotronic, Hauppauge, New York) according to manufacturer's instructions.

Bulk tank SCC data was received from the milk processing facility. DairyCOMP 305 data was extracted prior to the start of the trial and after the 4-month trial period to determine monthly mastitis events. An event gap of 14 days was set prior to analyzing the mastitis event data in DairyCOMP 305 to avoid counting the same mastitis event twice. To avoid confounding effects of seasonality on SCC and mastitis events, data were compared to those from the same time period in the previous year using an unpaired t-test to determine statistical differences between the pretreatment and treatment periods. The data was compared using results from the trial period from 2022 (Mar. 2, 2022, to Jul. 27, 2022) to the data from the year before Mar. 2, 2021, to Jul. 27, 2021. The dairy was monitored to ensure no major culling events occurred, hospital pen milk was not introduced to the bulk tank and there were no major protocol changes that occurred compared to the year prior that would impact the SCC or mastitis event data.

### Results and Discussion

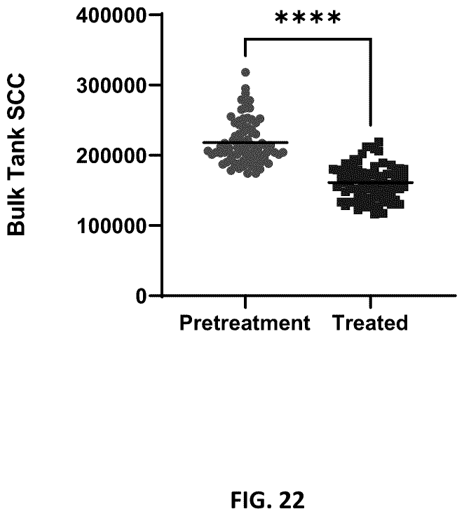

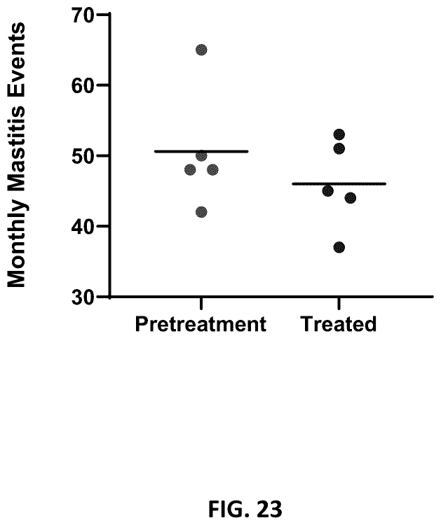

The bulk tank SCC counts significantly decreased (p<0.01) comparing the pretreatment average, 218,000, to the trial period average, 161,000 (FIG. 22). The monthly mastitis events were not significantly impacted (p=0.36) comparing the pretreatment period, which had an average of 51 mastitis events per month, to the trial period, which had an average of 46 mastitis events per month (FIG. 23).

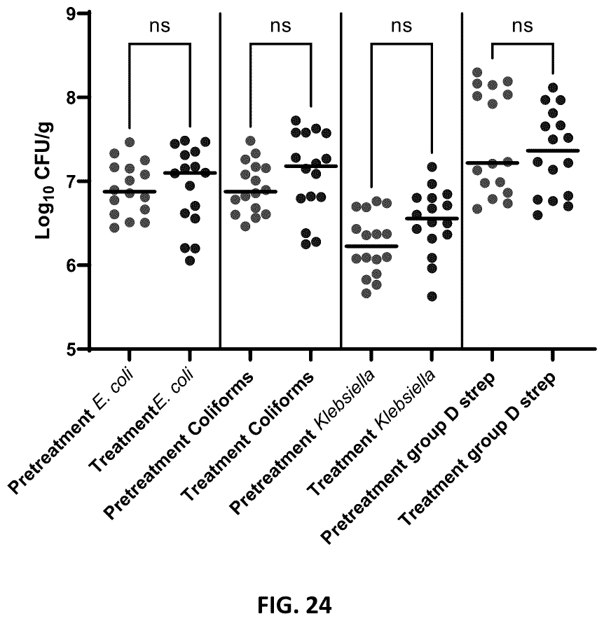

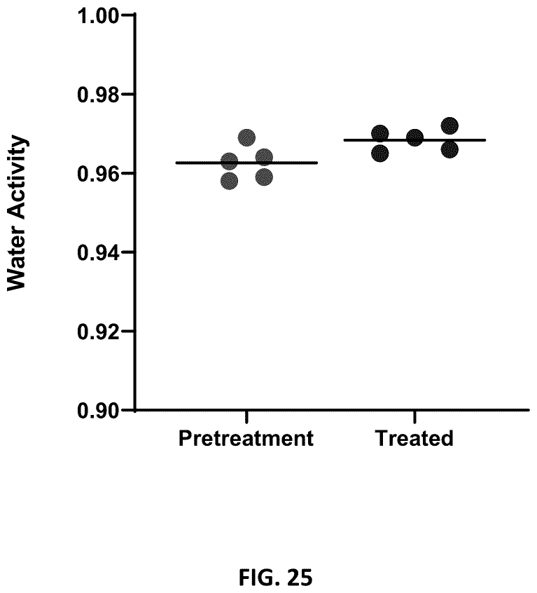

The stall bedding samples collected during the treatment period did not have significantly different levels of target bacteria compared to the pretreatment samples (FIG. 24). The average water activity for the pretreatment samples was significantly higher compared to the treatment period (p=0.04) (FIG. 25).

No significant reductions were observed in the levels of any target mastitis-causing pathogens. The water activity, or measure of available water to support bacterial growth, had a higher average measurement in the treated samples, indicating that this could be a more favorable environment for bacterial outgrowth. SCCs decreased by 57,000 and monthly mastitis events were not significantly impacted during the treatment period. The pretreatment samples were collected in the colder months and the treated samples collected in the hot and humid months. This could account for the lack of bacteria level response to the treatment. However the better indicator, which includes many more data points and is compared to the same seasonal period from the year before, SCCs, were significantly impacted. In conclusion, the blend of Bacillus strains, in accordance with this embodiment of the present invention, significantly reduced SCC during the treatment period.

### Example 7: The Effect of a Combination of Bacillus Strains Applied to Recycled Manure Solid Bedding on Mastitis-causing Organisms, Somatic Cell Count, and Mastitis Events at Farm E in Wisconsin

This Example evaluates pathogen inhibition in bedding material and the subsequent impact on SCC and mastitis events on Farm E in Wisconsin with the Bacillus strains provided herein (e.g., described in Example 2) in accordance with this embodiment of the present invention (referred to herein as “treated”), over 8 months.

### Materials and Methods

A dairy herd in Wisconsin, Farm E, was selected to study the impact of the Bacillus product, in accordance with this embodiment of the present invention, on pathogen inhibition in bedding material and the subsequent impact on SCC and mastitis events. The herd consisted of 400 milk cows housed in a free stall, deep bedded barn, bedded with seven day composted recycled manure solids.

The product, in accordance with this embodiment of the present invention was two Bacillus strains in equal proportions: Bacillus subtilis strain 839 and Bacillus subtilis strain 4976, sprayed as liquid application onto the bedding after the screw press at an application of 7.5×10⁵ CFU per gram of bedding material.

Bedding samples were obtained approximately one day prior to product application. One composite pre-composted sample and one seven-day composted pile sample were collected, each composite sample consisted of five handfuls from different locations in the pile. Stall samples were also collected from the three lactating cow pens. Stall samples were defined as used bedding which had been laid on and had been in the pen for approximately twenty-four hours. A handful of bedding was collected from the top one to two inches from the surface, at the location that the udder is typically located. Approximately every tenth stall in a pen was sampled, these samples were collected as composite samples from five different stalls. Two or three composite samples were collected from each pen depending on pen size. The same sample collection protocol was used after approximately 168 days of applying the Bacillus to the bedding.

Samples were placed on ice and analyzed within twenty-four hours of collection. Samples were mixed thoroughly, then 18 to 22 grams of the bedding material was diluted 1:10 with sterile peptone. Samples were masticated for one minute and target mastitis-causing bacteria were enumerated via streak plate method using: CHROMagar™ ECC (CHROMagar, EF322, Springfield, NJ) for the detection of E. coli and total coliforms, MacConkeys-Inositol-Carbenicillin Agar (MCIC) (Bagley and Seidler, 1978) for the detection of presumptive Klebsiella, and Bile Esculin Agar (BEA, Neogen, NCM0117A, Lansing, MI) for the detection of group D streptococci. Agar plates were incubated at 35° C. (MCIC) or 37° C. (CHROMagar™ ECC and BEA) aerobically for 24 hours. The log transformed levels of bacteria were compared by sample timepoint for each sample location (pile or stall) using an ordinary one-way ANOVA analysis to determine statistical differences. If present, up to five isolated colonies were harvested from each media type for each sample into Tryptic Soy Broth (TSB) (BD Bacto™, BD211825, Sparks, MD) and incubated aerobically for 24 hours at 37° C. The isolates were stored at −80° C. for later use. The DNA was extracted from pelleted cells of isolates harvested from the MCIC and BEA media types. The CHROMagar isolates were differentiated based on color change on the petri plates as E. coli or total coliforms, for this reason they were not characterized with molecular techniques. Bacterial cells were lysed by incubation for 1 h at 37° C. in 200 μL lysozyme solution (10 mg/mL lysozyme in T50E10) before DNA purification with the Maxwell HT Viral TNA Kit (AX2340, Promega, Madison, WI) according to the manufacturer's methods. To identify bacterial isolates the 16S rDNA gene was amplified via PCR (Barribeau et al., 2014). PCR reactions included 2.5 μl 10× Buffer, 2 mM MgCl₂, 0.2 μl dNTPs, 0.4 μM of each primer, 0.1 μl Platinum® Taq DNA Polymerase (Invitrogen, 10966-018), 2.5 μl template DNA, 16.4 μl ddH₂O for a final volume of 25 μl. The PCR conditions were: 4 minutes at 95° C., followed by 35 cycles of 95° C. for 30 seconds, 50° C. for 30 seconds, 72° C. for 2 minutes finishing with a final elongation of 7 minutes at 72° C. PCR product was sent to Genewiz (genewiz.com) for Sanger sequencing of the amplified 16S rDNA gene. Sequences were identified by comparison to bacterial type strains.

Stall bedding samples were further composited to four samples for each sampling point. Water activity was measured with a Rotronic HygroPalm water activity meter with HC2-AW Probe, Model #HP23-AW-A-Set (Rotronic, Hauppauge, New York) according to manufacturer's instructions.

Bulk tank, monthly average, SCC data was received from the milk processing facility. DairyCOMP 305 data was extracted prior to the start of the trial and after the 8-month trial period to determine monthly mastitis events. An event gap of 14 days was set prior to analyzing the mastitis event data in DairyCOMP 305 to avoid counting the same mastitis event twice. To avoid confounding effects of seasonality on SCC and mastitis events, data were compared to those from the same time period in the previous year using an unpaired t-test to determine statistical differences between the pretreatment and treatment periods. The data was compared using results from the trial period in 2021/2022 (November 2021 to June 2022) to the data from the year before Novermber 2020 to June 2021. The dairy was monitored to ensure no major culling events occurred, hospital pen milk was not introduced to the bulk tank and there were no major protocol changes that occurred compared to the year prior that would impact the SCC or mastitis event data.

### Results and Discussion

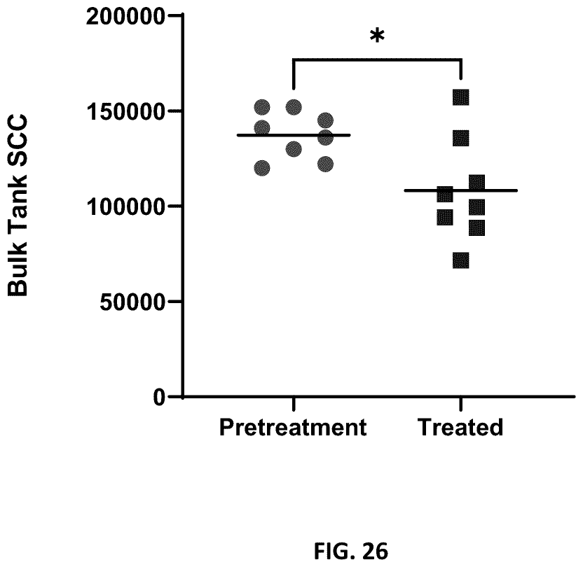

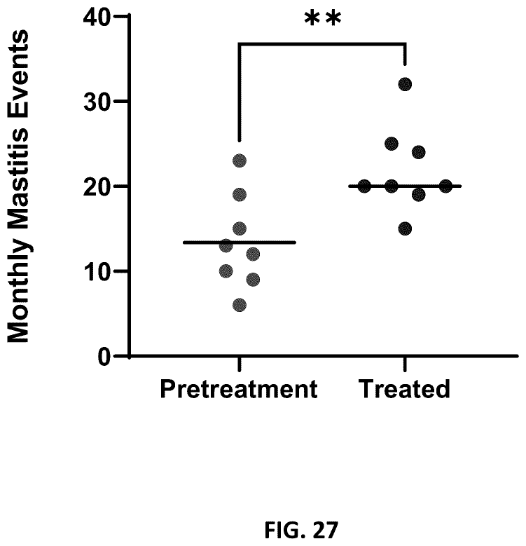

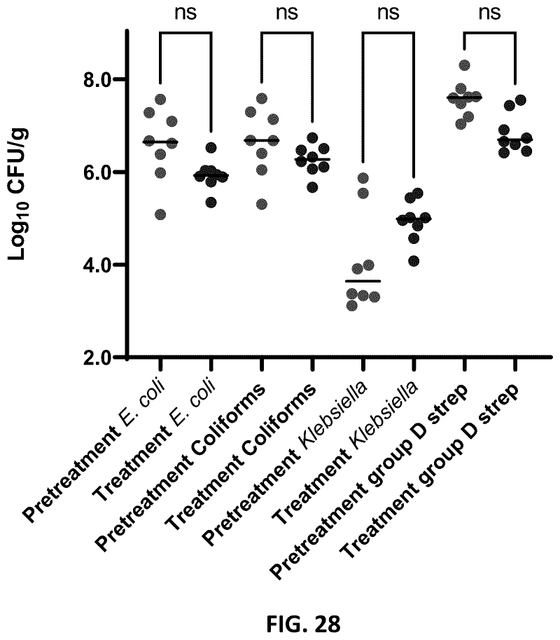

The bulk tank SCC counts significantly decreased (p=0.02) comparing the pretreatment, average SCC of 137,000, to the trial period, average SCC of 108,000 (FIG. 26). The monthly mastitis events significantly increased (p<0.01) comparing the pretreatment period, 13 average mastitis events per month, to the trial period, 22 average mastitis events per month (FIG. 27). The stall bedding samples collected during the treatment period were not significantly different compared to the pretreatment samples for any target bacteria (FIG. 28). Average levels of target bacteria were E. coli, 1.0×10⁷ CFU/g and 1.1×10⁶ CFU/g (p=0.42); total coliforms, 1.1×10⁷ CFU/g and 2.3×10⁶ CFU/g (p=0.92); presumptive Klebsiella, 1.4×10⁵ and 1.3×10⁵ (p=0.11); and group D streptococci 5.5×10⁷ and 1.1×10⁷ (p=0.27) for the pretreatment and treated samples, respectively. The pre-composting samples had E. coli levels of 4.7×10⁵ CFU/g and 3.9×10⁴ CFU/g, coliform levels of 6.4×10⁵ CFU/g and 6.5×10⁵ CFU/g, presumptive Klebsiella levels of 1.0×10⁵ CFU/g and 4.2×10⁴ CFU/g, and group D streptococci levels of 5.5×10⁵ CFU/g and 3.2×10⁶ CFU/g in the pretreatment and treated samples, respectively. The 7-day composted samples had E. coli levels of <1×10² CFU/g and 2.5×10³ CFU/g, coliforms levels of <1×10² CFU/g and 2.9×10³ CFU/g, presumptive Klebsiella levels of 2.6×10³ CFU/g and <1.0×10² CFU/g, and group D streptococci levels of 1.5×10⁴ CFU/g and 1.0×10⁴ CFU/g in the pretreatment and treated samples, respectively.

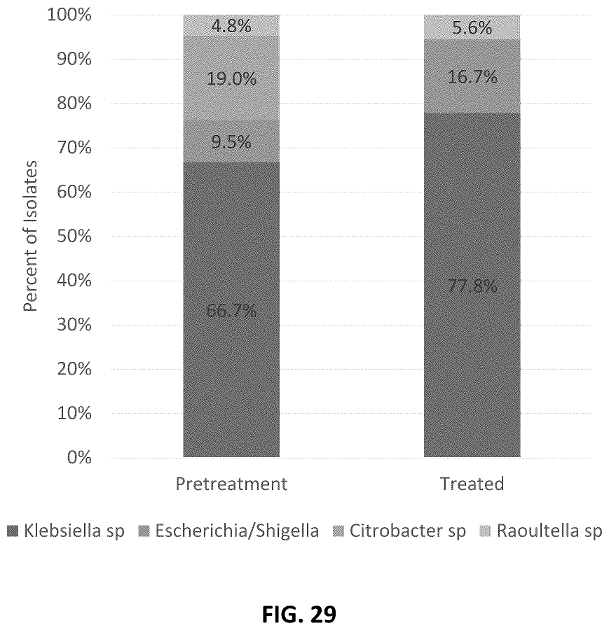

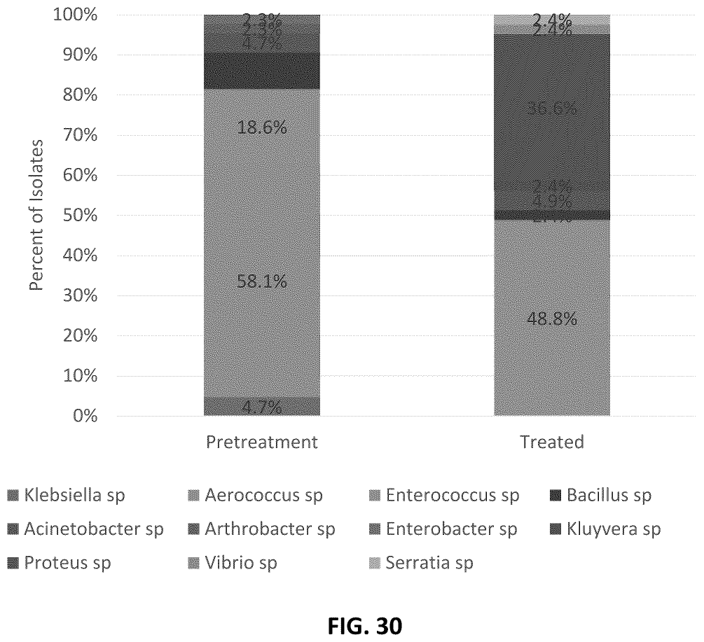

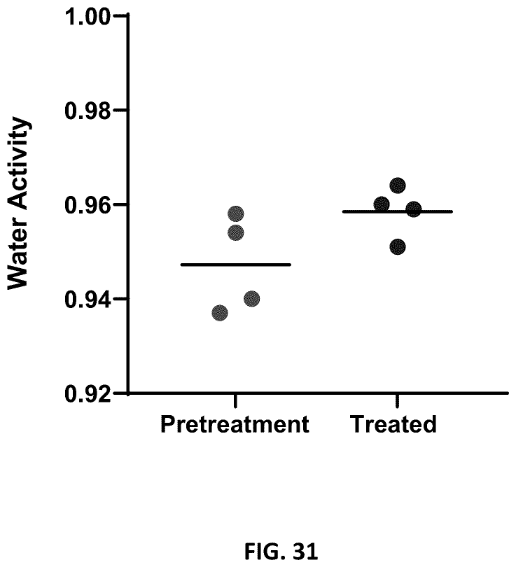

Sanger sequencing of the amplified 16S rDNA gene of isolates harvested from the MacConkey-Inositol-Carbenicillin Agar (presumptive Klebsiella) indicated the same dominant genus identified in the pretreatment and treated samples. The pretreatment and treated sampling points had Klebsiella identified as the dominate species, 66.7% and 77.8%, respectively (FIG. 29). The next most frequently observed species in the pretreatment samples was Citrobacter (19.0%) which was not observed in the treated samples (0.0%). Isolates from the Bile Esculin Agar (group D streptococci) indicated differences in the most frequently observed genera (FIG. 30). The most frequently observed genera in the pretreatment samples were Aerococcus (58.1%) and Enterococcus (18.6%). The treated samples did not have any detectable Aerococcus, instead Enterococcus (48.8%), and Proteus (36.6%) were the most abundant. Other notable changes identified from representative isolates harvested from BEA agar were Klebsiella (4.7%; 0.0%); Enterobacter (2.3%; 0.0%); and Serratia (0.0%; 2.4%), comparing the pretreatment to treated sample isolates, respectively. The average water activity for the pretreatment samples was 0.95 compared to the average water activity for the treated samples which was 0.96 (FIG. 30).

The stall bedding samples collected during the treatment period were not significantly different compared to the pretreatment for any target bacteria (FIG. 28). However, the average level of each target bacteria was lower during the treatment period. The group D streptococci were not significantly different, however there was a population shift in the representative isolates harvested. The water activity, or measure of available water to support bacterial growth, had a higher average in the treated samples, which could have impacted the target bacterial counts. Although there was not a significant reduction in target bacterial levels, SCC decreased by 29,000 during the treatment period. However, there was an increase in the number of monthly mastitis events with 9 more monthly mastitis events per month during the treatment period. The decrease in SCC indicates a reduction in environmental mastitis, however this was accompanied by an increase in clinical mastitis cases. One hypothesis is that the clinical mastitis cases could be increasing due to a contiguous mastitis causing organism, which is spreading from cow to cow and the bacteria is not being introduced through the environment. This could explain why SCCs are decreasing and the mastitis events are increasing. Although significant decreases were not observed for target mastitis-causing organism levels, the decrease in SCC suggests that the product could be inhibiting bacterial populations not captured during the enumeration of the treated samples. In conclusion, the blend of Bacillus strains, in accordance with this embodiment of the present invention, significantly reduced SCC during the treatment period.

### Example 8: Genetic Differences of Bacillus Strains

To compete with other microbes in their natural environment, many bacteria produce compounds that can inhibit other bacteria. These secondary metabolites often increase membrane permeability by forming pores in membranes of target cells or inhibit cell wall synthesis thereby preventing growth of susceptible microbes. Bacillus species produce multiple compounds with inhibitory activity against other microbes with many strains containing more than ten operons producing antifungal and antibacterial compounds. These compounds may have other functions within the cell. For example, surfactin is involved in intercellular signaling and biofilm formation (Zeriouh et al., 2014 Environ. Microbiol. 16, 2196-2211) and bacillibactin, is an iron-scavenger for Bacillus species, which then deprives other organisms of essential iron and inhibits their growth (Li et al., 2014 Front. Microbiol. 5.).

The predominant secondary metabolites produced by bacilli are a variety of functionally and structurally diverse peptides. They are often hydrophobic and cyclic with unusual amino acids and resistant to peptidases and proteases. They may be synthesized ribosomally or nonribosomally by multi-enzyme complexes, often followed by post-translational modifications. A major group of ribosomally synthesized antimicrobial peptides are the lantibiotics, which contain the non-protein amino acid lanthionine, formed post-translationally. Type A lantibiotics have a linear secondary structure while Type B are more globular. Bacillus strains often produce nonribosomally synthesized lipopeptides, fatty acids attached to small cyclic peptides. These nonribosomally synthesized peptides are structurally diverse (Luo et al., 2015a Appl. Environ. Microbiol. 81, 422-431), as they are assembled from a heterogeneous group of precursors, but their synthesis by a multicarrier thiotemplate mechanism is conserved (Luo et al., 2015b Appl. Environ. Microbiol. 81, 6601-6609). Nonribosomal peptide synthetases (NRPS) require posttranslational modification to be functionally active.

Other non-peptide antimicrobials are also produced by bacilli such as polyketides and siderophores. Polyketides are secondary metabolites which are also synthesized on multienzymes similar to NRPS, and they also undergo posttranslational modification. Hybrid synthetases containing peptide, fatty acid, and polyketide synthetase domains are also being identified in bacilli and some of these compounds were shown to have functional antimicrobial activity.

Most of the information available on the secondary compounds produced by bacilli and their antimicrobial activity (Chowdhury et al., 2015 Front. Microbiol. 6.; Koumoutsi et al., 2004 J. Bacteriol. 186, 1084-1096) is based on studies on plant-growth promoting rhizobacteria (PGPR) that are applied as spore formulations to improve crop production by promoting growth and inhibiting plant pathogens (Wu et al., 2015 Front. Microbiol. 6). A better understanding of how an organism lives and competes in its environment can be obtained by sequencing their full genome. Since 1995, when the first complete genome sequence of the bacteria Haemophilus influenzae Rd KW20 was published (Fleischmann et al., 1995 Rd. Science 269, 496), sequencing of genomes has increased exponentially and powerful databases and bioinformatics programs have been developed in order to predict the functions of newly sequenced organisms. Gene function is predicted based on the genetic organization of surrounding genes, conserved protein domains within genes and alignment with genes of established function. Predicted gene functions should then be confirmed by further molecular and biochemical experiments. A number of genome sequences of PGPR are available (Chen et al., 2007 Nat. Biotechnol. 25, 1007-1014; Jeong et al., 2015 Genome Announc. 3) and the core genome and conserved antimicrobial loci have been identified (Fan et al., 2015 PLoS ONE 10). Comparative analysis of the genomes of the strains to genomes available in the databases allows for prediction of the types of antimicrobial compounds produced by the strains and determine differences between strains.

### Materials and Methods

High molecular weight genomic DNA was extracted for genome sequencing from 1 ml of overnight cultures using phenol:chloroform:isoamyl alcohol with an ethanol precipitation. Complete genomes were obtained for all the strains used in the selection process using a combination of short-read and long read sequences as follows. Short read shotgun genomic libraries were prepared with Library Construction Kit (Kapa Biosystems, Wilmington, MA). Each library was quantified by qPCR and sequenced either on one MiSeq flowcell for 261 cycles using a MiSeq 600-cycle sequencing kit v2 or for 251 cycles from each end on a HiSeq 2500 (Illumina, San Diego, CA) using a HiSeq Rapid SBS sequencing kit version 2. Fastq files were generated and demultiplexed with the bcl2fastq v2.17.1.14 Conversion Software (Illumina). Long read genomic libraries were prepared using a Ligation Sequencing Kit 1D (Oxford Nanopore, Oxford, UK). The libraries were run on a MinION R9.4 flowcell (Oxford Nanopore). Fast5 files were basecalled to fastq and demultiplexed using Albacore v2.1.10 (Oxford Nanopore). Short read and long read fastq files were assembled de novo with Unicycler using conservative settings (Wick et al., 2017 PLOS Comput. Biol. 13, e1005595). Genomes were annotated in PATRIC using RASTtk (Brettin et al., 2015 Sci. Rep. 5, 8365).

Pairwise average nucleotide identities were determined using OrthoANI to determine nearest genetic neighbors. This method calculates the identity values for orthologous fragment pairs between two genomes. Secondary metabolite biosynthesis gene clusters were identified in antiSMASH (Blin et al. 2021 Nucleic Acids Res. 49, W29-W35; Blin et al. Nucleic Acids Res. 41, W204-W212).

### Results and Discussion

The genomes of the eight Bacillus strains tested for effectiveness against potential environmental mastitis-causing organisms were between 3.93 and 4.45 Mb in size with 3935 to 4700 predicted genes (Table 2). Analysis of all the genomes indicated that gene clusters, ranging from 12 to 14, for several antimicrobial secondary metabolites were present in all strains. The nonribosomally synthesized metabolite gene clusters are indicated in Table 3 and the ribosomally synthesized metabolite gene clusters are indicated in Table 4.

Of the eight strains tested, the two that were most effective at inhibiting the growth of putative environmental mastitis-causing organisms were 839 and 4976. Their closest neighbors by orthologous region identity are 1704 and 747, respectively (Table 5).
The closest genetic neighbor to 839 is 1704 with an OrthoANI of 99.3693 across orthologous regions. Pairwise identity across the entire genome is 91.8% with 1704 having 120 more genes than 839. The main differences in secondary metabolites across these two strains are the absence of an NRPS gene cluster related to locillomycin in 839 and the absence of a plantazolicin gene cluster in 1704 (Table 6).

The closest genetic neighbor to 4976 is 747 with an OrthoANI of 99.9903 across orthologous regions. Pairwise identity across the entire genome is 99.99% with one extra annotated gene in 4976 and fewer genes annotated as hypothetical. In total there are 44 SNPs between these two strains with the majority of these (32 SNPs) being in five of the 12 secondary metabolite regions identified by antiSMASH (Table 7). These genetic changes in regions known to be responsible for the antimicrobial activity of the strains are most likely the cause of the phenotypic and functional differences between the strains.

In sum, an in-depth comparison of the genomes of the Bacillus strains selected to have efficacy against environmental mastitis-causing organisms to their nearest neighbors indicates that there are multiple genetic differences specifically in the secondary metabolite producing genes. Functionally and genetically, the strains of the present invention are distinct from other strains.

TABLE 2
General genome characteristics of the Bacillus strains tested for effectiveness
against potential environmental mastitis-causing organisms

| | 747 | 839 | 1704 | 1781 | 1999 | 2018 | 4976 | 15533 |
|---|---|---|---|---|---|---|---|---|
| Circular Contigs | 1 | 1 | 1 | 1 | 1 | 1 | 1 | 1 |
| Plasmids | 0 | 0 | 0 | 0 | 0 | 0 | 0 | 0 |
| Size (bp) | 4063542 | 3927671 | 4006540 | 4062908 | 3973137 | 3984611 | 4063541 | 4447916 |
| % GC | 46.3 | 46.6 | 46.6 | 46.3 | 46.5 | 46.5 | 46.3 | 45.9 |
| Annotated Genes | 4135 | 3935 | 4055 | 4139 | 4006 | 4031 | 4136 | 4700 |
| Hypothetical Genes | 833 | 690 | 791 | 832 | 741 | 783 | 809 | 1047 |
| tRNA | 86 | 86 | 88 | 86 | 86 | 89 | 86 | 81 |
| antiSMASH regions | 13 | 13 | 13 | 13 | 14 | 13 | 13 | 12 |

TABLE 3
Secondary metabolite biosynthetic gene clusters that are nonribosomally synthesized detected in the genomes of
the Bacillus strains tested for effectiveness against potential environmental mastitis-causing organisms

Type

| Predicted | Non-ribosomal | | | | | | | |
|---|---|---|---|---|---|---|---|---|
| chemical | peptide synthetases | | | | | | | |
| structure | Surfactin | Bacitracin | Bacillibactin | Fengycin | NRPS1 | Locillomycin | Lichenysin | Ladderane |
| Bs747 | 82% | 100% | 100% | 100% | x | 35% | x | x |
| Bs839 | 95% | 100% | 100% | 100% | P | x | x | x |
| Bs1704 | 91% | 100% | 100% | 100% | P | 35% | x | x |
| Bs1781 | 82% | 100% | 100% | 100% | x | 35% | x | x |
| Bs1999 | 91% | 100% | 100% | 100% | P | 35% | x | x |
| Bs2018 | 91% | 100% | 100% | 100% | x | x | x | P |
| Bs4976 | 82% | 100% | 100% | 100% | x | 35% | x | x |
| Bl15533 | x | 100% | 53% | 93% | x | x | 100% | x |

| Type | | | | | | |
|---|---|---|---|---|---|---|
| Predicted | Non-ribosomal | | | | | |
| chemical | peptide synthetases | Polyketide synthases | | | | |
| structure | Subtilin | Butirosin | Macrolactin | Difficidin | Bacillaene | T3PKS |
| Bs747 | x | 7% | 100% | 100% | 100% | P |
| Bs839 | x | 7% | 100% | 100% | 100% | P |
| Bs1704 | x | 7% | 100% | 100% | 100% | P |
| Bs1781 | x | 7% | 100% | 100% | 100% | P |
| Bs1999 | x | 7% | 100% | 100% | 100% | P |
| Bs2018 | x | 7% | 100% | 100% | 100% | P |
| Bs4976 | x | 7% | 100% | 100% | 100% | P |
| Bl15533 | 100% | 7% | x | x | x | P |

The percent similarity to the most similar characterized gene cluster is indicated. This similarity is based on the presence of genes and not nucleotide differences. Gene clusters predictive of secondary metabolites without similar characterized gene clusters in the database are indicated by a P.

TABLE 4
Secondary metabolite biosynthetic gene clusters that are ribosomally synthesized
detected in the genomes of the Bacillus strains tested for effectiveness
against potential environmental mastitis-causing organisms

| Type | | | | | | |
|---|---|---|---|---|---|---|
| Predicted | | | Bacteriocin peptides | | | |
| chemical | Lanthipeptides | | | | Peptide | Subtilosin |
| structure | Lanthipeptide1 | Haloduracin | Plantazolicin | Bacilysin | 1 | A |
| Bs747 | P | x | x | 100% | x | x |
| Bs839 | x | x | 91% | 100% | x | x |
| Bs1704 | x | x | x | 100% | x | x |
| Bs1781 | P | x | x | 100% | x | x |
| Bs1999 | x | x | 91% | 100% | x | x |
| Bs2018 | P | x | x | 100% | x | x |
| Bs4976 | P | x | x | 100% | x | x |
| Bl15533 | x | 40% | x | x | P | x |

| Type | | | | | | |
|---|---|---|---|---|---|---|
| Predicted | | | Terpenes | | | |
| chemical | Bacteriocin peptides | | | Micrococcin | | |
| structure | CDPS | Lassopeptide | Terpene1 | P1 | Terpene3 | Siderophore |
| Bs747 | x | x | P | P | x | x |
| Bs839 | x | x | P | P | x | x |
| Bs1704 | x | x | P | P | x | x |
| Bs1781 | x | x | P | P | x | x |
| Bs1999 | x | x | P | P | x | x |
| Bs2018 | x | x | P | P | x | x |
| Bs4976 | x | x | P | P | x | x |
| Bl15533 | P | P | x | x | P | P |

The percent similarity to the most similar characterized gene cluster is indicated. This similarity is based on the presence of genes and not nucleotide differences. Gene clusters predictive of secondary metabolites without similar characterized gene clusters in the database are indicated by a P.

TABLE 5
The average identity values for orthologous fragment pairs between two genomes
was used to determine genetic relatedness among the Bacillus strains tested
for effectiveness against potential environmental mastitis-causing organisms

| | Bl15533 | Bs1704 | Bs1781 | Bs1999 | Bs2018 | Bs4976 | Bs747 | Bs839 |
|---|---|---|---|---|---|---|---|---|
| Bl15533 | 100 | 72.4236 | 72.4863 | 72.5053 | 72.4459 | 72.4788 | 72.5959 | 72.4330 |
| Bs1704 | 72.4236 | 100 | 97.7149 | 99.8802 | 98.9763 | 97.7251 | 97.7492 | 99.3693 |
| Bs1781 | 72.4863 | 97.7149 | 100 | 97.7191 | 97.7273 | 99.9868 | 99.9973 | 97.7594 |
| Bs1999 | 72.5053 | 99.8802 | 97.7191 | 100 | 99.0705 | 97.7428 | 97.7225 | 99.2816 |
| Bs2018 | 72.4459 | 98.9763 | 97.7273 | 99.0705 | 100 | 97.6964 | 97.7530 | 98.9753 |
| Bs4976 | 72.4788 | 97.7251 | 99.9868 | 97.7428 | 97.6964 | 100 | 99.9903 | 97.6997 |
| Bs747 | 72.5959 | 97.7492 | 99.9973 | 97.7225 | 97.7530 | 99.9903 | 100 | 97.7844 |
| Bs839 | 72.4330 | 99.3693 | 97.7594 | 99.2816 | 98.9753 | 97.6997 | 97.7844 | 100 |

TABLE 6
Comparison of secondary metabolite biosynthetic gene clusters between Bs839 and Bs1704

| Type | | | | | | | | |
|---|---|---|---|---|---|---|---|---|
| Predicted | | | | | | | | |
| chemical | Non-ribosomal peptide synthetases | | | | | | Polyketide synthases | |
| structure | Surfactin | Bacitracin | Bacillibactin | Fengycin | NRPS1 | Locillomycin | Butirosin | Macrolactin |
| Bs839 | 95% | 100% | 100% | 100% | P | x | 7% | 100% |
| Bs1704 | 91% | 100% | 100% | 100% | P | 35% | 7% | 100% |

| Type | | | | | | | |
|---|---|---|---|---|---|---|---|
| Predicted | | | | Bacteriocin | | Terpenes | |
| chemical | Polyketide synthases | | | peptides | | | Micrococcin |
| structure | Difficidin | Bacillaene | T3PKS | Plantazolicin | Bacilysin | Terpene1 | P1 |
| Bs839 | 100% | 100% | P | 91% | 100% | P | P |
| Bs1704 | 100% | 100% | P | x | 100% | P | P |

The percent similarity to the most similar characterized gene cluster is indicated. This similarity is based on the presence of genes and not nucleotide differences. Gene clusters predictive of secondary metabolites without similar characterized gene clusters in the database are indicated by a

TABLE 7
Comparison of secondary metabolite biosynthetic gene clusters between Bs4976 and Bs747

Type

| Predicted | Non-ribosomal peptide | | | | | | |
|---|---|---|---|---|---|---|---|
| chemical | synthetases | | | | | Polyketide synthases | |
| structure | Surfactin | Bacitracin | Bacillibactin | Fengycin | Locillomycin | Butirosin | Macrolactin |
| Bs747 | 82% | 100% | 100% | 100% | 35% | 7% | 100% |
| Bs4976 | 82% | 100% | 100% | 100% | 35% | 7% | 100% |
| SNPs | 5 | 0 | 0 | 10 | 5 | 0 | 0 |

Type

| Predicted | | | | | Bacteriocin | Terpenes | |
|---|---|---|---|---|---|---|---|
| chemical | Polyketide synthases | | | Lanthipeptides | peptides | | Micrococcin |
| structure | Difficidin | Bacillaene | T3PKS | Lanthipeptide1 | Bacilysin | Terpene1 | P1 |
| Bs747 | 100% | 100% | P | P | 100% | P | P |
| Bs4976 | 100% | 100% | P | P | 100% | P | P |
| SNPs | 6 | 0 | 0 | 0 | 1 | 0 | 0 |

The percent similarity to the most similar characterized gene cluster is indicated. This similarity is based on the presence of genes and not nucleotide differences. Gene clusters predictive of secondary metabolites without similar characterized gene clusters in the database are indicated by a P. Nucleotide differences in the gene clusters (SNPs) are indicated.

### Example 9: The Effect of a Combination of Bacillus Strains Applied to Recycled Manure Solid Bedding on Mastitis-causing Organisms, Somatic Cell Count, Milk Culture Growth and Mastitis Events at Farm F in California

The Example evaluates pathogen inhibition in bedding material and the subsequent impact on SCC, milk culture results and mastitis events on Farm F in California with the Bacillus strains provided herein (e.g., described in Example 2) in accordance with this embodiment of the present invention, (referred to herein as “treated”), over 150 days.

### Materials and Methods

A dairy herd in California, Farm F, was selected to study the impact of the Bacillus product, in accordance with this embodiment of the present invention, on pathogen inhibition in bedding material and the subsequent impact on SCC, milk culture results and mastitis events. The herd consisted of 1,515 milk cows housed in two free stall, deep bedded barns, bedded with composted recycled manure solids (RMS).

The product, in accordance with this embodiment of the present invention, was a combination product of two Bacillus strains in equal proportions: Bacillus subtilis strain 839 and Bacillus subtilis strain 4976. Bacillus were sprayed as a liquid application directly onto the bedding in the stalls two times per week in one of the barns at 2,625,000 CFU per gram of bedding material, equivalent to 750,000 CFU per gram daily application for 150 days, while the other barn served as the control.

Milk volume, energy corrected milk (ECM), SCC and mastitis events were measured across treatment and control cows using monthly test day milk measurements. Mastitis events were determined by the total number of infections, percent of new infections, percent of chronic infections and percent clean, no infection detected. Individual cows with SCC>200,000 cells/ml were classified as having an increased risk of clinical mastitis. Fresh cows were defined as newly infected if uninfected at the dry off stage (SCC<200K) and infected at beginning of the current lactation (SCC>200K). Using the same comparative methodology, cows were categorized as chronic and clean. Milk culture results that had detectable growth were characterized as environmental Streptococcus, Escherichia coli, or Staphylococcus species (Non-S. aureus). Composite samples were collected approximately 30, 60, 90 and 150 days after the start of the trial from both treated and control stalls. During each sampling point every fifth stall was sampled in each pen and the stall was visually assessed to confirm that it had been laid on and that the bedding had been in the stall for at least 24 hours. A handful of bedding was collected from the top one to two inches of the stall surface at the location that the udder is typically located. Four treated and four control pens were sampled, four composite samples were collected from each pen with each composite sample representing ten individual stall samples.

Samples were placed on ice and analyzed within twenty-four hours of collection. Samples were mixed thoroughly, then 18 to 22 grams of the bedding material was diluted 1:10 with sterile peptone. Samples were masticated for one minute and target mastitis-causing bacteria were enumerated via spread plate method using: CHROMagar™ ECC (CHROMagar, EF322, Springfield, NJ) for the detection of E. coli and total coliforms, MacConkeys-Inositol-Carbenicillin Agar (MCIC) (Bagley and Seidler, 1978) for the detection of presumptive Klebsiella, and Bile Esculin Agar (BEA, Neogen, NCM0117A, Lansing, MI) for the detection of group D streptococci. Agar plates were incubated at 35° C. (MCIC) or 37° C. (CHROMagar™ ECC and BEA) aerobically for 24 hours. The log transformed levels of bacteria were compared for stall sample results by treatment from all sampling points using an unpaired t-test to determine statistical differences for each target bacteria group.

Statistical analysis for the effects of treatment on the primary response variables: milk volume, ECM and SCC were quantified using Linear Regression Analysis. Linear Regression Analysis uses the “least squares” method to fit a line through a set of observations to assess how a single dependent variable is affected by the values of one or more independent variables. Data were analyzed according to the following model:

Yijkl=μ+Ti+Lk+Dl+ϵiklm

where:
μ=overall mean
Ti=effect of the ith treatment (i=1, 2)
Lk=effect of the kth lactation number (k=1, 2, 3+)
Dl=effect of days in milk
ϵiklm=random error
   Differences in mastitis events and milk culture results between treatment and control groups are reported descriptively as percentage change during 150 day period of observation.

### Results and Discussion

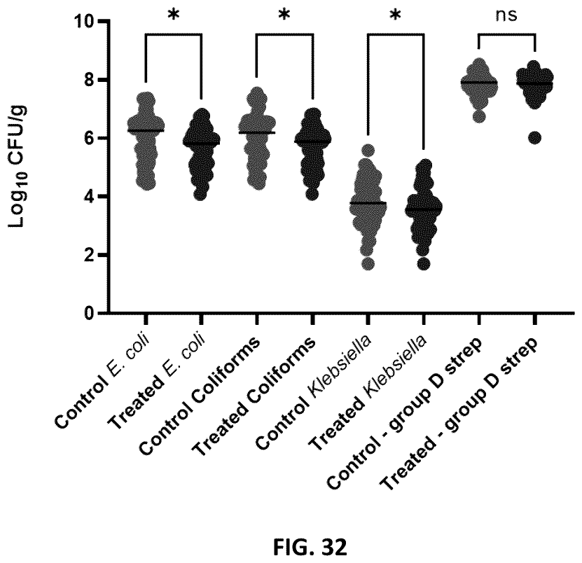

There was a statistically significant (P<0.10) reduction in SCC in the treated group compared to the control group with averages of 86,334 and 127,938 cells/mL, respectively (Table 1). There was no significant impact on milk production or ECM, but both values were higher in the cows on the treated bedding (Table 8). There were fewer incidences of total and new mastitis infections in the cows in the treated barn (Table 9). Milk culture results showed a numerical reduction for cows laying on treated bedding in the number of total positive cultures, environmental Streptococcus, E. coli, and Staphylococcus species, non-S. aureus (Table 10). Average levels of target bacteria in bedding samples were: E. coli at 3.7×10⁶ CFU/g and 1.1×10⁶ CFU/g (P=0.01); total coliforms at 4.2×10⁶ CFU/g and 1.2×10⁶ CFU/g (P=0.01); presumptive Klebsiella at 2.4×10⁴ and 1.2×10⁴ (P=0.04) and group D streptococci at 9.4×10⁷ and 8.8×10⁷ (P=0.65) for the control and treated samples, respectively. The comparison of RMS samples indicated significantly (P<0.05) lower levels of E. coli, coliforms and presumptive Klebsiella detected in the treated bedding compared to the control bedding (FIG. 32).

Significant reductions in bedding E. coli levels correspond with the decrease in E. coli positive milk cultures, which was the most abundant pathogen cultured in the milk throughout the trial period. In conclusion, when the blend of Bacillus strains were applied directly to the free stalls, in accordance with this embodiment of the present invention, a reduction in targeted mastitis-causing organisms within the bedding samples was observed. The treatment resulted in significant decreases in SCC, total and new mastitis infections, as well as fewer growth positive cultures including environmental Streptococcus, E. coli, and Staphylococcus Species (Non-S. aureus) in the dairy cows.

TABLE 8
Milk volume, ECM, and SCC measurements in control and
treated cows over the 150-day observation period
Statistical significance determined at the 10% level of
probability with P < 0.10.

| | Control | Treatment | | |
|---|---|---|---|---|
| Parameter | (n = 758) | (n = 757) | Difference | P-value |
| Milk (lbs./day) | 103 | 103.5 | 0.5 | 0.784 |
| ECM (lbs./day) | 101.6 | 102.5 | 0.9 | 0.378 |
| SCC | 127,938 | 86,334 | −41,604 | <0.100 |

TABLE 9
Total mastitis events, new infections, chronic infections, and
clean cases in control and treated cows over the
150-day observation period

| | Control | Treatment | |
|---|---|---|---|
| Parameter | (n = 758) | (n = 757) | Difference |
| Total cases (#) | 89 | 71 | −25% |
| New infections (#) | 53 | 49 | −8% |
| Chronic (#) | 54 | 62 | 13% |
| Clean (#) | 430 | 431 | 0% |

TABLE 10
Milk culture sample results in control and treated cows over
the 150-day observation period for growth positive,
environmental Streptococcus, E. coli, and
Staphylococcus species, non-S. aureus

| | Control | Treatment | |
|---|---|---|---|
| Parameter | (n = 758) | (n = 757) | Difference |
| Positive growth (#) | 1419 | 1282 | −11% |
| Environmental Streptococcus (#) | 263 | 243 | −8% |
| E. coli (#) | 613 | 565 | −8% |
| Staphylococcus species, | 441 | 397 | −11% |
| non-S. aureus (#) | | | |

### Example 10: The Effect of a Combination of Bacillus Strains Applied to Recycled Manure Solid Bedding in a Dry Form on Mastitis-causing Organisms and Somatic Cell Count at Farm G in Wisconsin

This Example evaluates pathogen inhibition in bedding material and the subsequent impact on SCC on Farm G in Wisconsin with the Bacillus strains provided herein (e.g., described in Example 2) in accordance with this embodiment of the present invention, (referred to herein as “treated”), over 6 months.

### Materials and Methods

A dairy herd in Wisconsin, Farm G, was selected to study the impact of the Bacillus product, in accordance with this embodiment of the present invention, on pathogen inhibition in bedding material and the subsequent impact on SCC. The herd consisted of 200 milk cows housed in a free stall, deep bedded barn, bedded with recycled manure solids. The product, in accordance with this embodiment of the present invention was a combination product of two Bacillus strains in equal proportions; Bacillus subtilis strain 839 and Bacillus subtilis strain 4976, which was applied with limestone carrier in a dry granular application onto the bedding after removing moisture with a screw press at an application of 750,000 CFU per gram of bedding material.

Bedding samples were obtained approximately two weeks prior to product application. Stall samples were collected from the lactating cow pens. Stall samples were defined as used bedding which had been laid on and had been in the pen for approximately twenty-four to forty-eight hours. A handful of bedding was collected from the top one to two inches from the surface, at the location that the udder is typically located. Approximately every sixth to seventh stall was sampled. These samples were collected as composite samples from five different stalls with six total composite bedding samples collected, representing 30 stalls. The same sample collection protocol was used after approximately 6 months of applying the Bacillus to the bedding.

Samples were placed on ice and analyzed within twenty-four hours of collection. Samples were mixed thoroughly, then 18 to 22 grams of the bedding material was diluted 1:10 with sterile peptone. Samples were masticated for one minute and target mastitis-causing bacteria were enumerated via spread plate method using: CHROMagar™ ECC (CHROMagar, EF322, Springfield, NJ) for the detection of E. coli and total coliforms, MacConkeys-Inositol-Carbenicillin Agar (MCIC) (Bagley and Seidler, 1978) for the detection of presumptive Klebsiella, and Bile Esculin Agar (BEA, Neogen, NCM0117A, Lansing, MI) for the detection of group D streptococci. Agar plates were incubated at 35° C. (MCIC) or 37° C. (CHROMagar™ ECC and BEA) aerobically for 24 hours. The log transformed levels of bacteria were compared by sample timepoint using an ordinary one-way ANOVA analysis to determine statistical differences.

Bulk tank SCC data was received from the milk processing facility. Due to a dramatic increase in SCC 8 months prior to the start of the trial a year over year comparison was not suited to this dataset. There was a three-week period during the trial when the product was not applied. SCC data was analyzed seven months prior to application (January to July 2022) compared to the six months using the treatment (August 1 to Nov. 16, 2022, and Dec. 7, 2022, to Feb. 28, 2023) and to the three-week period product was not applied (Nov. 17, 2022 to Dec. 6, 2022).

### Results and Discussion

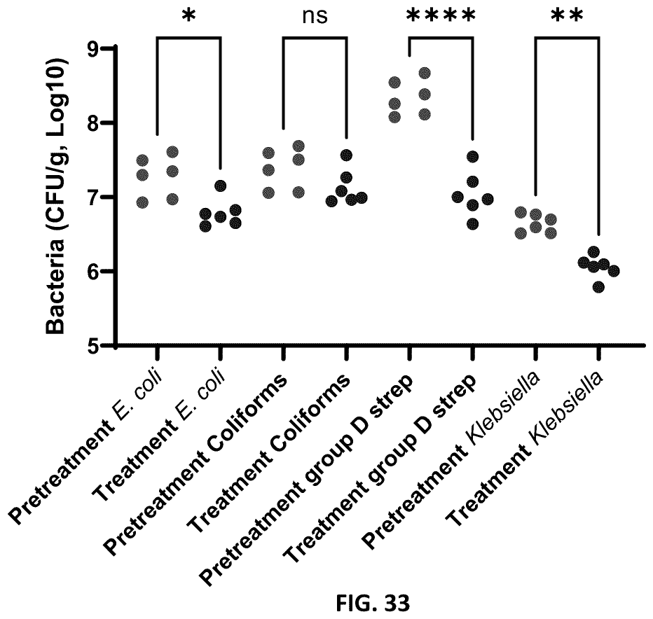

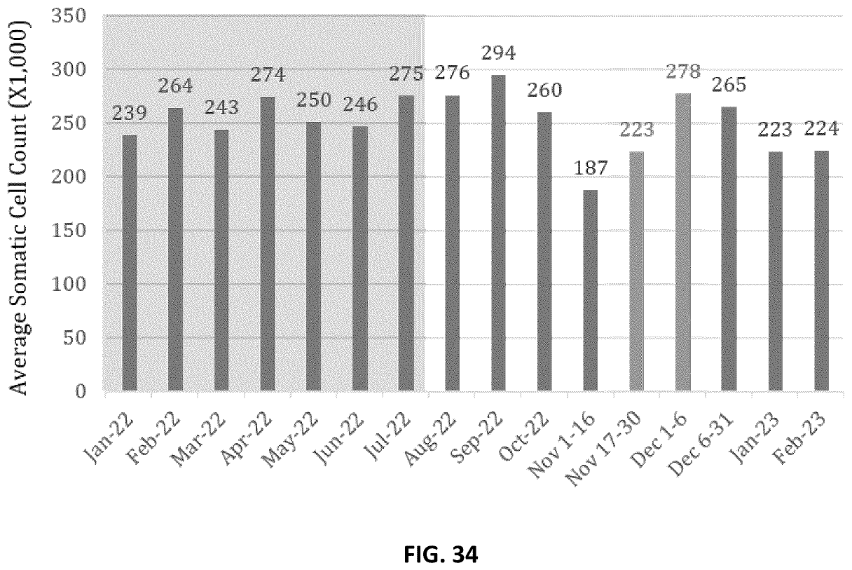

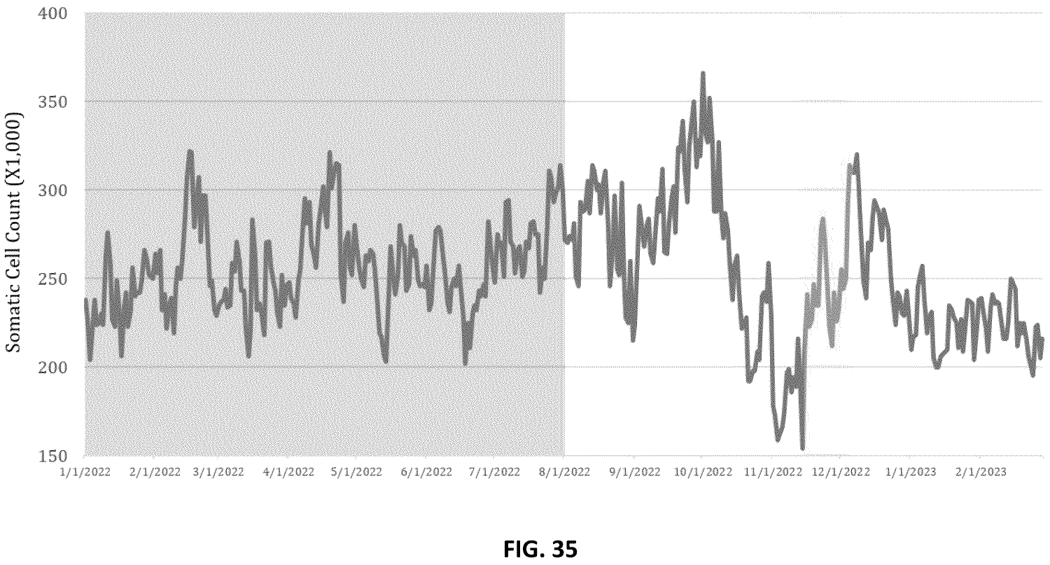

The stall bedding samples collected during the treatment period had significantly lower levels of E. coli, group D streptococci and presumptive Klebsiella in the treated bedding compared to pretreatment bedding (FIG. 33). Average levels of target bacteria for the pretreatment and treated samples, respectively, were: 2.2×10⁷ CFU/g and 6.8×10⁶ CFU/g (P=0.02) E. coli; 2.8×10⁷ CFU/g and 1.6×10⁷ CFU/g (P=0.61) total coliforms; 4.6×10⁶ and 1.2×10⁶ (P<0.01) presumptive Klebsiella, and 2.5×10⁸ and 1.4×10⁷ (P<0.01) group D streptococci. During the first three months of the trial the monthly average bulk tank SCCs were comparable (276,000, 294,000, and 260,000) to the first seven months of the year (239,000, 264,000, 243,000, 274,000, 250,000, 246,000, and 275,000). For the partial month of treatment in November the lowest average SCC was observed for the year (187,000, FIG. 34). The average level of SCC then increased during the period that treatment was not being applied in the second half of November (223,000) and the first week in December (278,000). Then after reapplying the treatment for the remainder of December (265,000), January (223,000) and February (224,000) the SCC average decreased. The lowest daily bulk tank SCC measurement for the year was detected after the extend use of the Bacillus on Nov. 12, 2022 (154,000) while one of the higher values was detected toward the end of the non-treated period, Dec. 6, 2022 (310,000, FIG. 35), before going back on the treatment.

The level of target mastitis causing bacteria decreased over the six months of application. The lowest average SCC level over the course of the year was observed after a 3 month application of the Bacillus strain composition. After not applying the Bacillus for the remainder of the month, the SCC increased. After restarting the treatment application, the level of SCC once again decreased and remained low through the end of the trial, with no other known variables contributing to these changes. In conclusion, the blend of Bacillus strains, in accordance with this embodiment of the present invention, reduced SCC after a three month application and sigifinicantly reduced target mastitis causing bacterial levels during the treatment period.

### Example 11: The Effect of a Combination of Bacillus Strains Applied to Composted Recycled Manure Solid Bedding Both in the Windrow and in the Stall on Mastitis-causing Organism Outgrowth in Individual Stalls at Farm H in Wisconsin

This Example evaluates pathogen inhibition in bedding material from individual stalls on Farm H in Wisconsin with the Bacillus strains provided herein (e.g., in Example 2) in accordance with this embodiment of the present invention, (referred to herein as “treated”), in two separate trials. The first, applying the Bacillus to the bedding windrow and the second, applying the Bacillus directly to the stall after fresh bedding is applied.

### Materials and Methods

A dairy herd in Wisconsin, Farm H, was selected to study the impact of the Bacillus product, in accordance with this embodiment of the present invention, on pathogen inhibition in bedding material. The herd consisted of 700 milk cows housed in a free stall, deep bedded barn, bedded with composted recycled manure solids (RMS). Fresh composted bedding was applied to stalls every other day.

The product, in accordance with this embodiment of the present invention, was a combination product of two Bacillus strains in equal proportions; Bacillus subtilis strain 839 and Bacillus subtilis strain 4976, which was applied in a liquid form onto the bedding. In the first experiment, the Bacillus strain composition was applied to the windrow during the last turning, prior to distribution to the stall. In the second experiment, the Bacillus strain composition was applied directly to the stalls. Both application rates were 750,000 CFU per gram of bedding material.

For the first experiment, one windrow of composted RMS bedding was treated while another windrow was left untreated. Both windrows started the composting process at the same time and underwent the same 3-week composting process, and both windrows were turned twice, at the end of the 1^{st} and 2^{nd} week of composting, during the second turn the treatment was applied to one of the windrows. The bedding was applied to two separate pens with similar environmental exposure, one used the control bedding while the second used the treated bedding. Ten individual stall bedding samples were collected one day prior (Week 0) to the start of the experiment from each pen. Stall samples were defined as used bedding which had been laid on and had been in the pen for approximately twenty-four hours. A handful of bedding was collected from the top one to two inches from the surface, at the location that the udder is typically located. The same sample collection protocol was used, collecting bedding from the same stalls, after approximately 5 weeks (Week 5) of applying the Bacillus windrow or untreated windrow bedding to the stalls.

The second experiment was executed in one pen, using twenty stalls, with similar environmental exposure. Ten stalls were treated every other day, directly after fresh untreated composted RMS bedding was applied, while the remaining ten stalls served as controls. Stall bedding samples were collected one week prior (Week −1) to the start of the experiment from the twenty individual stalls. Stall samples were defined as used bedding which had been laid on and had been in the pen for approximately twenty-four hours. A handful of bedding was collected from the top one to two inches from the surface, at the location that the udder is typically located. The same sample collection protocol was used after approximately 4 weeks (Week 4) of applying the Bacillus to the treated and untreated stalls.

Samples were placed on ice and analyzed within twenty-four hours of collection. Samples were mixed thoroughly, then 18 to 22 grams of the bedding material was diluted 1:10 with sterile peptone. Samples were masticated for one minute and target mastitis-causing bacteria were enumerated via spread plate method using: CHROMagar™ ECC (CHROMagar, EF322, Springfield, NJ) for the detection of E. coli and total coliforms, MacConkeys-Inositol-Carbenicillin Agar (MCIC) (Bagley and Seidler, 1978) for the detection of presumptive Klebsiella, and Bile Esculin Agar (BEA, Neogen, NCM0117A, Lansing, MI) for the detection of group D streptococci. Agar plates were incubated at 35° C. (MCIC) or 37° C. (CHROMagar™ ECC and BEA) aerobically for 24 hours. The log transformed levels of bacteria were compared using an unpaired t-test to determine statistical differences between treatments for each bacteria type.

### Results and Discussion

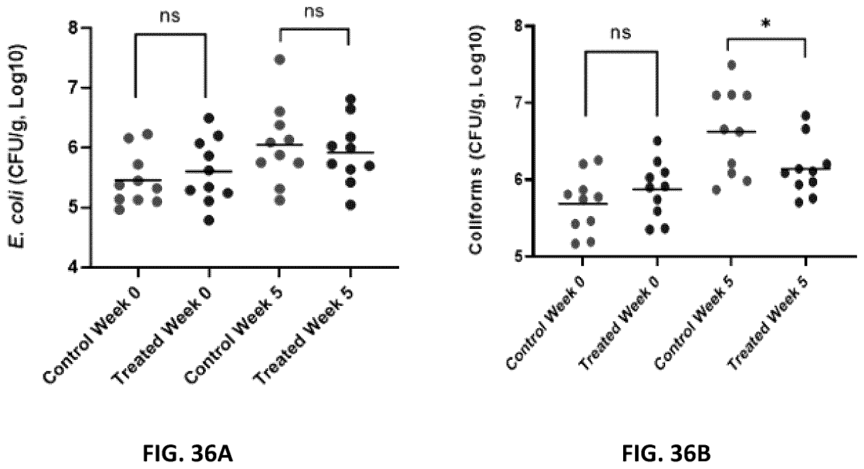

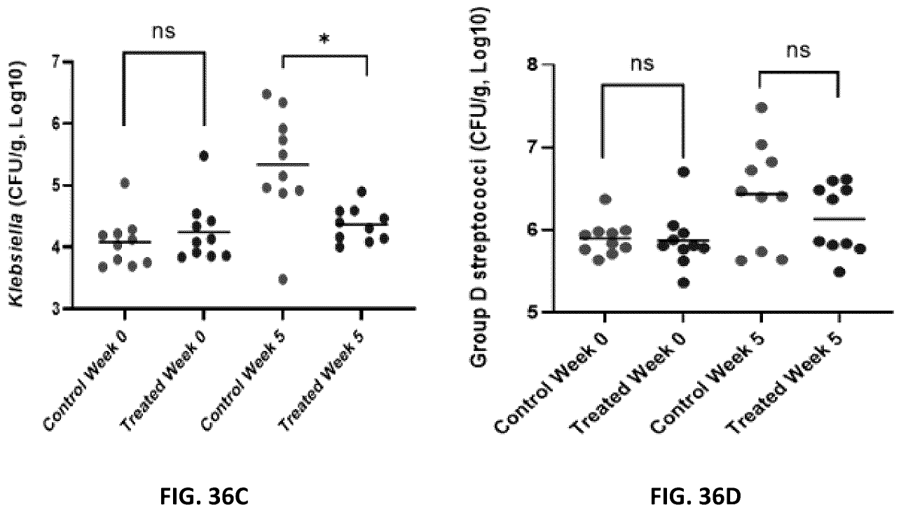

In experiment one, there was no difference in target bacteria levels in the bedding samples collected during the Week 0 sampling point, when compared by treatment group (P>0.05, FIGS. 36A-36D). During the Week 5 sampling point, the treated samples had significantly lower levels of total coliforms (P=0.04, FIG. 36B) and presumptive Klebsiella (P<0.01, FIG. 36C) compared to the control samples. The Week 5 levels of E. coli (P=0.64, FIG. 36A) and group D streptococci (P=0.21, FIG. 36D) were not significantly different when compared by treatment group.

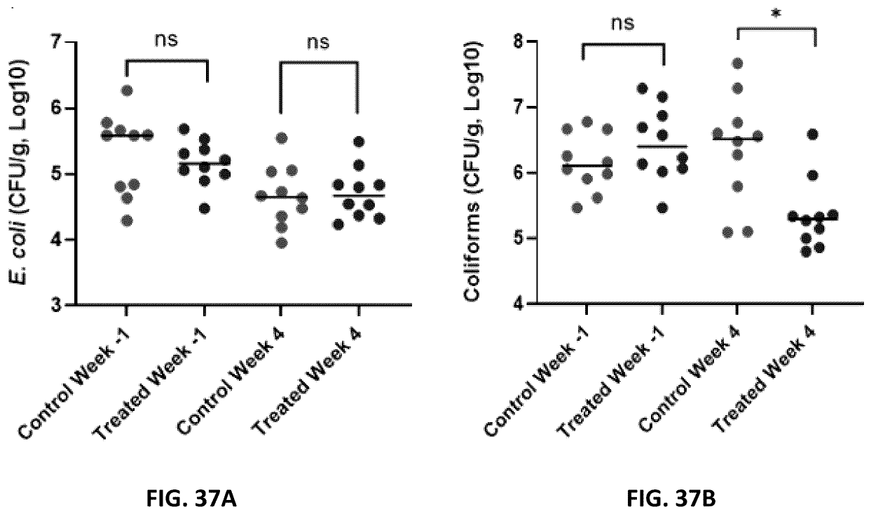

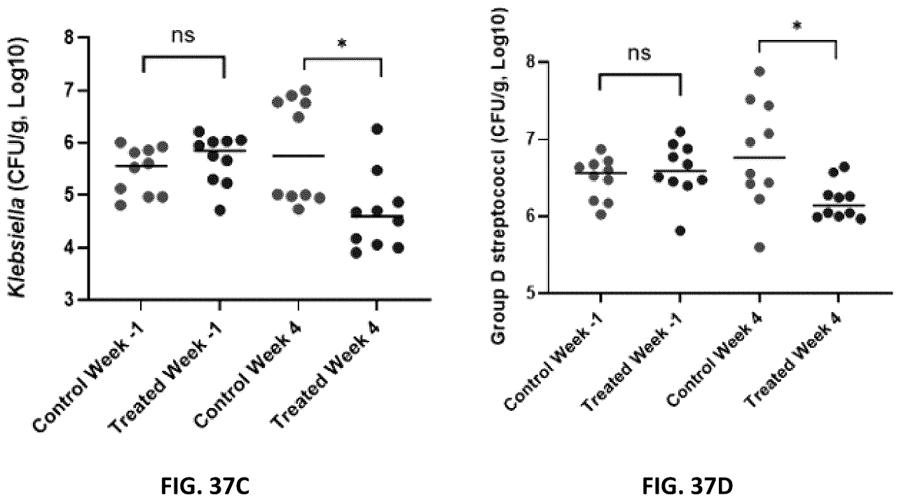

In experiment two, there was no difference in target bacteria levels in the bedding samples collected during the Week −1 sampling point, when compared by treatment group (P>0.05, FIGS. 37A-37D). During the Week 4 sampling point, the treated samples had significantly lower levels of total coliforms (P<0.01, FIG. 37B), presumptive Klebsiella (P=0.02, FIG. 37C) and group D streptococci (P<0.02, FIG. 37D) compared to the control samples. The Week 4 levels of E. coli (P=0.82, FIG. 37A) were not significantly different when compared by treatment group.

There were no significant differences in any target bacteria levels comparing baseline samples by stall treatment group for either experiment, indicating the stalls were starting with a similar bacterial level prior to the start of the experimental period. In both experiments, total coliform levels and Klebsiella levels were signficantly lower after 4 to 5 weeks of treatment application compared to uninoculated stall bedding, indicating inhibition of these populations by the Bacillus. Additionally in experiment two, there was a signficant reduction of group D streptococci in the treated bedding compared to the control. In conclusion, the blend of Bacillus strains, in accordance with this embodiment of the present invention, significantly reduced target mastitis pathogens in the bedding material compared to uninoculated bedding.

The section headings used herein are for organizational purposes only and are not to be construed as limiting the subject matter described in any way.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

That which is claimed:

1. A Bacillus strain composition for reducing growth of one or more mastitis-causing organisms, comprising a bacterial cell, a spore, a forespore, and/or a combination of cells, spores, and/or forespores of Bacillus subtilis 839 or an active variant thereof, and a bacterial cell, a spore, a forespore, and/or a combination of cells, spores, and/or forespores of Bacillus subtilis 4976 or an active variant thereof.

2. The Bacillus strain composition of claim 1, wherein said one or more mastitis-causing organisms are selected from the group consisting of Staphylococcus, Streptococcus, Enterococcus, Enterobacter, Escherichia, Shigella, Salmonella, Klebsiella, Serratia, Pseudomonas, and Proteus.

3. The Bacillus strain composition of claim 1, comprising said Bacillus subtilis 839 or active variant thereof and said Bacillus subtilis 4976 or active variant thereof in equal proportions.

4. The Bacillus strain composition of claim 1, wherein at least one of said Bacillus strains is a powdered, lyophilized strain.

5. The Bacillus strain composition of claim 1, further comprising a cryoprotectant.

6. The Bacillus strain composition of claim 1, further comprising a preservative.

7. The Bacillus strain composition of claim 1, wherein said bacterial cell, a spore, a forespore, and/or a combination of cells, spores, and/or forespores of Bacillus subtilis 839 or an active variant thereof and Bacillus subtilis 4976 or an active variant thereof is present at about 7.5×10⁵ CFU/gram to about 1×10⁶ CFU/gram or at about 7.5×10⁵ CFU/ml to about 1×10⁶ CFU/ml.

8. The Bacillus strain composition of claim 1, for reducing growth of said one or more mastitis-causing organisms in a bedding of a dairy animal having been applied an effective amount of said Bacillus strain composition.

9. The Bacillus strain composition of claim 8, wherein said effective amount comprises the Bacillus strains of about 7.5×10⁵ CFU/gram of bedding to about 1×10⁶ CFU/gram of bedding.

10. The Bacillus strain composition of claim 1, wherein said Bacillus strain composition is formulated as a liquid, a powder, a capsule, a gel, a paste, or a tablet.

11. The Bacillus strain composition of claim 1, wherein said Bacillus subtilis 839 is deposited under NRRL accession number B-67951 and/or said Bacillus subtilis 4976 is deposited under NRRL accession number B-67953.

12. A bedding for a dairy animal comprising an effective amount of a Bacillus strain composition, said Bacillus strain composition comprising a bacterial cell, a spore, a forespore, and/or a combination of cells, spores, and/or forespores of Bacillus subtilis 839 or an active variant thereof, and a bacterial cell, a spore, a forespore, and/or a combination of cells, spores, and/or forespores of Bacillus subtilis 4976 or an active variant thereof, wherein said effective amount of Bacillus strain composition reduces growth of one or more mastitis-causing organisms.

13. The bedding of claim 12, wherein said effective amount comprises the Bacillus strains of about 7.5×10⁵ CFU/gram of bedding to about 1×10⁶ CFU/gram of bedding.

14. The bedding of claim 12, comprising said Bacillus subtilis 839 or active variant thereof and said Bacillus subtilis 4976 or active variant thereof in equal proportions.

15. The bedding of claim 12, wherein a least one of said Bacillus strains is a powdered, lyophilized strain.

16. The bedding of claim 12, wherein said one or more mastitis-causing organisms are selected from the group consisting of Staphylococcus, Streptococcus, Enterococcus, Enterobacter, Escherichia, Shigella, Salmonella, Klebsiella, Serratia, Pseudomonas, and Proteus.

17. The bedding of claim 12, wherein the bedding is selected from the group consisting of recycled manure solids (RMS) bedding, composted RMS bedding, digested RMS bedding, sand bedding, recycled sand bedding, corn fodder bedding, corn stalk bedding, riverbed rock bedding, saw dust bedding, straw bedding, and wood shavings bedding.

18. The bedding of claim 12, wherein said Bacillus subtilis 839 is deposited under NRRL accession number B-67951 and/or said Bacillus subtilis 4976 is deposited under NRRL accession number B-67953.

19. A method of reducing one or more symptoms, signs, and/or occurrences of mastitis in a dairy animal, said method comprising contacting a bedding of the dairy animal with an effective amount of a Bacillus strain composition comprising a bacterial cell, a spore, a forespore, and/or a combination of cells, spores, and/or forespores of Bacillus subtilis 839 or an active variant thereof, and a bacterial cell, a spore, a forespore, and/or a combination of cells, spores, and/or forespores of Bacillus subtilis 4976 or an active variant thereof.

20. The method of claim 19, wherein said effective amount comprises the Bacillus strains of about 7.5×10⁵ CFU/gram of bedding to about 1×10⁶ CFU/gram of bedding.

21. The method of claim 19, wherein said Bacillus strain composition comprises said Bacillus subtilis 839 or active variant thereof and said Bacillus subtilis 4976 or active variant thereof in equal proportions.

22. The method of claim 19, wherein at least one of said Bacillus strains is a powdered, lyophilized strain.

23. The method of claim 19, wherein said Bacillus strain composition is formulated as a liquid, a powder, a capsule, a gel, a paste, or a tablet.

24. The method of claim 19, wherein contacting comprises spraying said Bacillus strain composition in liquid formulation onto said bedding.

25. The method of claim 19, wherein contacting comprises applying said Bacillus strain composition in dry formulation to said bedding.

26. The method of claim 19, wherein the bedding is selected from the group consisting of recycled manure solids (RMS) bedding, composted RMS bedding, digested RMS bedding, sand bedding, recycled sand bedding, corn fodder bedding, corn stalk bedding, riverbed rock bedding, saw dust bedding, straw bedding, and wood shavings bedding.

27. The method of claim 19, wherein the mastitis comprises clinical mastitis and/or subclinical mastitis.

28. The method of claim 19, wherein said method reduces growth of one or more mastitis-causing organisms in said bedding.

29. The method of claim 28, wherein said one or more mastitis-causing organisms are selected from the group consisting of Staphylococcus, Streptococcus, Enterococcus, Enterobacter, Escherichia, Shigella, Salmonella, Klebsiella, Serratia, Pseudomonas, and Proteus.

30. The method of claim 19, wherein said method reduces level of Escherichia coli, Klebsiella, and/or total coliforms in the bedding.

31. The method of claim 19, wherein said method: (a) reduces a somatic cell count in milk produced by the dairy animal, (b) reduces amount of bacteria in milk produced by the dairy animal; and/or (c) improves quality of milk produced by the dairy animal.

32. The method of claim 19, wherein said Bacillus subtilis 839 is deposited under NRRL accession number B-67951 and/or said Bacillus subtilis 4976 is deposited under NRRL accession number B-67953.
